(19) United States
(12) Patent Application Publication
(10) Pub. No.: US 2009/0246112 A1
(43) Pub. Date: Oct. 1, 2009

(54) Hydride fuel and explosive

(75) Inventor: Randell L. Mills, Yardley, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: BlackLight Power, Inc.

(21) Appl. No.: 12/155,935

(22) Filed: Jun. 11, 2008

Related U.S. Application Data
(63) Continuation of application No. 09/009,837, filed on Jan. 20, 1998, now abandoned.
(60) Provisional application No. 60/053,378, filed on Jul. 22, 1997.
(60) Provisional application No. 60/068,913, filed on Dec. 29, 1997.

(51) Int. Cl. C01B 3/02; C01B 6/04; C01B 33/00; C01B 7/00

(52) U.S. Cl. 423/324; 423/648.1; 423/646; 423/647; 423/462; 423/641

(57) ABSTRACT

This invention is directed to compositions of matter comprising a hydride ion having a binding energy greater than about 0.8 eV. The claimed hydride ions may be combined with cations, including a proton, to form novel hydrides.

This application claims priority from U.S. Provisional Application No. 60/053,378 filed Jul. 22, 1997 and U.S. Provisional Application entitled “Novel Hydride Compounds,” invented by Randell L. Mills, attorney docket No. 9113-19 PX2, filed Dec. 29, 1997.

### FIELD OF THE INVENTION

This invention relates to a new composition of matter comprising a hydride ion having a binding energy greater than about 0.8 eV (hereinafter “hydrino hydride”). The new hydride ion may also be combined with a cation, including a proton, to yield additional novel compounds.

### BACKGROUND OF THE INVENTION

Alkali and alkaline earth hydrides react violently with water to release hydrogen gas which burns in air ignited by the heat of the reaction with water. Typically metal hydrides decompose upon heating at a temperature well below the melting point of the parent metal.

Theoretical introduction relating to a composition of hydrogen having a binding energy of about

$$\frac{13.6 eV}{{n}^{2}} ,$$

where

$$n = \frac{1}{p}$$

and p is an integer greater than 1 is disclosed in Mills, R., The Grand Unified Theory of Classical Quantum Mechanics, September 1996 Edition (“'96 Mills GUT”), provided by BlackLight Power, Inc., Great Valley Corporate Center, 41 Great Valley Parkway, Malvern, Pa. 19355; and in prior applications PCT/US96/07949, PCT/US94/02219, PCT/US91/8496, and PCT/US90/1998, the entire disclosures of which are all incorporated herein by this reference (hereinafter “Mills Prior Publications”).

### SUMMARY OF THE INVENTION

This invention is directed to a new composition of matter comprising a hydride ion (H⁻) having a binding energy greater than 0.8 eV, as reflected in the following formula

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 1 )$$

where p is an integer greater than one, s=½, π is pi, is Planck's constant bar, μₒ is the permeability of vacuum, mₑ is the mass of the electron, μₑ is the reduced electron mass, aₒ is the Bohr radius, and e is the elementary charge. An ion comprising an ordinary hydrogen nucleus and two electrons having the binding energy of 0.8 eV is hereinafter referred to as “ordinary hydride ion.” The hydride ion comprises two indistinguishable electrons bound to a proton. The hydride ion of the present invention is formed by the reaction of an electron with a hydrogen atom having a binding energy given by

$$Binding Energy = \frac{13.6 eV}{{n}_{.}^{2}} \qquad ( 2 )$$

where

$$n = \frac{1}{p}$$

and p is an integer greater than one. (The binding energy is the energy required to remove an electron from an atom or a molecule and is equivalent to the ionization energy.) A hydrogen atom having the binding energy given in Eq. (2) is hereafter referred to as a hydrino atom or hydrino. The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a, is hereinafter referred to as “ordinary hydrogen atom.”

Hydrinos are formed by reacting an ordinary hydrogen atom with a catalyst having a net enthalpy of reaction of about

m·27.21 eV (3)

where m is an integer.

This catalysis releases energy with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

One such catalytic system involves potassium. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to

$$m = 1 in Eq . ( 3 ) . \\ \begin{matrix}27.28 eV + {K}^{+} + {K}^{+} + H [ \frac{{a}_{H}}{p} ] \to K + {K}^{2 +} + H [ \frac{{a}_{H}}{( p + 1 )} ] + [ {( p + 1 )}^{2} - {p}^{2} ] \times 13.6 eV & ( 4 ) \\ K + {K}^{2 +} \to {K}^{+} + {K}^{+} + 27.28 eV & ( 5 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 6 )$$

Note that the energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) \to {H}_{2} O ( l ) \qquad ( 7 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

Hydrino

$$H [ \frac{{a}_{H}}{p} ]$$

reacts with an electron to form a corresponding hydrino hydride ion, hereinafter designated as H⁻(n=1/p):

$$H [ \frac{{a}_{H}}{p} ] + {e}^{-} \to {H}^{-} ( n = 1 / p ) . \qquad ( 8 )$$

The binding energies of the hydrino hydride ion H⁻(n=1/p) as a function of p, where p is an integer, are shown in TABLE 1.

TABLE 1
The representative binding energy of the hydrino hydride ion
H⁻(n = 1/p) as a function of p, Eq. (1).

| | r₁ | Binding | Wavelength |
|---|---|---|---|
| Hydride Ion | (aₒ)^{a} | Energy^{b} (eV) | (nm) |
| H⁻(n = 1/2) | 0.9330 | 3.047 | 407 |
| H⁻(n = 1/3) | 0.6220 | 6.610 | 188 |
| H⁻(n = 1/4) | 0.4665 | 11.23 | 110 |
| H⁻(n = 1/5) | 0.3732 | 16.70 | 74.2 |
| H⁻(n = 1/6) | 0.3110 | 22.81 | 54.4 |
| H⁻(n = 1/7) | 0.2666 | 29.34 | 42.3 |
| H⁻(n = 1/8) | 0.2333 | 36.08 | 34.4 |
| H⁻(n = 1/9) | 0.2073 | 42.83 | 28.9 |
| H⁻(n = 1/10) | 0.1866 | 49.37 | 25.1 |
| H⁻(n = 1/11) | 0.1696 | 55.49 | 22.3 |
| H⁻(n = 1/12) | 0.1555 | 60.97 | 20.3 |
| H⁻(n = 1/13) | 0.1435 | 65.62 | 18.9 |
| H⁻(n = 1/14) | 0.1333 | 69.21 | 17.9 |
| H⁻(n = 1/15) | 0.1244 | 71.53 | 17.3 |
| H⁻(n = 1/16) | 0.1166 | 72.38 | 17.1 |

^{a}Equation (21)
^{b}Equation (22)

According to the present invention, a hydride ion (H⁻) is provided having a binding energy greater than 0.8 eV. The binding energy, also known as the ionization energy, of an atom, ion or molecule is the energy required to remove one electron from the atom, ion or molecule. Hydride ions having a binding of about 3, 7, 11, 17, 23, 29, 36, 43, 49, 55, 61, 66, 69, 71 and 72 eV are provided.

According to another embodiment of the invention, a compound is provided, comprising at least one increased binding energy hydrogen species. The increased binding energy hydrogen species is selected from the group consisting of (a) increased binding energy hydride ions having a binding energy greater than 0.8 eV, (b) increased binding energy hydrogen atoms having a binding energy of about 13.6/n² eV, (c) increased binding energy hydrogen molecules having a first binding energy of about 15.5/n² eV, and (d) increased binding energy molecular hydrogen ion having a binding energy of about 16.4/n² eV. The variable “n” is a fraction whose numerator is 1 and denominator is an integer greater than 1.

The compound is preferably greater than 50 atomic percent pure. More preferably, the compound is greater than 90 atomic percent pure. Most preferably, the compound is greater than 98 atomic percent pure.

The compound may further comprise one or more cations, such as a proton or H₃⁺.

The compound may further comprise one or more ordinary hydrogen atoms and/or ordinary hydrogen molecules.

The compound may have the formula MH, MH₂, or M₂H₂, wherein M is an alkali cation and H is an increased binding energy hydride ion or an increased binding energy hydrogen atom. The compound may have the formula MH, wherein n is 1 or 2, M is an w alkaline earth cation and H is an increased binding energy hydride ion or an increased binding energy hydrogen atom.

The compound may have the formula MHX wherein M is an alkali cation, X is one of a neutral atom, a molecule, or a singly negatively charged anion, and H is an increased binding energy hydride ion or an increased binding energy hydrogen atom.

The compound may have the formula MHX wherein M is an alkaline earth cation, X is a singly negatively charged anion, and H is an increased binding energy hydride ion or an increased binding energy hydrogen atom.

The compound may have the formula MHX wherein M is an alkaline earth cation, X is a doubly negatively charged anion, and H is an increased binding energy hydrogen atom.

The compound may have the formula M₂HX wherein M is an alkali cation, X is a singly negatively charged anion, and H is an increased binding energy hydride ion or an increased binding energy hydrogen atom.

The compound may have the formula MHₙ wherein n is an integer from 1 to 5, M is an alkaline cation and the hydrogen content Hₙ of the compound comprises at least one increased binding energy hydrogen species.

The compound may have the formula M₂Hₙ wherein n is an integer from 1 to 4, M is an alkaline earth cation and the hydrogen content Hₙ of the compound comprises at least one increased binding energy hydrogen species.

The compound may have the formula M₂XHₙ wherein n is an integer from 1 to 3, M is an alkaline earth cation, X is a singly negatively charged anion, and the hydrogen content Hₙ of the compound comprises at least one increased binding energy hydrogen species.

The compound may have the formula M₂X₂Hₙ wherein n is 1 or 2, M is an alkaline earth cation, X is a singly negatively charged anion, and the hydrogen content Hₙ of the compound comprises at least one increased binding energy hydrogen species.

The compound may have the formula M₂X₃H wherein M is an alkaline earth cation, X is a singly negatively charged anion, and H is an increased binding energy hydride ion or an increased binding energy hydrogen atom.

The compound may have the formula M₂XHₙ wherein n is 1 or 2, M is an alkaline earth cation, X is a doubly negatively charged anion, and the hydrogen content Hₙ of the compound comprises at least one increased binding energy hydrogen species.

The compound may have the formula M₂XX′H wherein M is an alkaline earth cation, X is a singly negatively charged anion, X₁ is a doubly negatively charged anion, and H is an increased binding energy hydride ion or an increased binding energy hydrogen atom.

The compound may have the formula MM′Hₙ wherein n is an integer from 1 to 3, M is an alkaline earth cation, M′ is an alkali metal cation and the hydrogen content Hₙ of the compound comprises at least one increased binding energy hydrogen species.

The compound may have the formula MM′XHₙ wherein n is 1 or 2, M is an alkaline earth cation, M′ is an alkali metal cation, X is a singly negatively charged anion and the hydrogen content Hₙ of the compound comprises at least one increased binding energy hydrogen species.

The compound may have the formula MM′XH wherein M is an alkaline earth cation, M′ is an alkali metal cation, X is a doubly negatively charged anion and H is an increased binding energy hydride ion or an increased binding energy hydrogen atom.

The compound may have the formula MM′XX′H wherein M is an alkaline earth cation, M′ is an alkali metal cation, X and X′ are singly negatively charged anion and H is an increased binding energy hydride ion or an increased binding energy hydrogen atom.

The compound may have the formula HₙS wherein n is 1 or 2 and the hydrogen content Hₙ of the compound comprises at least one increased binding energy hydrogen species.

The compound may have the formula MSiHₙ wherein n is an integer from 1 to 6, M is an alkali or alkaline earth cation, and the hydrogen content Hₙ of the compound comprises at least one increased binding energy hydrogen species.

The compound may have the formula MXX′Hₙ wherein n is an integer from 1 to 5, M is an alkali or alkaline earth cation, X is a singly or doubly negatively charged anion, X′ is Si, Al, Ni, a transition element, an inner transition element, or a rare earth element, and the hydrogen content Hₙ of the compound comprises at least one increased binding energy hydrogen species.

The compound may have the formula MAlHₙ wherein n is an integer from 1 to 6, M is an alkali or alkaline earth cation and the hydrogen content Hₙ of the compound comprises at least one increased binding energy hydrogen species.

The compound may have the formula MHₙ wherein n is an integer from 1 to 6, M is a transition element, an inner transition element, a rare earth element, or Ni, and the hydrogen content Hₙ of the compound comprises at least one increased binding energy hydrogen species.

The compound may have the formula MNiHₙ wherein n is an integer from 1 to 6, M is an alkali cation, alkaline earth cation, silicon, or aluminum, and the hydrogen content Hₙ of the compound comprises at least one increased binding energy hydrogen species.

The compound may have the formula MXHₙ wherein n is an integer from 1 to 6, M is an alkali cation, alkaline earth cation, silicon, or aluminum, X is a transition element, inner transition element, or a rare earth element cation, and the hydrogen content Hₙ of the compound comprises at least one increased binding energy hydrogen species.

The compound may have the formula MSiHₙ wherein n is an integer from 1 to 8, M is an alkali or alkaline earth cation, and the hydrogen content Hₙ of the compound comprises at least one increased binding energy hydrogen species.

The compound may have the formula Si₂Hₙ wherein n is an integer from 1 to 8, and the hydrogen content Hₙ of the compound comprises at least one increased binding energy hydrogen species.

The compound may have the formula SiHₙ wherein n is an integer from 1 to 8, and the hydrogen content Hₙ of the compound comprises at least one increased binding energy hydrogen species.

The compound may have the formula TiHₙ wherein n is an integer from 1 to 4, and the hydrogen content Hₙ of the compound comprises at least one increased binding energy hydrogen species.

The compound may have the formula Al₂Hₙ wherein n is an integer from 1 to 4, and the hydrogen content Hₙ of the compound comprises at least one increased binding energy hydrogen species.

The compound may have the formula MXAlX′Hₙ wherein n is 1 or 2, M is an alkali or alkaline earth cation, X and X′ are either a singly negatively charged anion or a doubly negatively charged anion, and the hydrogen content Hₙ of the compound comprises at least one increased binding energy hydrogen species.

The compound may have the formula MXSiX₁Hₙ wherein n is 1 or 2, M is an alkali or alkaline earth cation, X and X′ are either a singly negatively charged anion or a doubly negatively charged anion, and the hydrogen content Hₙ of the compound comprises at least one increased binding energy hydrogen species.

The compound may have the formula SiO₂Hₙ wherein n is an integer from 1 to 6, and the hydrogen content H, of the compound comprises at least one increased binding energy hydrogen species.

The compound may have the formula MSiO₂Hₙ wherein n is an integer from 1 to 6, M is an alkali or alkaline earth cation, and the hydrogen content H, of the compound comprises at least one increased binding energy hydrogen species.

The compound may have the formula MSi₂Hₙ wherein n is an integer from 1 to 6, M is an alkali or alkaline earth cation, and the hydrogen content Hₙ of the compound comprises at least one increased binding energy hydrogen species.

The compound may have the formula M₂SiHₙ wherein n is an integer from 1 to 8, M is an alkali or alkaline earth cation, and the hydrogen content Hₙ of the compound comprises at least one increased binding energy hydrogen species.

In MHX, M₂HX, M₂XHₙ, M₂X₂Hₙ, M₂X₃H, M₂XX′H, MM′XHₙ, MM′XX′H, MXX′Hₙ, MXAlX₁Hₙ, the singly negatively charged anion may be a halogen ion, hydroxide ion, hydrogen carbonate ion, or nitrate ion.

In MHX, M₂XHₙ, M₂XX′H, MM′XH, MXX′Hₙ, MXAlX′Hₙ, the doubly negatively charged anion may be a carbonate ion or sulfate ion.

According to another embodiment of the invention, a method is provided for preparing a compound comprising at least one increased binding energy hydride ion having a binding energy greater than 0.8 eV. The method comprises reacting atomic hydrogen with a catalyst having a net enthalpy of reaction of at least m·27 eV, where m is an integer to produce an increased binding energy hydrogen atom having a binding energy of about 13.6/n² eV, wherein n is a fraction whose numerator is 1 and denominator is an integer greater than 1. The increased binding energy hydrogen atom is reacted with an electron, to produce an increased binding energy hydride ion having a binding energy greater than 0.8 eV. The increased binding energy hydride ion is reacted with one or more cations to produce a compound comprising at least one increased binding energy hydride ion having a binding energy greater than 0.8 eV.

According to another embodiment of the invention, a fuel cell is provided, comprising a vessel having a cathode. The vessel contains atomic hydrogen and a catalyst having a net enthalpy of reaction of at least m·27 eV, where m is an integer. The atomic hydrogen reacts with the catalyst and the cathode in the vessel, thereby producing a hydride ion having a binding energy greater than 0.8 eV. The fuel cell may comprise a battery.

According to another embodiment of the invention, a fuel cell is provided, comprising a vessel having a first compartment and a second department. The first compartment contains a cathode and increased binding energy hydrogen atoms. The second compartment contains an anode and a reductant. A salt bridge connects the first compartment and the second department. In the vessel, the increased binding energy hydrogen atoms react with electrons supplied by the reductant, thereby producing a hydride ion having a binding energy greater than 0.8 eV. The fuel cell may further comprise a getter for the increased binding energy hydrogen atoms. The getter may comprise a metal with a low work function, such as an alkali or alkaline earth metal. The fuel cell may further comprise a source of increased binding energy hydrogen atoms for supplying the increased binding energy hydrogen atoms. The source of increased binding energy hydrogen atoms may be a compound including an increased binding energy hydrogen species.

In the fuel cell having a source of increased binding energy hydrogen atoms, increased binding energy hydrogen atoms may be provided by at least one of an electrolytic cell, gas cell, gas discharge cell, and a plasma torch cell. The fuel cell further comprises a passageway for the increased binding energy hydrogen atoms communicating between the cell and the first compartment of the fuel cell. The fuel cell may further comprise a getter for the increased binding energy hydrogen atoms. The getter may comprise a metal with a low work function, such as an alkali or alkaline earth metal.

According to another embodiment of the invention, a hydride ion having a binding energy of about 0.65 eV is provided.

According to another embodiment of the invention, a method for the explosive release of energy is provided by reacting a hydride ion having a binding energy of about 0.65 eV, or a compound of the hydride ion, with a proton to produce molecular hydrogen having a first binding energy of about 8,928 eV. The proton may be supplied by an acid or a super-acid. The acid or super acid may be HF, HCl, H₂SO₄, HNO₃, the reaction product of HF and SbF₅, the reaction product of HCl and Al₂Cl₆, the reaction product of H₂SO₃F and SbF₅, the reaction product of H₂SO₄ and SO₂, and combinations thereof. The reaction with the acid or super-acid may be initiated by rapid mixing of the hydride ion or hydride ion compound with the acid or super-acid. The rapid mixing may be achieved by detonation of a conventional explosive proximal to the hydride ion and the acid or super-acid.

According to another embodiment of the invention, a method for the explosive release of energy is provided comprising thermally decomposing a compound of a hydride ion. The hydride ion having a binding energy of about 0.65 eV. The decomposition of the compound produces a hydrogen molecule having a first binding energy of about 8,928 eV. The thermal decomposition may be achieved, for example, by detonating a conventional explosive proximal to the hydride ion compound. The thermal decomposition may also be achieved by percussion heating of the hydride ion compound. The percussion heating of the hydride ion compound may comprise colliding a projectile tipped with the compound under condition resulting in detonation upon impact.

According to another embodiment of the invention, a fuel is provided comprising a compound including at least one increased binding energy hydrogen species.

According to another embodiment of the invention, a method for producing a hydride ion having a binding energy of about 0.65 eV is provided. The method comprises supplying increased binding energy hydrogen atoms and reacting the increased binding energy hydrogen atoms with a first reductant, thereby forming at least one stable hydride ion having a binding energy greater than 0.8 eV and at least one non-reactive atomic hydrogen. The method further comprises collecting the non-reactive atomic hydrogen and reacting the non-reactive atomic hydrogen with a second reductant, thereby forming stable hydride ions including the hydride ion having a binding energy of about 0.65 eV. The first reductant may have a high work function or a positive free energy of reaction. The first reduction may be a metal other than an alkali or alkaline earth metal, such as tungsten. The second reductant may comprise a plasma or an alkali or alkaline earth metal.

The invention is also directed to a reactor for producing hydrino hydrides. The hydrino hydride reactor of the present invention comprises a cell for making hydrinos and an electron source. The reactor produces hydrino hydrides having the binding energy of Eq. (1). The cell for making hydrinos may take the form of an electrolytic cell, a gas cell, a gas discharge cell, or a plasma torch cell. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only ¹H but also deuterium and tritium. Electrons from the electron source contact the hydrinos and react to form hydrino hydrides.

In the electrolytic cell, the hydrinos are reduced (i.e. gain an electron) to form hydrino hydrides by contacting any of the following 1.) a cathode, 2.) a reductant which comprises the cell, 3.) any of the reactor components, or 4.) a reductant extraneous to the operation of the cell (i.e. a consumable reductant added to the cell from an outside source) (items 2.-4. are hereinafter, collectively referred to as “the hydrino reducing reagent”). In the gas cell, the hydrinos are reduced to hydrino hydrides by the hydrino reducing reagent. In the gas discharge cell, the hydrinos are reduced to hydrino hydrides by 1.) contacting the cathode; 2.) reduction by plasma electrons, or 3.) contacting the hydrino reducing w reagent. In the plasma torch cell, the hydrinos are reduced to hydrino hydrides by 1.) reduction by plasma electrons, or 2.) contacting the hydrino reducing reagent. In one embodiment, the electron source comprising the hydrino hydride reducing reagent is effective only in the presence of hydrino atoms.

According to another aspect of the present invention, novel compounds are formed from a hydrino hydride anion and a cation. In the electrolytic cell, the cation may be either an oxidized species of the material of the cell cathode or anode, a cation of an added reductant, or a cation of the electrolyte including a cation comprising the catalyst. A cation of the electrolyte may comprise a cation of the catalyst. In the gas cell, the cation comprises either an oxidized species of the material of the cell, a cation comprising the molecular hydrogen dissociation material which produces atomic hydrogen, a cation comprising an added reductant, or a cation present in the cell including the catalyst. In the discharge cell, the cation includes either an oxidized species of the material of the cathode or anode, a cation of an added reductant, or a cation present in the cell including the catalyst. In the plasma torch cell, the cation includes either an oxidized species of the material of the cell, a cation of an added reductant, or a cation present in the cell including the catalyst.

One application of the reaction to make hydrino hydride of the present invention is as a cathode half reaction of an electrochemical cell.

According to another aspect of the invention, hydrino molecules or dihydrinos, are produced by reacting protons with hydrino hydrides, or by the thermal decomposition of hydrino hydride including compounds containing at least one hydrino hydride ion(s), hydrino atom(s), dihydrino molecular ion(s), and/or dihydrino molecule(s), or the thermal or chemical decomposition of compounds containing at least one hydrino hydride ion(s), hydrino atom(s), dihydrino molecular ion(s), and/or dihydrino molecule(s). A diatomic hydrogen molecule having a binding energy of 15.5 eV is referred to hereinafter as “ordinary hydrogen molecule.”

According to another aspect of the invention, energy is released by the thermal decomposition or chemical reaction of hydrino, dihydrino, and/or hydrino hydride compounds to form lower-energy products such as lower-energy hydrino, dihydrino, and/or hydrino hydride compounds, w lower-energy hydrinos or lower-energy hydrino hydrides, and dihydrinos from hydrinos and hydrino hydrides. Exemplary hydrino, dihydrino, and/or hydrino hydride compounds as reactants and products include those given in the Experimental Section and the Additional Compositions Involving Hydrino Hydrides Section.

According to another aspect of the invention, hydrino, dihydrino, and/or hydrino hydride compounds are a source of hydrinos for the electrochemical cell of the present invention. The claimed compounds may be used as fuel to store enthalpy.

Other objects, features, and characteristics of the present invention, as well as the methods of operation and the functions of the related elements, will become apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 is a schematic drawing of an hydride reactor in accordance with the present invention;

FIG. 2 is a schematic drawing of an electrolytic cell hydride reactor in accordance with the present invention;

FIG. 3 is a schematic drawing of a gas cell hydride reactor in accordance with the present invention;

FIG. 4 is a schematic drawing of an experimental gas cell hydride reactor in accordance with the present invention;

FIG. 5 is a schematic drawing of a gas discharge cell hydride reactor in accordance with the present invention;

FIG. 6 is a schematic of an experimental gas discharge cell hydride reactor in accordance with the present invention;

FIGS. 7 and 7A are schematic drawings of plasma torch cell hydride reactors in accordance with the present invention;

FIG. 8 is a schematic drawing of an experimental plasma torch cell hydride reactor in accordance with the present invention;

FIG. 9 is a schematic drawing of a battery or fuel cell in accordance with the present invention;

FIG. 10 is the 0 to 1200 eV binding energy region of an X-ray Photoelectron Spectrum (XPS) of a control glassy carbon rod;

FIG. 11 is the survey spectrum of a glassy carbon rod cathode following electrolysis of a 0.57M K₂CO₃ electrolyte (sample #1) with the primary elements identified;

FIG. 12 is the low binding energy range (0-285 eV) of a glassy carbon rod cathode following electrolysis of a 0.57M K₂CO₃ electrolyte (sample #1);

FIG. 13 is the 55 to 70 eV binding energy region of an X-ray Photoelectron. Spectrum (XPS) of a glassy carbon rod cathode following electrolysis of a 0.57M K₂CO₃ electrolyte (sample #1);

FIG. 14 is the 0 to 70 eV binding energy region of a high resolution X-ray Photoelectron Spectrum (XPS) of a glassy carbon rod cathode following electrolysis of a 0.57M K₂CO₃ electrolyte (sample #2);

FIG. 15 is the 0 to 70 eV binding energy region of a high resolution X-ray Photoelectron Spectrum (XPS) of a glassy carbon rod cathode following electrolysis of a 0.57M K₂CO₃ electrolyte and storage for three months (sample #3);

FIG. 16 is the survey spectrum of crystals prepared by filtering the electrolyte from the K₂CO₃ electrolytic cell that produced 6.3×10⁸ J of enthalpy of formation of hydrino hydride (sample #4) with the primary elements identified;

FIG. 17 is the 0 to 75 eV binding energy region of a high resolution X-ray Photoelectron Spectrum (XPS) of crystals prepared by filtering the electrolyte from the K₂CO₃ electrolytic cell that produced 6.3×10⁸ J of enthalpy of formation of hydrino hydride (sample #4);

FIG. 18 is the survey spectrum of crystals prepared by acidifying the electrolyte from the K₂CO₃ electrolytic cell that produced 6.3×10⁸ J of enthalpy of formation of hydrino hydride, and concentrating the acidified solution until crystals formed on standing at room temperature (sample #5) with the primary elements identified;

FIG. 19 is the 0 to 75 eV binding energy region of a high resolution X-ray Photoelectron Spectrum (XPS) of crystals prepared by acidifying the electrolyte from the K₂CO₃ electrolytic cell that produced 6.3×10⁸ J of enthalpy of formation of hydrino hydride, and concentrating the acidified solution until crystals formed on standing at room temperature (sample #5);

FIG. 20 is the survey spectrum of crystals prepared by concentrating the electrolyte from a K₂CO₃ electrolytic cell operated by Thermacore, Inc. until a precipitate just formed (sample #6) with the primary elements identified;

FIG. 21 is the 0 to 75 eV binding energy region of a high resolution X-ray Photoelectron Spectrum (XPS) of crystals prepared by concentrating the electrolyte from a K₂CO₃ electrolytic cell operated by Thermacore, Inc. until a precipitate just formed (sample #6) with the primary elements identified;

FIG. 22 is the superposition of the 0 to 75 eV binding energy region of the high resolution X-ray Photoelectron Spectrum (XPS) of sample #4, sample #5, and sample #6;

FIG. 23 is the mass spectrum (m/e=0-110) of the vapors from the crystals from the electrolyte of the Na₂CO₃ electrolytic cell with a sample heater temperature of 225° C.;

FIG. 24 is the mass spectrum (m/e=0-110) of the vapors from the K₂CO₃ used as the electrolyte of the K₂CO₃ electrolytic cell with a sample heater temperature of 225° C.;

FIG. 25 is the mass spectrum (m/e=0−117) of the vapors from the crystals from the electrolyte of the K₂CO₃ electrolytic cell hydrino hydride reactor that was made 1 M in LiNO₃ and acidified with HNO₃ with a sample heater temperature of 170° C.;

FIG. 26 is the mass spectrum (m/e=0-110) of the vapors from the crystals filtered from the electrolyte of the K₂CO₃ electrolytic cell hydrino hydride reactor with a sample heater temperature of 185° C.;

FIG. 27 is the mass spectrum (m/e=0-110) of the vapors from the crystals from a gas cell hydrino hydride reactor comprising a KI catalyst, stainless steel filament leads, and a Pt filament with a sample heater temperature of 210° C.;

FIG. 28 is the mass spectrum (m/e=0-110) of the vapors from the crystals from a gas cell hydrino hydride reactor comprising a KI catalyst, stainless steel filament leads, and a W filament with a sample heater temperature of 175° C.;

FIG. 29 is the 0 to 75 eV binding energy region of a high resolution X-ray Photoelectron Spectrum (XPS) of recrystallized crystals prepared from the gas cell hydrino hydride reactor comprising a KI catalyst, stainless steel filament leads, and a W filament corresponding to the mass spectrum shown in FIG. 28;

FIG. 30 is the mass spectrum (m/e=0-110) of the vapors from the cryopumped crystals isolated from the 40° C. cap of a gas cell hydrino hydride reactor comprising a KI catalyst, stainless steel filament leads, and a W filament with the sample dynamically heated from 90° C. to 120° C. while the scan was being obtained in the mass range m/e=75-100;

FIG. 31 is the mass spectrum (m/e=0-10) of the sample shown in FIG. 30 with the succeeding repeat scan where the total time of each scan was 75 seconds;

FIG. 32 is the mass spectrum (m/e=0-110) of the vapors from the crystals from a gas discharge cell hydrino hydride reactor comprising a KI catalyst and a Ni electrodes with a sample heater temperature of 133° C.;

FIG. 33 is the mass spectrum (m/e=0-110) of the vapors from the crystals from a plasma torch cell hydrino hydride reactor with a sample heater temperature of 375° C.;

FIG. 34 is the mass spectrum as a function of time of hydrogen (m/e=2 and (m/e=1), water (m/e=18, m/e=2, and (m/e=1), carbon dioxide (m/e=44 and m/e=12), and hydrocarbon fragment CH₃⁺ (m/e=15), and carbon (m/e=12) obtained following recording the mass spectra of the crystals from the electrolytic cell, the gas cell, the gas discharge cell, and the plasma torch cell hydrino hydride reactors shown in FIGS. 25, 26, 27, 28, 32, and 33;

FIG. 35 is the X-ray Diffraction (XRD) data before hydrogen flow over the ionic hydrogen spillover catalytic material: 40% by weight potassium nitrate (KNO₃) on Grafoil with 5% by weight 1%-Pt-on-graphitic carbon;

FIG. 36 is the X-ray Diffraction (XRD) data after hydrogen flow over the ionic hydrogen spillover catalytic material: 40% by weight potassium nitrate (KNO₃) on Grafoil with 5% by weight 1%-Pt-on-graphitic carbon;

FIG. 37 is the X-ray Diffraction (XRD) data of the crystals from the stored nickel cathode of the K₂CO₃ electrolytic cell hydrino hydride-reactor (sample #1A);

FIG. 38 is the results of the measurement of the enthalpy of the decomposition reaction of hydrino hydride compounds using an adiabatic calorimeter with virgin nickel wires and cathodes from a Na₂CO₃ electrolytic cell and a K₂CO₃ electrolytic cell that produced 6.3×10⁸ J of enthalpy of formation of hydrino hydride;

FIG. 39 is the gas chromatographic analysis (60 meter column) of the gasses released from the sample collected from the plasma torch manifold when the sample was heated to 400° C.;

FIG. 40 is the gas chromatographic analysis (60 meter column) of high purity hydrogen;

FIG. 41 is the gas chromatographic analysis (60 meter column) of gasses from the thermal decomposition of a nickel wire cathode from a K₂CO₃ electrolytic cell that was heated in a vacuum vessel;

FIG. 42 is the gas chromatographic analysis (60 meter column) of gasses of a hydrogen discharge with the catalyst (KI) where the reaction gasses flowed through a 100% CuO recombiner and were sampled by an on-line gas chromatograph;

FIG. 43 is the schematic of the discharge cell light source, the extreme ultraviolet (EUV) spectrometer for windowless EUV spectroscopy, and the mass spectrometer used to observe hydrino, hydrino hydride compound, and dihydrino molecular ion formations and transitions;

FIG. 44 is the EUV spectrum (20-75 nm) recorded of normal hydrogen and hydrogen catalysis with KNO₃ catalyst vaporized from the catalyst reservoir by heating;

FIG. 45 is the EUV spectrum (90-93 nm) recorded of hydrogen catalysis with KI catalyst vaporized from the nickel foam metal cathode by the plasma discharge;

FIG. 46 is the EUV spectrum (89-93 nm) recorded of hydrogen catalysis with a five way stainless steel cross discharge cell that served as the anode, a stainless steel hollow cathode, and KI catalyst that was vaporized directly into the plasma of the hollow cathode from the catalyst reservoir by heating superimposed on four control (no catalyst) runs;

FIG. 47 is the EUV spectrum (90-92.2 nm) recorded of hydrogen catalysis with KI catalyst vaporized from the hollow copper cathode by the plasma discharge;

FIG. 48 is the EUV spectrum (20-120 nm) recorded of normal hydrogen excited by a discharge cell which comprised a five way stainless steel cross that served as the anode with a hollow stainless steel cathode;

FIG. 49 is the EUV spectrum (20-120 nm) recorded of hydrino hydride compounds synthesized with KI catalyst vaporized from the catalyst reservoir by heating wherein the transitions were excited by the plasma discharge in a discharge cell which comprised a five way stainless steel cross that served as the anode and a hollow stainless steel cathode;

FIG. 50 is a representative mass spectrum (m/e=0-75) of the gaseous hydrino hydride compounds recorded alternatively with the EUV spectrum with catalyst; and

FIG. 51 is the EUV spectrum (120-124.5 nm) recorded of hydrogen catalysis to form hydrino that reacted with discharge plasma protons wherein the KI catalyst was vaporized from the cell walls by the plasma discharge.

### DETAILED DESCRIPTION OF THE INVENTION

Formation of a hydride ion having a binding energy greater than about 0.8 eV allows for production of alkali and alkaline earth hydrides having stability or slow reactivity in water. In addition, very stable metal hydrides can be produced with such a hydride ion. These novel materials form very strong bonds with certain cations and have unique properties with many applications such as structural materials, corrosion resistant coatings, heat resistant coatings, optical coatings, optical filters (e.g. due to their unique continuum emission and absorption bands), magnets (e.g. as a compound with a ferromagnetic cation such as iron or nickel), chemical synthetic processing methods, and refining methods. Also, their formation reaction is useful in chemical etching processes including semiconductor etching to form computer chips, for example. Due to the small mass of such a hydride ion, these materials also are lighter than present materials containing a different anion. In a further application, a hydrino hydride stable to air represents a significant improvement as the product of a cathode half reaction of a fuel cell or battery over conventional cathode products of present batteries and fuel cells due to the much greater energy release of the hydrino hydride reaction. Due to the rapid kinetics and the extraordinary exothermic nature of the reactions of these compounds, other applications include munitions, explosives, and solid fuels.

### Hydride Ion

A hydrino atom

$$H [ \frac{{a}_{H}}{p} ]$$

reacts with an electron to form a corresponding hydrino hydride ion H⁻(n=1/p) as given by Eq. (8).

Hydride ions are a special case of two electron atoms each comprising a nucleus and an “electron 1” and an “electron 2”. The derivation of the binding energies of two electron atoms is given by the '96 Mills GUT. A brief summary of the hydride binding energy derivation follows whereby the equation numbers of the format (#.###) correspond to those given in the '96 Mills GUT.

The hydride ion comprises two indistinguishable electrons bound to a proton of Z=+1. Each electron experiences a centrifugal force, and the balancing centripetal force (on each electron) is produced by the electric force between the electron and the nucleus. In addition, a magnetic force exits between the two electrons causing the electrons to pair.

Determination of the Orbitsphere Radius, rₙ

Consider the binding of a second electron to a hydrogen atom to form a hydride ion. The second electron experiences no central electric force because the electric field is zero outside of the radius of the first electron. However, the second electron experiences a magnetic force due to electron 1 causing it to spin pair with electron 1. Thus, electron 1 experiences the reaction force of electron 2 which acts as a centrifugal force. The force balance equation can be determined by equating the total forces acting on the two bound electrons taken together. The force balance equation for the paired electron orbitsphere is obtained by equating the forces on the mass and charge densities. The centrifugal force of both electrons is given by Eq. (7.1) and Eq. (7.2) where the mass is 2mₑ. Electric field lines end on charge. Since both electrons are paired at the same radius, the number of field lines ending on the charge density of electron 1 equals the number that end on the charge density of electron 2. The electric force is proportional to the number of field lines; thus, the centripetal electric force, F_{e/e}, between the electrons and the nucleus is

$${F}_{ele ( electron 1 , 2 )} = \frac{\frac{1}{2} {e}^{2}}{4 {πɛ}_{o} {r}_{n}^{2}} \qquad ( 12 )$$

where εₒ is the permittivity of free-space. The outward magnetic force on the two paired electrons is given by the negative of Eq. (7.15) where the mass is 2mₑ. The outward centrifugal force and magnetic forces on electrons 1 and 2 are balanced by the electric force

$$\frac{{ℏ}^{2}}{2 {m}_{e} {r}_{2}^{3}} = \frac{\frac{1}{2} {e}^{2}}{4 {πɛ}_{o} {r}_{2}^{2}} - \frac{1}{Z} \frac{{ℏ}^{2}}{2 {m}_{e} {r}_{2}^{3}} \sqrt{s ( s + 1 )} \qquad ( 13 )$$

where Z=1. Solving for r₂,

$${r}_{2} = {r}_{1} = {a}_{0} ( 1 + \sqrt{s ( s + 1 )} ) ; s = \frac{1}{2} \qquad ( 14 )$$

That is, the final radius of electron 2, r₂, is given by Eq. (14); this is also the final radius of electron 1.

### Binding Energy

During ionization, electron 2 is moved to infinity. By the selection rules for absorption of electromagnetic radiation dictated by conservation of angular momentum, absorption of a photon causes the spin axes of the antiparallel spin-paired electrons to become parallel. The unpairing energy, E_{unparing}(magnetic), is given by Eq. (7.30) and Eq. (14) multiplied by two because the magnetic energy is proportional to the square of the magnetic field as derived in Eqs. (1.122-1.129). A repulsive magnetic force exists on the electron to be ionized due to the parallel alignment of the spin axes. The energy to move electron 2 to a radius which is infinitesimally greater than that of electron 1 is zero. In this case, the only force acting on electron 2 is the magnetic force. Due to conservation of energy, the potential energy change to move electron 2 to infinity to ionize the hydride ion can be calculated from the magnetic force of Eq. (13). The magnetic work, E_{magwork}, is the negative integral of the magnetic force (the second term on the right side of Eq. (13)) from r₂ to infinity,

$${E}_{magwork} = {\int }_{{r}_{2}}^{∞} \frac{{ℏ}^{2}}{2 {m}_{e} {r}^{3}} \sqrt{s ( s + 1 )} d r \qquad ( 15 )$$

where r₂ is given by Eq. (14). The result of the integration is

$${E}_{magwork} = - \frac{{ℏ}^{2} \sqrt{s ( s + 1 )}}{4 {m}_{e} {{a}_{0}^{2} [ 1 + \sqrt{s ( s + 1 )} ]}^{2}} \qquad ( 16 )$$

where

$$s = \frac{1}{2} .$$

By moving electron 2 to infinity, electron 1 moves to the radius r₁=a_{H}, and the corresponding magnetic energy, E_{electron 1 final} (magnetic), is given by Eq. (7.30). In the present case of an inverse squared central field, the binding energy is one half the negative of the potential energy [Fowles, G. R., Analytical Mechanics, Third Edition, Holt, Rinehart, and Winston, N.Y., (1977), pp. 154-156.]. Thus, the binding energy is given by subtracting the two magnetic energy terms from one half the negative of the magnetic work wherein mₑ is the electron reduced mass μₑ given by Eq. (1.167) due to the electrodynamic magnetic force between electron 2 and the nucleus given by one half that of Eq. (1.164). The factor of one half follows from Eq. (13).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ 1 + \sqrt{s ( s + 1 )} ]}^{2}} - \\ \frac{{πμ}_{0} {e}^{2} {ℏ}^{2}}{{m}_{e}^{2} {a}_{0}^{3}} ( 1 + \frac{{2}^{2}}{{[ 1 + \sqrt{s ( s + 1 )} ]}^{3}} )\end{matrix} \qquad ( 17 )$$

The binding energy of the hydride ion H⁻(n=1) is 0.75402 eV according to Eq. (17). The experimental value given by Dean [John A. Dean, Editor, Lange's Handbook of Chemistry, Thirteenth Edition, McGraw-Hill Book Company, New York, (1985), p. 3-10.] is 0.754209 eV which corresponds to a wavelength of λ=1644 nm. Thus, both numbers approximate to a binding energy of about 0.8 eV.

### Hydrino Hydride

The hydrino atom H(½) can form a stable hydride ion. The central field is twice that of the hydrogen atom, and it follows from Eq. (13) that the radius of the hydrino hydride ion H⁻(n=½) is one half that of an ordinary hydrogen hydride ion, H⁻(n=1), given by Eq. (14).

$${r}_{2} = {r}_{1} = \frac{{a}_{0}}{2} ( 1 + \sqrt{s ( s + 1 )} ) ; s = \frac{1}{2} \qquad ( 18 )$$

The energy follows from Eq. (17) and Eq. (18).

$$\begin{matrix}\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{2} ]}^{2}} - \\ \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{2} ]}^{3}} )\end{matrix} & ( 19 )\end{matrix}$$

The binding energy of the hydrino hydride ion H⁻(n=½) is 3.047 eV according to Eq. (19), which corresponds to a wavelength of λ=407 nm. In general, the central field of hydrino atom H(n=1/p); p=integer is p times that of the hydrogen atom. Thus, the force balance equation is

$$\frac{{ℏ}^{2}}{2 {m}_{e} {r}_{2}^{3}} = \frac{\frac{p}{2} {e}^{2}}{4 {πɛ}_{o} {r}_{2}^{2}} - \frac{1}{Z} \frac{{ℏ}^{2}}{2 {m}_{e} {r}_{2}^{3}} \sqrt{s ( s + 1 )} \qquad ( 20 )$$

where Z=1 because the field is zero for r>r₁. Solving for r₂,

$${r}_{2} = {r}_{1} = \frac{{a}_{0}}{p} ( 1 + \sqrt{s ( s + 1 )} ) ; s = \frac{1}{2} \qquad ( 21 )$$

From Eq. (21), the radius of the hydrino hydride ion H⁻(n=1/p); p=integer is 1/p that of atomic hydrogen hydride, H⁻(n=1), given by Eq. (14). The energy follows from Eq. (20) and Eq. (21).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{2} ]}^{2}} - \\ \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{2} ]}^{3}} )\end{matrix} \qquad ( 22 )$$

TABLE 1 provides the binding energy of the hydrino hydride ion H⁻(n=1/p) as a function of p according to Eq. (22).

### Hydride Reactor

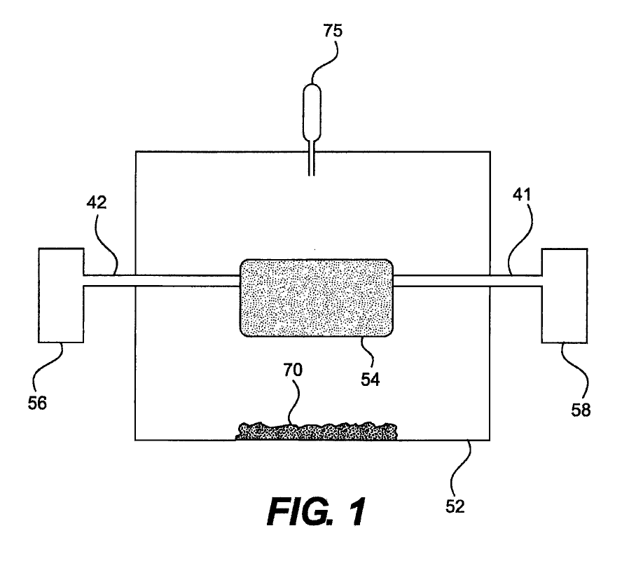

One embodiment of the present invention involves a hydride reactor shown in FIG. 1, comprising a vessel 52 having a catalysis mixture 54. The catalysis mixture 54 comprises a source of atomic hydrogen 56 supplied through hydrogen supply passage 42 and a catalyst 58 having a net enthalpy of reaction of about m·27.21 eV, where m is an integer supplied through catalyst supply passage 41. The catalysis involves reacting atomic hydrogen from the source 56 with the catalyst. The hydride reactor includes an electron source 70 contacting hydrinos and reducing them to hydrino hydride ions.

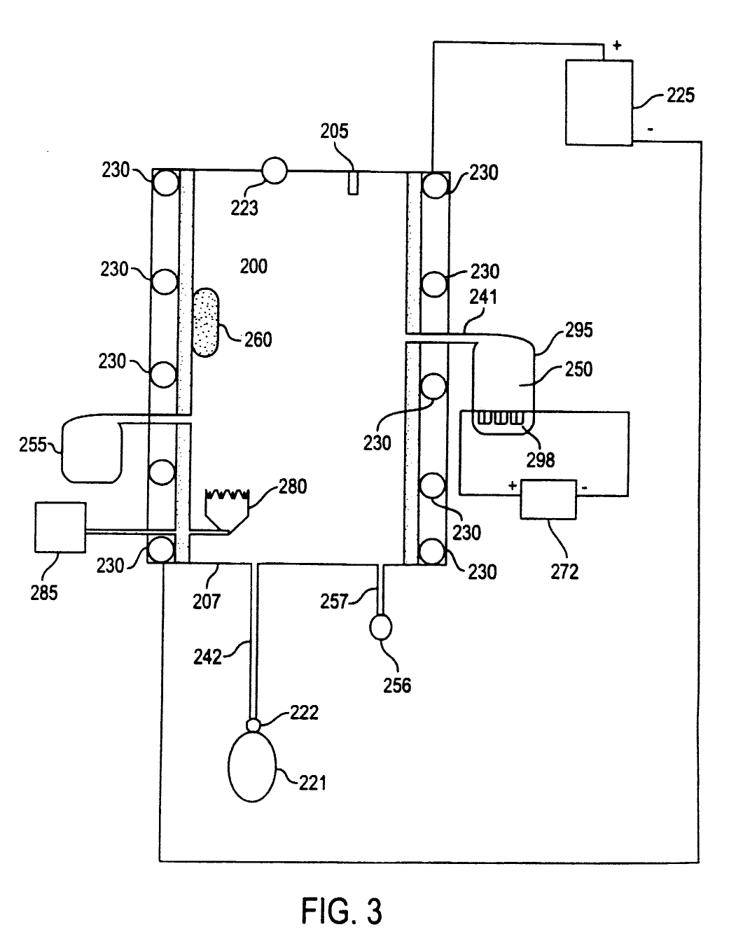

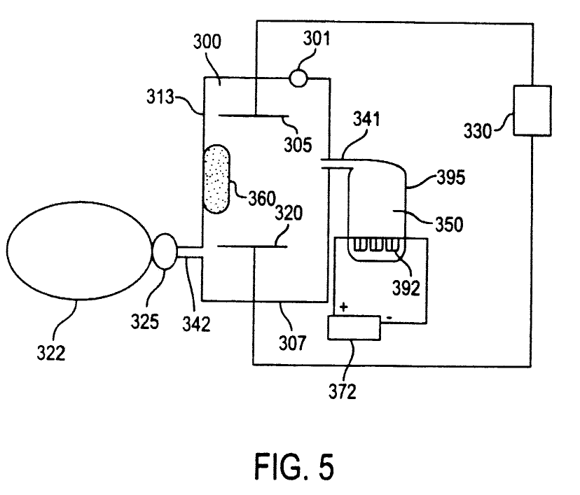

The source of hydrogen can be hydrogen gas, dissociation of water including thermal dissociation, electrolysis of water, hydrogen from hydrides, or hydrogen from metal-hydrogen solutions. According to one embodiment of the invention, molecular hydrogen is dissociated into atomic hydrogen by using a catalyst including the noble metals such as palladium and platinum, the refractory metals such as molybdenum and tungsten, the transition metals such as nickel and titanium, and the inner w transition metals such as niobium and zirconium, and other such materials listed in the Prior Mills Publications. In embodiments of the gas cell hydride reactor and gas discharge cell hydride reactor shown in FIGS. 3 and 5, respectively, a photon source 75 of FIG. 1 dissociates hydrogen molecules to hydrogen atoms. In all embodiments, the catalyst can be one or more of an electrochemical, chemical, photochemical, thermal, free radical, sonic, or nuclear reaction(s) or inelastic photon or particle scattering reaction(s). In the latter two cases, the hydride reactor comprises a particle source and/or photon source 75 of FIG. 1 to supply the catalyst as an inelastic scattering reaction. In one embodiment, the catalyst includes an electrocatalytic ion or couple(s) in the molten, liquid, gaseous, or solid state given in the Tables of the Prior Mills Publications (e.g. TABLE 4 of PCT/US90/01998 and pages 25-46, 80-108 of PCT/US94/02219).

In an embodiment wherein the catalysis occurs in the gas phase, the catalyst is maintained at a pressure less than atmospheric, preferably the range 10 millitorr to 100 torr, and the atomic and/or molecular hydrogen is maintained at a pressure less than atmospheric, preferably the range 10 millitorr to 100 torr.

The present invention of an electrolytic cell hydride reactor, gas cell hydride reactor, a gas discharge cell hydride reactor, and a plasma torch cell hydride reactor comprises: a source of atomic hydrogen; at least one of a solid, molten, liquid, or gaseous catalyst; and a vessel for containing the atomic hydrogen and the catalyst. The identification, methods, and apparatus for hydrino production including a listing of effective catalysts, and sources of hydrogen atoms are described in the Prior Mills Publications. The hydrinos react with the electrons to form hydrino hydrides. The method and apparatus to reduce hydrinos to hydrino hydrides includes the reduction at the cathode of the electrolytic cell, chemical reduction by a reactant of the gas cell, reduction by the plasma electrons or by the cathode of the gas discharge cell, or reduction by plasma electrons of the plasma torch cell.

### Electrolytic Cell Hydride Reactor

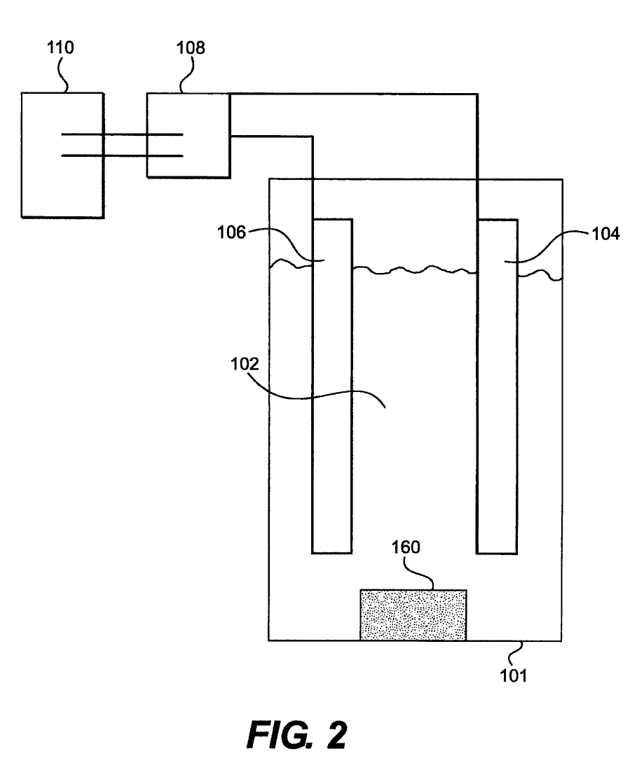

An electrolytic cell hydride reactor of the present invention is shown in FIG. 2. An electric current is passed through an electrolytic solution 102 by the application of a voltage to an anode 104 and cathode 106 by the power controller 108 powered by the power supply 110. The electrolytic solution 102 contains a catalyst for producing hydrino atoms.

One embodiment of the electrolytic cell hydride reactor comprises a nickel cathode 106 and a platinized titanium or nickel anode 104 used to electrolyze an aqueous about 0.5 M K₂CO₃ electrolytic solution 102 (K⁺/K⁺ catalyst) where the cell is operated within a voltage range of 1.4 to 3 volts. In one embodiment, the electrolytic solution 102 is molten.

Hydrino atoms form at the cathode 106 via the contact of the catalyst of the electrolyte 102 with the hydrogen atoms generated at the cathode 106. The apparatus further comprises a source of electrons in contact with the hydrinos to form hydrino hydrides. In the electrolytic cell, the hydrinos are reduced (i.e. gain the electron) to hydrino hydrides by contacting 1.) the cathode 106, 2.) a reductant which comprises the cell vessel 101, or 3.) any of the reactor's components including features designated as 104, and 102, or 4.) a reductant 160 extraneous to the operation of the cell (i.e. a consumable reductant added to the cell from an outside source). Thus, any of these reductants may comprise the electron source. A compound may form between a hydrino hydride anion and a cation. In the case of the electrolytic cell, the cation includes either an oxidized species of the material of the cathode or anode, a cation of an added reductant, or a cation of the electrolyte including a cation comprising the catalyst.

### Gas Cell Hydride Reactor

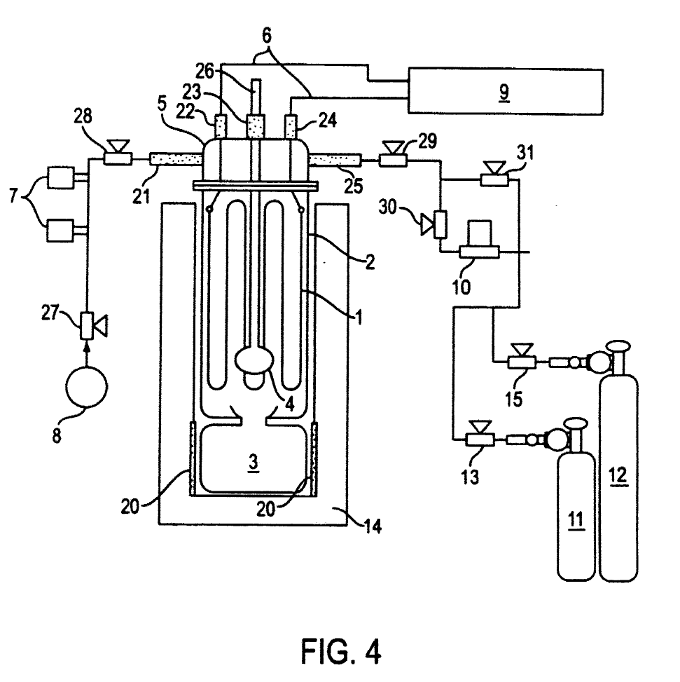

According to another embodiment of the invention, a hydride reactor for producing hydrino hydrides make take the form of a hydrogen gas cell hydride reactor. A gas cell hydride reactor of the present invention is shown in FIG. 3, and an experimental gas cell hydride reactor is shown in FIG. 4. Reactant hydrinos are provided by an electrocatalytic and/or a disproportionation reaction, wherein the catalysis may occur in the gas phase. The reactor comprises a reaction vessel 207 having a chamber 200 capable of containing a vacuum or pressures greater than atmospheric; a source of hydrogen 221; a means 222 to control the pressure and flow of hydrogen into the vessel through hydrogen supply passage 242, a pressure sensor 223, a vacuum pump 256, and a vacuum line 257; a source of atomic hydrogen in the gas so phase 280, and a catalyst in the gas phase including the electrocatalytic ions and couples described in the Mills Prior Publications. The apparatus further comprises a source of electrons in contact with the hydrinos to form hydrino hydrides.

The catalyst 250 can be placed in a catalyst reservoir 295. In such an embodiment, the reaction vessel 207 has a catalyst supply passage 241 for the passage of the gaseous catalyst from the catalyst reservoir 295 to the reaction chamber 200. In another embodiment, the catalyst can be placed in a chemically resistant open container such as a boat inside the reaction vessel.

The molecular and atomic hydrogen as well as the catalyst partial pressure in the reaction vessel 207 is preferably maintained at the range of 10 millitorr to 100 torr. Most preferably, the hydrogen partial pressure in the reaction vessel 207 is maintained at about 200 millitorr.

Molecular hydrogen is dissociated into atomic hydrogen by 1.) a dissociating material including noble metals such as platinum or palladium, transition metals such as nickel and titanium, inner transition metals such as niobium and zirconium, or refractory metals such as tungsten or molybdenum, 2.) electromagnetic radiation including UV light provided by a photon source 205, or 3.) a hot filament or grid 280 having power supply 285. The hydrogen dissociation occurs such that the dissociated hydrogen atoms contact a catalyst including a molten, liquid, gaseous, or solid catalyst to form hydrino atoms. The catalyst vapor pressure is maintained at the desired pressure by controlling the temperature of the catalyst reservoir 295 with a catalyst reservoir heater 298 having a power supply 272. In another embodiment, the catalyst vapor pressure is maintained at the desired pressure by controlling the temperature of the catalyst boat by adjusting its power supply.

The rate of production of hydrinos directly and hydrino hydride indirectly by the gas cell hydride reactor can be controlled by controlling the amount of catalyst in the gas phase and/or by controlling the concentration of atomic hydrogen or hydrinos. The concentration of the gaseous catalyst in the vessel chamber 200 can be controlled by controlling the initial amount of the volatile catalyst present in the chamber 200 which completely vaporizes, and/or by controlling the catalyst temperature with the catalyst reservoir heater 298 or the catalyst boat heater. The vapor pressure of the volatile catalyst 250 in the chamber 200 is determined by the temperature of the catalyst reservoir 295 or the catalyst boat, because each is colder than the reactor vessel 207. The reactor vessel 207 temperature is maintained at a kb higher operating temperature with heat liberated by the catalysis and hydrino reduction and/or with a temperature control means 230 such as a heating coil shown in cross section in FIG. 3 having a power supply 225. The reactor temperature further controls the reaction rates.

The temperature of a stainless steel alloy reactor vessel 207 is preferably maintained at 200-1200° C. The temperature of a molybdenum reactor vessel 207 is preferably maintained at 200-1800° C. The temperature of a tungsten reactor vessel 207 is preferably maintained at 200-3000° C. The temperature of a quartz or ceramic reactor vessel 207 is preferably maintained at 200-1800° C.

The concentration of atomic hydrogen can be controlled by the amount of atomic hydrogen provided by the atomic hydrogen source 280 and the amount of molecular hydrogen supplied from the hydrogen source 221 controlled by a flow controller 222 and a pressure sensor 223. The reaction rate may be monitored by windowless ultraviolet (UV) emission spectroscopy to detect the intensity of the UV emission due to the catalysis and the hydrino hydride emission.

The apparatus to make hydrino hydrides further comprises an electron source 260 in contact with the hydrinos to form hydrino hydrides. In the gas cell, the hydrinos are reduced to hydrino hydrides by contacting 1.) a reductant comprising the reactor vessel 207, or 2.) any of the reactor's components including features designated as 205, 250, 298, 295, 280, 223, 221, 222, 256, 257, 241, and 242 or 3.) a reductant 260 extraneous to the operation of the cell (i.e. a consumable reductant added to the cell from an outside source). Thus, any of these reductants may comprise the electron source.

Compound comprising a hydrino hydride anion and a cation may be formed in the gas cell. The cation comprises either an oxidized species comprising either the material of the cell, a cation comprising the molecular hydrogen dissociation material which produces atomic hydrogen, a cation comprising an added reductant, or a cation present in the cell including the cation of the catalyst.

In another embodiment of the gas cell hydride reactor using a gaseous catalyst, hydrogen atoms are produced by pyrolysis, such as the combustion of a hydrocarbon. In one mode, pyrolysis occurs in an internal combustion or combustion turbine engine. The hydrocarbon or hydrogen containing fuel comprises the catalyst which is vaporized (becomes gaseous) during the combustion. In another mode, the catalyst is a thermally stable salt of rubidium or potassium such as RbF, RbCl, RbBr, RbI, Rb₂S₂, RbOH, Rb₂SO₄, Rb₂CO₃, Rb₃PO₄, and KF, KCl, KBr, KI, K₂S₂, KOH, K₂SO, K₂CO₃, K₃PO₄, K₂GeF₄. Additional counterions of the electrocatalytic ion or couple include organic anions, including wetting or emulsifying agents.

In another embodiment, the hydrocarbon or hydrogen containing fuel further comprises water as a mixture and a solvated source of catalyst including emulsified electrocatalytic ions or couples. During pyrolysis, water serves as a further source of hydrogen atoms which undergo catalysis. The water can be dissociated into hydrogen atoms thermally or catalytically on a surface, such as the cylinder or piston head, which can comprise material dissociating water to hydrogen and oxygen. The water dissociation material includes an element, compound, alloy, or mixture of transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and Cs intercalated carbon (graphite).

In another embodiment, during each engine cycle, vaporized catalyst is drawn from the catalyst reservoir 295 through the catalyst supply passage 241 into the cylinder which corresponds to the vessel chamber 200 where the amount of catalyst 250 used per engine cycle may be determined by the vapor pressure of the catalyst and the gaseous displacement volume of the catalyst reservoir 295. The vapor pressure of the catalyst may be controlled by controlling the temperature of the catalyst reservoir 295 with the reservoir heater 298.

The present embodiment of the apparatus to make hydrino atoms and hydrino hydrides includes a source of electrons, such as a hydrino reducing reagent, in contact with hydrinos to form hydrino hydrides.

### Gas Discharge Cell Hydride Reactor

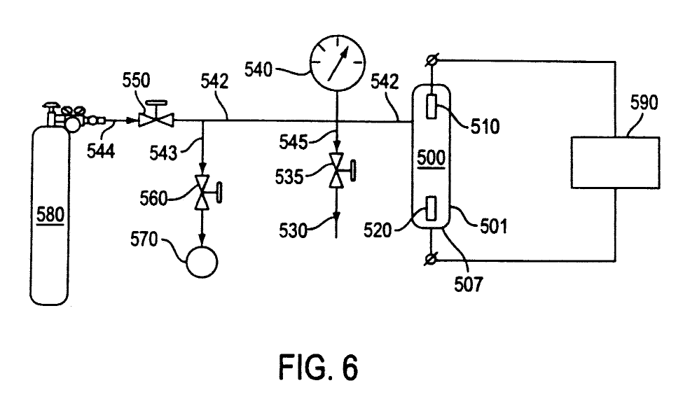

A gas discharge cell hydride reactor of the present invention is shown in FIG. 5, and an experimental discharge cell hydrino hydride reactor is shown in FIG. 6. The gas discharge cell hydride reactor of FIG. 5, including an ozonizer-type capacitor, comprises a hydrogen isotope gas-filled glow discharge vacuum vessel 313 having a chamber 300; a hydrogen source 322 which supplies hydrogen to the chamber 300 through control valve 325 and hydrogen supply passage 342; a catalyst, including compounds described in Mills Prior Publications (e.g. TABLE 4 of PCT/US90/01998 and pages 25-46, 80-108 of PCT/US94/02219); and a voltage and current source 330 to cause current to pass between a cathode 305 and an anode 320 which may be reversible.

In one embodiment, the cell wall 313 is conducting and serves as the anode. In another embodiment, the cathode 305 is hollow such as a hollow, nickel, aluminum, copper, or stainless steel hollow cathode.

The cathode 305 may be coated with the catalyst. The hydrogen catalysis occurs on the cathode surface, and atomic hydrogen is dissociated on the cathode because it comprises a hydrogen dissociative material and/or the hydrogen is dissociated by the discharge.

Alternatively, the discharge vaporizes the catalyst to provide a gaseous catalyst. Or, the gaseous catalyst is produced by the discharge current such as a discharge in potassium metal to form K⁺/K⁺, rubidium metal to form Rb⁺, or titanium metal to form Ti²⁺. The gaseous hydrogen atoms are provided by a discharge of molecular hydrogen gas such that the catalysis occurs in the gas phase.

Another embodiment of the gas discharge cell hydride reactor where catalysis occurs in the gas phase, comprises a controllable gaseous catalyst, and the gaseous hydrogen atoms are provided by a discharge of molecular hydrogen gas. The gas discharge cell 307 has a catalyst supply passage 341 for the passage of the gaseous catalyst from a catalyst reservoir 395 to the reaction chamber 300. The catalyst reservoir 395 is heated with a catalyst reservoir heater 392 having a power supply 372 to provide the gaseous catalyst to the reaction chamber 300. The catalyst vapor pressure is controlled by controlling the temperature of the catalyst reservoir 395 by adjusting the heater 392 with its power supply 372.

In another embodiment of the gas discharge cell hydride reactor where catalysis occurs in the gas phase comprising a controllable gaseous catalyst and gaseous hydrogen atoms provided by a discharge of W molecular hydrogen gas, a chemically resistant (does not react or degrade during the operation of the reactor) open container, such as a tungsten or ceramic boat, inside the gas discharge cell has the catalyst. The catalyst in the catalyst boat is heated with a boat heater using its power supply to provide the gaseous catalyst to the reaction chamber. In another embodiment, the glow discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The cell may be operated at room temperature by continuously supplying catalyst. Or, to prevent the catalyst from condensing in the cell, its temperature is maintained above that of the catalyst source, catalyst reservoir 395 or catalyst boat. In an embodiment, the temperature of a stainless steel alloy cell is 0-1200° C.; the temperature of a molybdenum cell is 0-1800° C.; the temperature of a tungsten cell is 0-3000° C.; the temperature of a glass, quartz, or ceramic cell is 0-1800° C. In an embodiment, the discharge voltage is in the range 1000 to 50,000 volts, and the current is about 1 mA or in the range 1 μA to 1 A.

The apparatus to make hydrino hydrides includes an electron source in contact with the hydrinos. In the gas discharge cell, the hydrinos are reduced to hydrino hydrides by contacting 1.) the cathode 305, 2.) plasma electrons, 3.) the vessel 313, or 4.) any of the reactor components including features designated as 305, 320, 350, 392, 395, 301, 325, 322, 342, and 341, or 5) a reductant 360 extraneous to the operation of the cell (e.g. a consumable reductant added to the cell from an outside source). Thus, any of these reductants may comprise the electron source.

The present invention is directed to novel compounds having a hydrino hydride anion and a cation. In the discharge cell, the cation includes either an oxidized species of the material comprising the cathode or the anode, a cation of an added reductant, or a cation present in the cell, including the catalyst.

In one embodiment, potassium or rubidium hydrino hydride is prepared in the gas discharge cell 307 comprising the catalyst reservoir 395 containing KI or RbI catalyst with the heater 392 to control the catalyst vapor pressure in the gas discharge cell. The catalyst reservoir 395 is heated with the heater 392 to maintain the catalyst vapor pressure at the cathode 305 and negative glow region preferably in the pressure range 10 millitorr to 100 torr or more preferably at about 200 mtorr. In another embodiment, the cathode 305 and the anode 320 of the gas discharge cell 307 are coated with KI or RbI catalyst and are vaporized during the operation of the cell. The hydrogen supply from source 322 is adjusted with control 325 to supply hydrogen and maintain the hydrogen pressure in the 10 millitorr to 100 torr range.

In one embodiment, catalysis occurs in a hydrogen plasma discharge cell using a catalyst with a net enthalpy of about 27.2 electron volts. The catalyst (e.g. potassium ions) is vaporized by the hot discharge which also produces reactant hydrogen atoms. Catalysis using potassium ions results in the emission of extreme ultraviolet (UV) photons. In addition to the transition

$$H [ \frac{{a}_{H}}{1} ] {}^{{K}^{+} / {K}^{+}} H [ \frac{{a}_{H}}{2} ] + 912 Å ,$$

the disproportionation reaction causes additional emission of extreme UV at 912 Å and 304 Å. Extreme UV photons ionize hydrogen resulting in the emission of the normal spectrum of hydrogen which includes visible light. Thus, the extreme UV emission from the catalysis is observable indirectly as indicated by the conversion of the extreme UV to visible wavelengths. At the same time, hydrinos react with electrons to form hydrino hydride ions having the continuum absorption and emission lines given in TABLE 1. These lines are observable by emission spectroscopy. However, the hydrogen spectrum produced by the plasma discharge must be removed.

A method and apparatus of the present invention to remove the hydrogen discharge emission to permit observation of hydrino and hydrino hydride emission is gated recording of a pulsed plasma discharge cell with a volatilized catalyst (e.g. K⁺/K⁺). In one such embodiment, the charged coupled device (CCD) of a video camera is triggered to the off status by the firing pulse of the discharge power supply. Then during the discharge-off phase of the cycle, the video camera is activated to record. The cell discharge produces the hydrogen atoms and vaporizes the catalyst. For example, potassium iodide dimers are generated in the gas phase. The half-life of hydrogen atoms at 200 mtorr is about one second [N. V. Sidgwick, The Chemical Elements and Their Compounds, Volume I, Oxford, Clarendon Press, (1950), p. 17.]. The w lifetime of vaporized catalyst is comparable. Thus, with a low hydrogen pressure, catalysis occurs in the gas phase during the off phase of the pulsed discharge cell. The discharge time constant and the time constants for atomic relaxation due to discharge excitation are less than several microseconds. The camera is much slower. Thus, the cell is pulsed at a frequency less than the frame frequency of the video camera (e.g. 30 frames/sec). An example is pulsing the discharge at 10 Hz. No light is produced during the discharge-off phase. Thus, visible light emission not directly associated with the discharge is recorded. This emission is confirmed to be due to catalysis by replicating the experiment with sodium in place of potassium (the catalyst control), and by replicating the experiment with helium in place of hydrogen (the hydrogen control). The absence of emission during the discharge-off phase identifies this emission in the potassium experiment as catalysis of hydrogen to form hydrinos and hydrino hydrides.

### Plasma Torch Cell Hydride Reactor

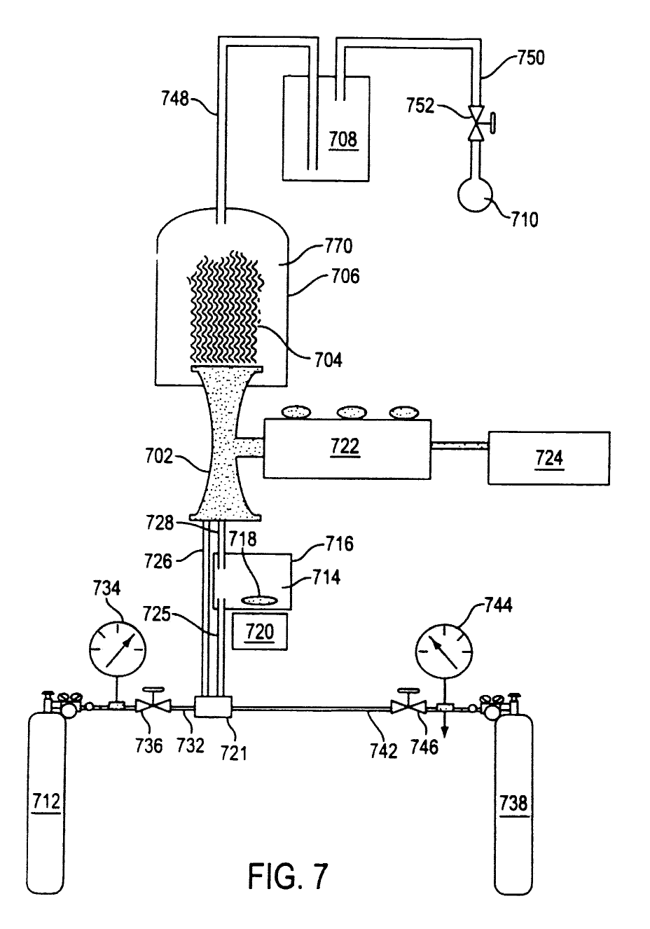

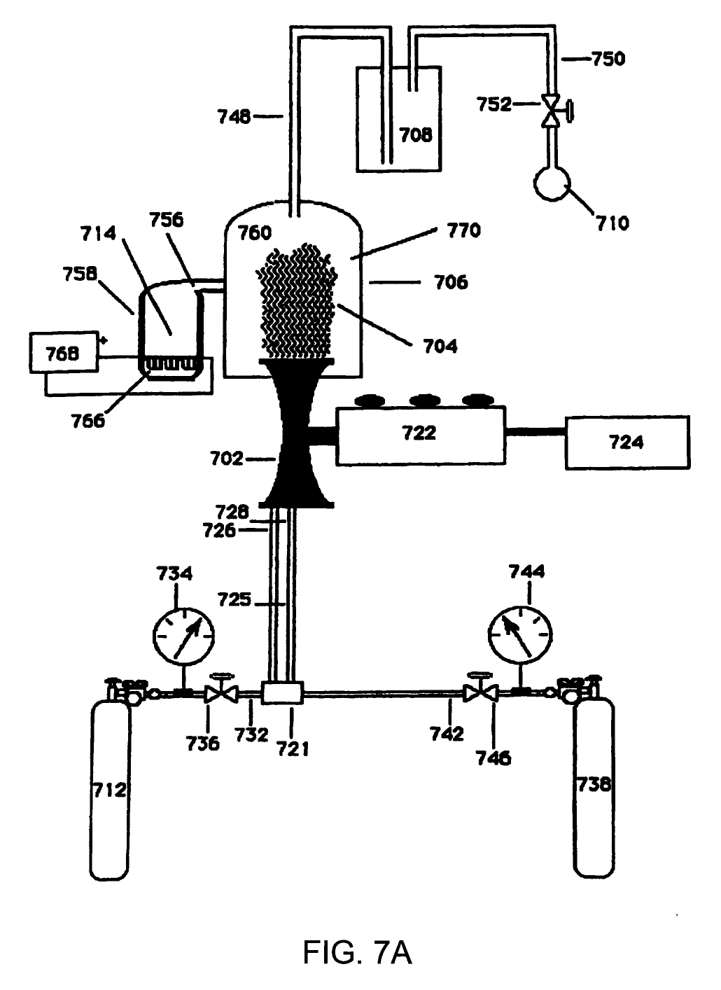

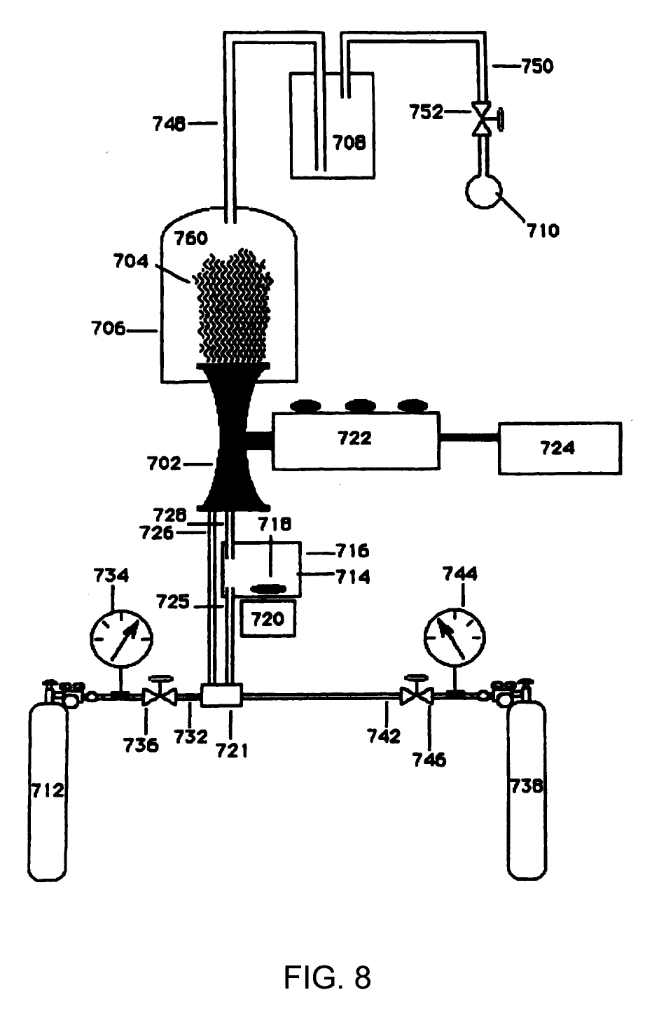

A plasma torch cell hydride reactor of the present invention is shown in FIG. 7, and an experimental plasma torch cell hydride reactor is shown in FIG. 8. A plasma torch cell hydride reactor of FIG. 7 comprises a plasma torch 702 with a hydrogen isotope plasma 704 enclosed by a manifold 706, a hydrino hydride trap 708, a vacuum pump 710, a plasma gas supply 712 including an argon gas supply, a hydrogen supply 738, a hydrogen-plasma-gas mixer and mixture flow regulator 721, a catalyst 714, including compounds described in Mills Prior Publications (e.g. TABLE 4 of PCT/US90/01998 and pages 25-46, 80-108 of PCT/US94/02219), a catalyst reservoir 716, a mechanical agitator including a magnetic stirring bar 718 and magnetic stirring bar motor 720, a tunable microwave cavity 722, and a microwave generator 724. The hydrogen is supplied to the torch 702 by at least one of a hydrogen passage 726 or a passage for both hydrogen and catalyst 728. The plasma gas is supplied to the torch by at least one of a plasma gas passage 726 or a passage for plasma gas and catalyst 728.

Hydrogen flows from the hydrogen supply 738 to the catalyst reservoir 716 via passage 742 and passage 725 wherein the flow of hydrogen is controlled by hydrogen flow controller 744 and valve 746. Plasma gas flows from the plasma gas supply 712 directly to the plasma w torch via passage 732 and 726 and to the catalyst reservoir 716 via passage 732 and 725 wherein the flow of plasma gas is controlled by plasma gas flow controller 734 and valve 736. The mixture of plasma gas and hydrogen supplied to the torch via passage 726 and to the catalyst reservoir 716 via passage 725 is controlled by the hydrogen-plasma-gas mixer and mixture flow regulator 721. The hydrogen and plasma gas mixture serves as a carrier gas for catalyst particles which are dispersed into the gas stream as fine particles by mechanical agitation. The mechanical agitator includes the magnetic stirring bar 718 and the magnetic stirring motor 720. The aerosolized catalyst and hydrogen gas of the mixture flow into the plasma torch 702 and become gaseous hydrogen atoms and vaporized catalyst ions (including K⁺ ions from KI) in the plasma 704. The plasma is powered by microwave generator 724 wherein the microwaves are tuned by the tunable microwave cavity 722. Catalysis occurs in the gas phase.

The amount of gaseous catalyst is controlled by controlling the rate that catalyst is aerosolized with the mechanical agitator and the carrier gas flow rate where the carrier gas includes a hydrogen and plasma gas mixture (e.g. hydrogen and argon). The amount of gaseous hydrogen atoms is controlled by controlling the hydrogen flow rate and the ratio of hydrogen to plasma gas in the mixture. The hydrogen flow rate, the plasma gas flow rate, and the mixture directly to the torch and the mixture to the catalyst reservoir are controlled with flow rate controllers 734 and 744, valves 736 and 746 and hydrogen-plasma-gas mixer and mixture flow regulator 721. The catalysis rate is also controlled by controlling the temperature of the plasma with the microwave generator 724.

Hydrino atoms and hydrino hydride are produced in the plasma 704. Hydrino hydride is cryopumped onto the manifold 706, or it flows into the trap 708 through passage 748. A flow to the trap 708 is effected by a pressure gradient controlled by the vacuum pump 710, vacuum line 750, and vacuum valve 752.

In another embodiment shown in FIG. 7A, at least one of the plasma torch 702 or the manifold 706 has a catalyst supply passage 756 for the passage of the gaseous catalyst from a catalyst reservoir 758 to the plasma 704. The catalyst in the catalyst reservoir 758 is heated by a catalyst reservoir heater 766 having a power supply 768 to provide the gaseous catalyst to the plasma 704. The catalyst vapor pressure is controlled by controlling the temperature of the catalyst reservoir 758 by adjusting the heater 766 with its power supply 768. In another embodiment, a chemically resistant open container such as a ceramic boat inside the manifold has the catalyst. The plasma torch manifold forms a cell which is operated at an elevated temperature such that the catalyst in the boat is sublimed, boiled, or volatilized into the gas phase. Or, the catalyst in the catalyst boat is heated with a boat heater having a power supply to provide the gaseous catalyst to the plasma. The catalyst vapor pressure is controlled by controlling the temperature of the cell with a cell heater, or by controlling the temperature of the boat by adjusting the boat heater with its power supply.

The plasma temperature is maintained in the range of 5,000-30,000° C. The cell may be operated at room temperature by continuously supplying catalyst. Or, to prevent the catalyst from condensing in the cell, its temperature is maintained above that of the catalyst source, catalyst reservoir 758 or catalyst boat. The temperature of a stainless steel alloy cell is preferably 0-1200° C. The temperature of a molybdenum cell is preferably 0-1800° C. The temperature of a tungsten cell is preferably 0-3000° C. The temperature of a glass, quartz, or ceramic cell is preferably 0-1800° C. The cell pressure is atmospheric in the embodiment that the manifold 706 is open to the atmosphere. An exemplary plasma gas is argon; exemplary aerosol flow rates are 0.8 standard liters per minute (slm) hydrogen and 0.15 slm argon; an exemplary argon plasma flow rate is 5 slm; an exemplary forward input power is 1000 W, and an exemplary reflected power is 10-20 W.

In other embodiments, the mechanical catalyst agitator including a magnetic stirring bar 718 and a magnetic stirring bar motor 720 is replaced with an aspirator, atomizer, or nebulizer to form an aerosol of the catalyst 714 which is dissolved or suspended in a medium including water and contained in the catalyst reservoir 716. Or, the aspirator, atomizer, or nebulizer injects the catalyst directly into the plasma 704. The nebulized or atomized catalyst is carried into the plasma 704 by the carrier gas including hydrogen.

The apparatus to make hydrino hydrides includes an electron source in contact with the hydrinos. In the plasma torch cell, the hydrinos are reduced to hydrino hydrides by contacting 1.) the manifold 706, 2.) plasma electrons, or 4.) any of the reactor components including features designated as 702, 756, and 758, or 5) a reductant 770 extraneous to the operation of the cell (e.g. a consumable reductant added to the cell from an outside source). Thus, any of these reductants may comprise the electron source.

The present invention is directed to novel compounds having a hydrino hydride anion and a cation including a proton and H₃⁺, as well as hydrino atom(s), dihydrino molecular ion(s), and/or dihydrino molecule(s), and hydrogen atoms and hydrogen molecules. In the plasma torch cell, the cation includes either an oxidized species of the material comprising the torch or the manifold, a cation of an added reductant, or a cation present in the plasma, including the catalyst.

### Hydrino Hydride Purification

The construction and operation of a representative apparatus to purify hydrino hydride produced in an electrolytic cell hydride reactor is illustrated as follows. For example, extensively wash a 60 meter long nickel wire cathode from a potassium carbonate electrolytic cell with water and coil it around a 7 mm OD, 30 cm long hollow quartz tube and insert this tube into a 40 cm long, 12 mm OD quartz tube. Seal the larger quartz tube at both ends with Swagelock™ fittings and connect it to a Welch Duo Seal model 1402 mechanical vacuum pump with a stainless steel Nuprom™“H” series bellows valve. Install a thermocouple vacuum gauge tube and rubber septum on the apparatus side of the pump. Connect the nickel wire cathode to leads through the Swagelock™ fittings to a 220V AC transformer. Evacuate the apparatus containing the nickel wire to between 25 and 50 millitorr. Heat the wire to 800° C. by varying the transformer voltage. Physically remove the white crystals which collect at the cold ends of the evacuated quartz tube. The white crystals comprise the hydrino hydride and its cation which may be further purified by the methods described hereafter.

In the case of the electrolytic cell, gas cell, gas discharge cell, and plasma torch cell hydride reactor, compounds containing hydrino hydride ion(s), hydrino atom(s), dihydrino molecular ion(s), and/or dihydrino molecule(s) form crystals over time. Also, compounds of the removed electrode of the electrolytic cell, or gas discharge cell, or cell components of the gas cell, or plasma torch cell hydride reactor containing hydrino hydride ion(s), hydrino atom(s), dihydrino molecular ion(s), and/or dihydrino molecule(s) react with the electrode material, cell components, added reductant, or residual catalyst to form crystals containing hydrino hydride which are physically collected or removed by precipitation and recrystallization. The hydrino hydride may be further purified by the methods described hereafter.

A method to isolate and purify the hydrino hydride comprises the following steps: 1.) in the case of the electrolytic cell hydride reactor, remove the water of the electrolyte by evaporation; 2.) in the case of the electrolytic cell reactor and all other hydride reactor types, dissolve the remaining catalyst and suspend the hydrino hydride in a suitable solvent including water which preferentially dissolves the catalyst but not hydrino hydride; 3.) filter the solvent and collect the insoluble hydrino hydride crystals. An alternative method comprises the following steps: 1.) dissolve the remaining catalyst and suspend the hydrino hydride in a suitable solvent which preferentially dissolves the catalyst but not the hydrino hydride; 2.) then, allow the hydrino hydride crystals to grow on the surfaces of the cell; 3.) pour off the solvent and collect the hydrino hydride crystals.

Hydrino hydride may also be purified from the catalyst such as a potassium salt by: 1.) using different cation exchanges of the catalyst or hydrino hydride, or anion exchanges of the catalyst, which changes the difference in solubility of the hydrino hydride relative to the catalyst or other ions present, 2.) precipitation and recrystallization exploiting differential solubility in solvents such as organic solvents, or 3.) gas or liquid chromatography including high pressure liquid chromatography (HPLC).

Hydrino hydride may also be purified by distillation, sublimation, or cryopumping including under reduced pressure, such as 10 μtorr to 1 torr. A method to purify hydrino hydride from a catalyst including a potassium salt comprises distillation or sublimation. The catalyst, such as a potassium salt, is distilled off or sublimed and the residual hydrino hydride remains. The method comprises the following steps: 1.) remove contaminants or particulates by dissolving the product of the hydride reactor in a solvent such as water and filter the solution; 2.) exchange the anion of the catalyst to increase the difference in the boiling points of hydrino hydride versus the catalyst. For example, nitrate may be exchanged for carbonate or iodide to reduce the boiling point of the catalyst. In the case of a carbonate catalyst anion, nitrate may replace carbonate with the addition of nitric acid. In the case of an iodide catalyst anion, nitrate may replace iodide with the oxidation of the iodide to iodine with H₂O₂ and nitric acid to yield the nitrate. Nitrite replaces the iodide ion with the addition of nitric acid only. 3.) sublime the converted catalyst salt and collect the residual hydrino hydride.

Another embodiment of the method to purify hydrino hydride from a catalyst including a potassium salt, comprises distillation, sublimation, or cryopumping wherein the hydrino hydride has a higher vapor pressure than the catalyst. Thus, hydrino hydride is the distillate or sublimate which is collected. The separation is increased by exchanging the anion of the catalyst to increase its boiling point.

In one embodiment, wherein substitution of the catalyst anion is employed such that the resulting compound has a low melting point, a mixture comprising hydrino hydride is melted. The hydrino hydride is insoluble in the melt and thus precipitates from the melt. The melting occurs under vacuum such that the anion exchanged catalyst product including potassium nitrate partially sublimes. The mixture comprising hydrino hydride precipitate is dissolved in a minimum volume of a suitable solvent including water which preferentially dissolves the catalyst but not the hydrino hydride. The mixture is filtered to obtain hydrino hydride crystals.

The cation of the isolated hydrino hydride may be replaced by a different desired cation (e.g. K⁺ replaced by Li⁺) by reaction upon heating and concentrating the solution containing the desired cation or via ion exchange chromatography

One approach to purifying hydrino hydride comprises precipitation and recrystallization. In one method, hydrino hydride is recrystallized from an iodide solution containing hydrino hydride and one or more of potassium, lithium or sodium iodide which will not precipitate until the concentration is greater than 10 M. Thus, hydrino hydride can be preferentially precipitated. In the case of a carbonate solution, the iodide can be formed by neutralization with hydro iodic acid (HI). One embodiment to purify hydrino hydride comprises the following steps: 1.) rinse the KI catalyst from the gas cell, gas discharge cell or plasma torch hydride reactor and filter; 2.) make the filtrate approximately 5 M by addition of water or by concentrating via evaporation; and 3.) allow hydrino hydride crystals to form on standing and filter the precipitate.

In one embodiment, hydrino hydride is precipitated from an acidic solution (e.g. the pH range 6 to 1) by addition of an acid such as nitric, hydrochloric, hydro iodic, or sulfuric acid.

In another embodiment, hydrino hydride is isolated from the electrolyte of a K₂CO₃ electrolytic cell by: 1.) making the K₂CO₃ electrolyte from the electrolytic cell approximately 1 M in a cation that precipitates hydrino hydride, such as the cation provided by LiNO₃, NaNO₃, or Mg(NO₃)₂, 2.) acidifying the electrolyte with an acid including HNO₃, 3.) concentrating the acidified solution until a precipitate is formed; and 4.) filtering the solution to obtain the crystals, or allowing the solution to evaporate on a crystallization dish so that hydrino hydride crystallizes separately from the other compounds. In this case, the crystals are separated physically.

The hydrino hydride ion can bond to a cation with unpaired electrons such as a transition or rare earth cation to form a paramagnetic or ferromagnetic compound. In one embodiment, the hydrino hydride is separated from impurities, by magnetic separation in its crystalline form by sifting the mixture over a magnet including an electromagnet to which hydrino hydride adheres. The crystals are removed mechanically, or by rinsing. In the latter case, the rinse liquid is removed by evaporation. Or, in the case of electromagnetic separation, the electromagnet is then inactivated and the hydrino hydride is collected.

The compounds of the present invention comprising hydrino hydride ion(s), hydrino atom(s), dihydrino molecular ion(s), and/or dihydrino molecule(s) as well as ordinary hydrogen atoms and molecules are substantially pure as isolated and purified by the exemplary methods given herein. That is, the isolated material comprises greater than 50 atomic percent of said compound.

### Identification of Increased Binding Energy Hydrogen Compounds

The increased binding energy hydrogen compounds may be identified by a variety of methods. The identification methods comprise: 1.) elemental analysis, 2.) solubility, 3.) reactivity, 3.) melting point, 4.) boiling point, 5.) vapor pressure as a function of temperature, 6.) refractive index, 7.) X-ray photoelectron spectroscopy (XPS), 9.) X-ray diffraction (XRD), 10.) infrared spectroscopy (IR), 11.) nuclear magnetic resonance spectroscopy, 12.) gas phase mass spectroscopy of a heated sample, and 13.) time of flight secondary ion mass spectroscopy (TOFSIMS). Further methods to identify hydrino hydrides involve XPS and XRD of carbon cathodes of the electrolytic cell and the gas discharge cell hydride reactors. Spectroscopic methods of hydrino hydride identification include ultraviolet (UV) and visible emission spectroscopy of the discharge cell and the gas cell. XPS and XRD of carbon cathodes identify hydrino hydride by its binding energies and by the unique XRD pattern of hydrino hydride, respectively. Ultraviolet (UV) and visible emission spectroscopy of the discharge cell and the gas cell identify hydrino hydride by the presence of hydrino hydride continuum lines.

A first preferred method of identification of hydrino hydride is to obtain purified crystals and perform XPS and mass spectroscopy of volatilized hydrino hydride. The mass spectrometer is heated to about 115° C., the sample port is heated to about 150° C., and a chamber containing hydrino hydride crystals such as a fritted capillary is heated to various temperatures such as 110° C., 145° C., and 175° C. as the mass spectrum is recorded to identify volatilized hydrino hydride compounds. Mass spectroscopy is also performed in situ on a crystal following XPS by heating the sample stage and recording the mass spectrum with an on-line residual gas analyzer of the XPS.

A second preferred method of identification of hydrino hydride is to obtain purified crystals and perform extreme ultraviolet (EUV) and ultraviolet (UV) spectroscopy and mass spectroscopy of volatilized hydrino hydride. In one embodiment, the excited emission of hydrino hydride is observed wherein the source of excitation is a plasma discharge, and the mass spectrum is recorded with an on-line mass spectrometer to identify volatilized hydrino hydride compounds. In another embodiment, hydrino and the hydrino hydride compounds are formed in a hydrino hydride reactor of the present invention which is on-line to a EUV and UV spectrometer and a mass spectrometer. The emission spectrum of the catalysis of hydrogen and the emission due to formation and excitation of hydrino hydride compounds is recorded. In yet another embodiment, the catalyst of the hydrino hydride reactor is KI or KNO₃, and the catalyst of the gas discharge or plasma torch cell w hydrino hydride reactor is KI, KNO₃, or argon gas that is ionized by the discharge or plasma to form the active catalyst Ar⁺. A further active catalyst of the argon/hydrogen mixture of the gas discharge or plasma m torch cell hydrino hydride reactor is Ar²⁺ with H⁺.

### Dihydrino Methods

The theoretical introduction to dihydrinos is provided in the '96 Mills GUT. Two hydrino atoms

$$H [ \frac{{a}_{H}}{p} ]$$

may react to form a diatomic molecule referred to as a dihydrino

$${H}_{2}^{⋆} [ 2 {c}^{′} = \frac{\sqrt{2} {a}_{o}}{p} ] .$$

$$2 H [ \frac{{a}_{H}}{p} ] \to {H}_{2}^{⋆} [ 2 {c}^{′} = \frac{\sqrt{2} {a}_{o}}{p} ] \qquad ( 23 )$$

where p is an integer. The dihydrino comprises a hydrogen molecule having a total energy,

$${E}_{T} ( {H}_{2}^{⋆} [ 2 {c}^{′} = \frac{\sqrt{2} {a}_{o}}{p} ] ) ,$$

$${E}_{T} ( {H}_{2}^{⋆} [ 2 {c}^{′} = \frac{\sqrt{2} {a}_{o}}{p} ] ) = - 13.6 eV [ \begin{matrix}( 2 {p}^{2} \sqrt{2} - {p}^{2} \sqrt{2} + \frac{{p}^{2} \sqrt{2}}{2} ) \\ ln \frac{\sqrt{2} + 1}{\sqrt{2} - 1} - {p}^{2} \sqrt{2}\end{matrix} ] \qquad ( 24 )$$

where 2c′ is the internuclear distance and aₒ is the Bohr radius. Thus, the relative internuclear distances (sizes) of dihydrinos are fractional. Without considering the correction due to zero order vibration, the bond dissociation energy,

$${E}_{D} ( {H}_{2}^{⋆} [ 2 {c}^{′} = \frac{\sqrt{2} {a}_{o}}{p} ] ) ,$$

is given by the difference between the energy of two hydrino atoms each given by the negative of Eq. (2) and the total energy of the dihydrino molecule given by Eq. (24). (The bond dissociation energy is defined as the energy required to break the bond).

$${E}_{T} ( {{H}_{2}^{⋆} [ 2 {c}^{′} = \frac{2 {a}_{o}}{p} ]}^{+} ) = 13.6 eV ( - 4 {p}^{2} ln 3 + {p}^{2} + 2 {p}^{2} ln 3 ) \qquad ( 26 )$$

The first binding energy, BE₁, of the dihydrino molecular ion with consideration of zero order vibration is about

$${BE}_{1} = \frac{16.4}{{( \frac{1}{p} )}^{2}} eV \qquad ( 26 a )$$

Without considering the correction due to zero order vibration, the bond dissociation energy,

$${E}_{D} ( {{H}_{2}^{⋆} [ 2 {c}^{′} = \frac{2 {a}_{o}}{p} ]}^{+} ) ,$$

is the difference between the negative of the binding energy of the corresponding hydrino atom given by Eq. (2) and

$${E}_{T} ( {{H}_{2}^{⋆} [ 2 {c}^{′} = \frac{2 {a}_{o}}{p} ]}^{+} )$$

given by Eq. (26).

$${E}_{D} ( {{H}_{2}^{⋆} [ 2 {c}^{′} = \frac{2 {a}_{o}}{p} ]}^{+} ) = E ( H [ \frac{{a}_{H}}{p} ] ) - {E}_{T} ( {{H}_{2}^{⋆} [ 2 {c}^{′} = \frac{2 {a}_{o}}{p} ]}^{+} ) \qquad ( 27 )$$

The first binding energy, BE₁, of the dihydrino molecule

$${H}_{2}^{⋆} [ 2 {c}^{′} = \frac{\sqrt{2} {a}_{o}}{p} ] \to {{H}_{2}^{⋆} [ 2 {c}^{′} = \frac{2 {a}_{o}}{p} ]}^{+} + {e}^{-} \qquad ( 28 )$$

is given by Eq. (26) minus Eq. (24).

$${BE}_{1} = {E}_{T} ( {{H}_{2}^{⋆} [ 2 {c}^{′} = \frac{2 {a}_{o}}{p} ]}^{+} ) - {E}_{T} ( {H}_{2}^{⋆} [ 2 {c}^{′} = \frac{\sqrt{2} {a}_{o}}{p} ] ) \qquad ( 29 )$$

The second binding energy, BE₂, is given by the negative of Eq. (26). The first binding energy, BE₁, of the dihydrino molecule with consideration of zero order vibration is about

$${BE}_{1} = \frac{15.5}{{( \frac{1}{p} )}^{2}} eV \qquad ( 29 a )$$

The dihydrino and the dihydrino ion are further described in the '96 Mills GUT, and PCT/US96/07949 and PCT/US/94/02219.

A method to prepare dihydrino gas from the hydrino hydride comprises reacting hydrino hydride with a source of protons including acid, protons of a plasma of a gas discharge cell, and protons from a metal hydride. The reaction of hydrino hydride

$${H}^{-} ( \frac{1}{p} )$$

with a proton is

$${H}^{-} ( \frac{1}{p} ) + {H}^{+} \to {H}_{2}^{⋆} [ 2 {c}^{′} = \frac{\sqrt{2} {a}_{o}}{p} ] + energy \qquad ( 30 )$$

One way to make dihydrino gas from hydrino hydride is by thermally decomposing the hydride. For example, potassium hydrino hydride is heated until potassium metal is formed together with dihydrino gas. An example of a thermal decomposition reaction of hydrino hydride

$${M}^{+} {H}^{-} ( \frac{1}{p} )$$

is

$$2 {M}^{+} {H}^{-} ( \frac{1}{p} ) {}^{Δ} {H}_{2}^{⋆} [ 2 {c}^{′} = \frac{\sqrt{2} {a}_{o}}{p} ] + energy + 2 M \qquad ( 31 )$$

where M⁺is the cation.

A hydrino can react with a proton to form a dihydrino ion which further reacts with an electron to form a dihydrino molecule.

$$H [ \frac{{a}_{H}}{p} ] + {H}^{+} \to {{H}_{2}^{⋆} [ 2 {c}^{′} = \frac{2 {a}_{o}}{p} ]}^{+} + e - \to {H}_{2}^{⋆} [ 2 {c}^{′} = \frac{\sqrt{2} {a}_{o}}{p} ] \qquad ( 32 )$$

The energy of the reaction of the hydrino atom with a proton is given by the negative of the bond energy of the dihydrino ion (Eq. (27)). The energy given by the reduction of the dihydrino ion by an electron is the negative of the first binding energy (Eq. (29)). These reactions emit UV radiation. UV spectroscopy is a way to study the emitted radiation.

A reaction to prepare dihydrino gas is given by Eq. (32). Sources of reactant protons comprise 1.) a metal hydride (e.g. a transition metal such as nickel hydride) and 2.) a gas discharge cell. In case 1.), hydrino atoms are formed in an electrolytic cell comprising a catalyst electrolyte and a metal cathode which forms a hydride. Permeation of hydrino atoms through the metal hydride containing protons results in the synthesis of dihydrinos according to Eq. (32). The dihydrino gas may be collected from the inside of an evacuated hollow cathode that is sealed at one end. Hydrinos diffuse through the cathode and react with protons of the hydride of the cathode. The dihydrinos produced according to Eq. (32) diffuse into the cavity of the cathode and are collected. In case 2), hydrinos are formed in a hydrogen gas discharge cell wherein a catalyst is present in the vapor phase. Ionization of hydrogen atoms by the gas discharge cell provides protons to react with the hydrinos in the gas phase to form dihydrino molecules according to Eq. (32). Dihydrino gas may be purified by gas chromatography or by combusting normal hydrogen with a recombiner such as a CuO recombiner.

In another embodiment, dihydrino is prepared from a compound containing hydrino hydride, hydrino atoms, and/or dihydrino molecules by thermally decomposing the compound to release dihydrino gas. Dihydrino is also prepared from a compound containing hydrino hydride ion(s), hydrino atom(s), dihydrino molecular ion(s), and/or dihydrino molecule(s) by chemically decomposing the compound. For example, the compound is chemically decomposed by reacting a cation such as Li⁺ with NiH₆ hydrino hydride to liberate dihydrino gas according to the following methods: 1.) run a 0.57M K₂CO₃ electrolytic cell with nickel electrodes for an extended period of time such as one year; 2.) make the electrolyte about 1 M in LiNO₃ and acidify it with HNO₃; 3.) evaporate the solution to dryness, then heat until the mixture melts, and continue to apply heat until the solution turns black from the decomposition of a hydrino hydride compound such as NiH₆ to NiO, dihydrino gas, and lithium hydrino hydride; 4.) collect the dihydrino gas, and identify dihydrino by methods including gas chromatography, gas phase XPS, and Raman spectroscopy.

### Dihydrino Gas Identification

Dihydrino gas is identified as a higher ionizing mass two in the mass spectrometer. The dihydrino gas peaks occur at retention times different from normal hydrogen during gas chromatography at cryogenic temperatures, after passing through a 100% H₂/O₂ recombiner (e.g. CuO recombiner). In the case of

$${H}_{2}^{⋆} [ 2 {c}^{′} = \frac{\sqrt{2} {a}_{o}}{2} ] ,$$

dihydrino gas is identified as the split m/e=2 peak in the high resolution magnetic sector mass spectrometer, as the 62.2 eV peak in the gas phase XPS, and as the peak with 4 times the vibrational energy of normal molecular hydrogen via Raman spectroscopy. In the case of stimulated Raman spectroscopy, a YAG laser excitation is used to observe Raman Stokes and antiStokes lines due to vibration of dihydrino

$${H}_{2}^{⋆} [ 2 {c}^{′} = \frac{\sqrt{2} {a}_{o}}{2} ] or {D}_{2}^{⋆} [ 2 {c}^{′} = \frac{\sqrt{2} {a}_{o}}{2} ]$$

that is liquefied on the cryopump spectroscopy stage. A further method of identification comprises performing XPS (X-ray Photoelectron Spectroscopy) on dihydrino liquefied on a stage.

### Mass Spectroscopy Methods

Mass spectroscopy is performed with a Dycor System 1000 Quadrapole Mass Spectrometer Model #D200MP with a HOVAC Dri-2 Turbo 60 Vacuum System. The binding energy is calibrated to within ±1 eV.

Mass spectra of gasses from the sample are recorded over time while the ionization energy is varied between 30 eV and 70 eV for the experiment with the catalyst and a control without the catalyst. The pressure of the sample gas in the mass spectrometer is kept the same for each experiment by adjusting the needle value of the mass spectrometer. The entire range of masses through m/e=200 is measured following the determinations at m/e=1 and m/e=2.

### Gas Chromatography Methods

Gas samples are analyzed with a Hewlett Packard 5890 Series II gas chromatograph equipped with a thermal conductivity detector and either a 60 meter, 0.32 mm ID fused silica Rt-Alumina PLOT column alone or this 60 meter column connected to an identical 50 meter PLOT column (Restek, Bellefonte, Pa.) for a total column length of 110 meters. When two columns are used, they were connected with either a Capillary Vu-Union™ or Vacuum Vu-Union™ connector (Restek, Bellefonte, Pa.). Column(s) are conditioned at 200° C. for 18-72 hours before each series of runs. Samples are run at −196° C., using Ne as the carrier gas.

The 60 meter column is run with the carrier gas at 3.4 PSI with the following flow rates: carrier—2.0 ml/min., auxiliary—3.4 ml/min., and reference—3.5 ml/min., for a total flow rate of 8.9 ml/min. The split rate is 10.0 ml/min.

The 110 meter column is run with the carrier gas at 7.0 PSI with the following flow rates: carrier—2.2 ml/min., auxiliary—3.0 ml/min., and reference—3.9 ml/min., for a total flow rate of 9.1 ml/min. The split rate is 10.0 ml/min.

### Additional Increased Binding Energy Hydrogen Compounds

In a further embodiment of the present invention, hydrino hydride ions are reacted or bonded to any positively charged atom of the periodic chart including an alkali or alkaline earth cation, including a proton. Hydrino hydride ions may also react with or bond to any organic molecule, inorganic molecule, compound, metal, nonmetal, or semiconductor to form an organic molecule, inorganic molecule, compound, metal, nonmetal, or semiconductor. Additionally, hydrino hydride ions may react with or bond to H₃⁺, or dihydrino molecular ions

$${{H}_{2}^{⋆} [ 2 {c}^{′} = \frac{\sqrt{2} {a}_{o}}{p} ]}^{+} .$$

Dihydrino molecular ions may bond to hydrino hydride ions such that the binding energy of the dihydrino molecule

$${H}_{2}^{⋆} [ 2 {c}^{′} = \frac{\sqrt{2} {a}_{o}}{p} ]$$

is less than the binding energy of the hydrino hydride

$${H}^{-} ( \frac{1}{p} )$$

of the compound. The reactants which may react with hydrino hydrides include neutral atoms, negatively or positively charged atomic and molecular ions, and free radicals. In one embodiment, hydrino hydride is XD reacted with a metal. Thus, in one embodiment of the electrolytic cell Go hydride reactor, hydrino hydride produced during operation at the cathode is incorporated into the cathode by reacting with it. A metal-hydrino hydride material is produced. Exemplary types of compounds of the present invention include those that follow. Each compound of the invention includes at least one hydrogen species H which is hydrino hydride ion or a hydrino atom; or in the case of compounds containing two or more hydrogen species H, at least one such H is a hydrino hydride ion or a hydrino atom, and/or two or more hydrogen species of the compound are present in the compound in the form of dihydrino molecular ion (two hydrogens) and/or dihydrino molecule (two hydrogens). The compound may further comprise an ordinary hydrogen atom, or an ordinary hydrogen molecule, in addition to one or more of the increased binding energy species. In general, such ordinary hydrogen atom(s) and ordinary hydrogen molecule(s) of the following exemplary compounds are herein called “hydrogen”:

H⁻(1/p)H₃⁺; MH, MH₂, and M₂H₂ where M is an alkali cation (in the case of M₂H₂, the alkali cations may be different) and H is a hydrino hydride ion or hydrino atom; MHₙ=1 to 2 where M is an alkaline earth cation and H is a hydrino hydride ion or hydrino atom; MHX where M is an alkali cation, X is a neutral atom or molecule or a single negatively charged anion such as halogen ion, hydroxide ion, hydrogen carbonate ion, or nitrate ion, and H is a hydrino hydride ion or hydrino atom; MHX where M is an alkaline earth cation, X is a single negatively charged anion such as halogen ion, hydroxide ion, hydrogen carbonate ion, or nitrate ion, and H is a hydrino hydride ion or hydrino atom; MHX where M is an alkaline earth cation, X is a doubly negatively charged anion such as carbonate ion or sulfate ion, and H is a hydrino atom; M₂HX where M is an alkali cation (the alkali cations may be different), X is a single negatively charged anion such as halogen ion, hydroxide ion, hydrogen carbonate ion, or nitrate ion, and H is a hydrino hydride ion or hydrino atom; MHₙ n 1 to 5 where M is an alkaline cation and H is at least one of a hydrino hydride ion, hydrino atom, dihydrino molecular ion, dihydrino molecule, and may further comprise an ordinary hydrogen atom, or ordinary hydrogen molecule; M₂Hₙ n=1 to 4 where M is an alkaline earth cation and H is at least one of a hydrino hydride ion, hydrino atom, dihydrino molecular ion, dihydrino molecule, and may further comprise an ordinary hydrogen atom, or ordinary hydrogen molecule (the alkaline earth cations may be different); M₂XHₙ n=1 to 3 where M is an alkaline earth cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom, or ordinary hydrogen molecule (the alkaline earth cations may be different); M₂X₂Hₙ n=1 to 2 where M is an alkaline earth cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom (the alkaline earth cations may be different); M₂X₃H where M is an alkaline earth cation, X is a single negatively charged anion such as halogen ion, hydroxide ion, hydrogen carbonate ion, or nitrate ion, and H is a hydrino hydride ion, or hydrino atom (the alkaline earth cations may be different); M₂XHₙ n=1 to 2 where M is an alkaline earth cation, X is a doubly negatively charged anion such as carbonate ion or sulfate ion, and H is at least one of a hydrino hydride ion, hydrino atom, dihydrino molecular ion, dihydrino molecule, and may further comprise an ordinary hydrogen atom (the alkaline earth cations may be different); M₂XX′ H where M is an alkaline earth cation, X is a single negatively charged anion such as halogen ion, hydroxide ion, hydrogen carbonate ion, or nitrate ion, X′ is a doubly negatively charged anion such as carbonate ion or sulfate ion, and H is a hydrino hydride ion or hydrino atom (the alkaline earth cations may be different); MM′ Hₙ n=1 to 3 where M is an alkaline earth cation, M′ is an alkali metal cation, and H is at least one of a hydrino hydride ion, hydrino atom, dihydrino molecular ion, dihydrino molecule, and may further comprise an ordinary hydrogen atom, or ordinary hydrogen molecule; MM′ XHₙ n=1 to 2 where M is an alkaline earth cation, M′ is an alkali metal cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom; MM′ XH where M is an alkaline earth cation, M′ is an alkali metal cation, X is a doubly negatively charged anion such as carbonate ion or sulfate ion, and H is a hydrino hydride ion or hydrino atom; MM′ XX′ H where M is an alkaline earth cation, M, is an alkali metal cation, X and X are each a single negatively charged anion such as halogen ion, hydroxide ion, hydrogen carbonate ion, or nitrate ion, and H is a hydrino hydride ion or hydrino atom; HₙS n=1 to 2 where H is at least one of a hydrino hydride ion, hydrino atom, dihydrino molecular ion, dihydrino molecule, and may further comprise an ordinary hydrogen atom; MSiHₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MXSiHₙ n=1 to 5 where M is an alkali or alkaline earth cation, Si may be replaced by Al, Ni, transition, inner transition, or rare earth element, X is a single negatively charged anion such as halogen ion, hydroxide ion, hydrogen carbonate ion, or nitrate ion, or a doubly negative charged anion such as carbonate ion or sulfate ion, and H is at least one of a hydrino hydride ion, hydrino atom, dihydrino molecular ion, dihydrino molecule, and may further comprise an ordinary hydrogen atom, or ordinary hydrogen molecule; MAlHₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MHₙ n=1 to 6 where M is a transition, inner transition, or rare earth element cation such as nickel and H is at least one of a hydrino hydride ion, hydrino atom, dihydrino molecular ion, dihydrino molecule, and may further comprise an ordinary hydrogen atom, or ordinary hydrogen molecule; MNiHₙ n=1 to 6 where M is an alkali cation, alkaline earth cation, silicon, or aluminum and H is at least one of a hydrino hydride ion, hydrino atom, dihydrino molecular ion, dihydrino molecule, and may further comprise an ordinary hydrogen atom, or ordinary hydrogen molecule, and nickel may be substituted by another transition metal, inner transition, or rare earth cation; M₂SiHₙ n=1 to 8 where M is an alkali or alkaline earth cation (the cations may be different) and H is at least one of a hydrino hydride ion, hydrino atom, dihydrino molecular ion, dihydrino molecule, and may further comprise an ordinary hydrogen atom, or ordinary hydrogen molecule; SiHₙ n=11 to 8 where H is at least one of a hydrino hydride ion, hydrino atom, dihydrino molecular ion, dihydrino molecule, and may further comprise an ordinary hydrogen atom, or ordinary hydrogen molecule; SiHₙ n=1 to 8 where H is at least one of a hydrino hydride ion, hydrino atom, dihydrino molecular ion, dihydrino molecule, and may further comprise an ordinary hydrogen atom, or ordinary hydrogen molecule; TiHₙ n=11 to 4 where H is at least one of a hydrino hydride ion, hydrino atom, dihydrino molecular ion, dihydrino molecule, and may further comprise an ordinary hydrogen atom, or ordinary hydrogen molecule; Al₂Hₙ n=1 to 4 where H is at least one of a hydrino hydride ion, hydrino atom, dihydrino molecular ion, dihydrino molecule, and may further comprise an ordinary hydrogen atom, or ordinary hydrogen molecule; MXAlX′ Hₙ n=1 to 2 where M is an alkali or alkaline earth cation, X and X′ are each a single negatively charged anion such as halogen ion, hydroxide ion, hydrogen carbonate ion, or nitrate ion, or a doubly negative charged anion such as carbonate ion or sulfate ion, H is at least one of a hydrino hydride ion, hydrino atom, dihydrino molecular ion, dihydrino molecule, and may further comprise an ordinary hydrogen atom, and another cation such as Si may replace Al; SiO₂Hₙ n=1 to 6 where H is at least one of a hydrino hydride ion, hydrino atom, dihydrino molecular ion, dihydrino molecule, and may further comprise an ordinary hydrogen atom, or ordinary hydrogen molecule; MSiO₂Hₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MSi₂Hₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; and M₂SiHₙ n=1 to 8 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen w molecule.

In a further embodiment of the present invention, hydrino hydride and/or atom is reacted or bonded to a source of electrons including any positively charged atom of the periodic chart such as an alkali, alkaline m earth, transition metal, inner transition metal, rare earth, lanthanide, or actinide cation to form a structure described by a lattice described in '96 Mills GUT (pages 255-264 which are incorporated by reference) to produce a superconductor of reduced dimensionality.

### Hydrino Hydride Getter

Each reactor of the present invention comprises: a source of atomic hydrogen; at least one of a solid, molten, liquid, or gaseous catalyst; a catalysis vessel including the hydrogen and the catalyst, and a source of electrons. The reactor may further comprise a getter, which functions as a scavenger to prevent hydrino atoms from reacting with components of the cell to form hydrino hydride. The getter may also be used to reverse the reaction between the hydrinos and the components to form a substitute cation of the hydrino hydride ion. Such getter may comprise a metal with a low work function such as an alkali or alkaline earth metal, a source of electrons and cations including protons such as the plasma of the discharge cell or plasma torch cell, the protons and electrons of a metal hydride such as a transition or rare element hydride, or an acid. In another embodiment, the cell components comprise a metal which is regenerated at high temperature, by electrolysis, or plasma etching or has a high work function and is resistant to reaction with hydrino to form hydrino hydride. In a further embodiment, the cell is comprised of a material which reacts with hydrino hydride to form a composition of matter which is acceptable or superior to the parent material as a component of the cell (e.g. more resilient with a longer functional life-time).

Metal compounds comprising hydrino hydride ion(s), hydrino atom(s), dihydrino molecular ion(s), and/or dihydrino molecule(s) as well as normal hydrogen atoms and molecules such as NiH₆ and WH₆ form during the operation of the hydrino hydride reactor as shown in the Experimental Section. In one embodiment, the getter comprises a metal such as nickel or tungsten which forms said compounds that decompose to restore the metal surface of the desired component of the hydrino hydride reactor such as the cell wall or hydrogen dissociator. In one embodiment, the cell of the hydrino hydride reactor is metal or the quartz or ceramic cell is metallized by methods including vacuum deposition, and the cell is the getter.

In another embodiment, wherein the hydrino hydride has a lower vapor pressure than the catalyst, the cell comprises a cryotrap for the hydrino hydride which is maintained at a temperature intermediate between the cell temperature and the temperature of the catalyst reservoir, such that hydrino hydride condenses in the trap with little or no condensation of the catalyst in the hydrino hydride cryotrap. An exemplary hydrino hydride cryotrap 255 of the gas cell hydride reactor is shown in FIG. 3.

In another embodiment, wherein the hydrino hydride has a higher vapor pressure than the catalyst, the cell comprises a heated catalyst reservoir which provides vaporized catalyst to the cell. Periodically, the catalyst reservoir is maintained at a temperature which causes the catalyst to condense with little or no condensation of the hydrino hydride. The hydrino hydride is maintained in the gas phase at the elevated temperature of the cell and is removed by a pump including a vacuum pump or a cryopump. An exemplary pump 256 of the gas cell hydride reactor is shown in FIG. 3.

The hydrino hydride ion can bond to a cation with unpaired electrons, such as a transition or rare earth cation, to form a paramagnetic or ferromagnetic compound. In one embodiment, the hydrino hydride getter 255 of the gas cell hydride reactor comprises a magnet whereby magnetic hydrino hydride is removed from the gas phase by attaching to the magnetic getter.

Hydrino hydride ions can be ionized by hydrino atoms of lower energy level than the product ionized hydrino. The ionized hydrino hydride can further undergo disproportionation to release further energy. Over time, the hydrino hydride products tend towards the most stable hydrino hydride, H⁻(n= 1/16). Thus, by removing or adding hydrino hydride, the power and energy produced by the cell may be controlled. In an embodiment, the getter is a regulator of the vapor pressure of hydrino hydride to control the power or energy produced by the cell. The hydrino hydride vapor pressure regulator includes a pump wherein the vapor pressure is determined by the rate of pumping. The W hydrino hydride vapor pressure regulator also may include a cryotrap wherein the temperature of the cryotrap determines the vapor pressure of the hydrino hydride. A further embodiment of the hydrino hydride vapor pressure regulator comprises a flow restriction to a cryotrap of constant temperature wherein the flow rate to the trap determines the steady state hydrino hydride vapor pressure. Exemplary flow restrictions include adjustable quartz, zirconium, or tungsten plugs.

### Hydrino Hydride Battery

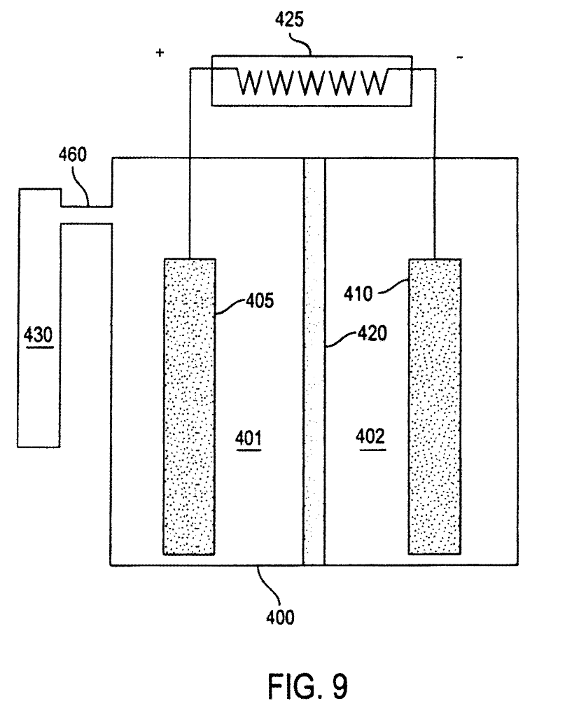

One application of the reaction to form hydrino hydrides given by Eq. (8) is as a cathode (reduction) half reaction of an electrochemical cell, a battery or a fuel cell. The electrochemical cell shown in FIG. 9 comprises a vessel 400, a cathode 405, an anode 410, a salt bridge 420, and an electrical load 425. The vessel 400 further comprises two separate compartments 401 and 402. The compartment 401 contains the cathode 405 and the oxidant (i.e. gains the electron), hydrino atoms, and the compartment 402 contains the anode 410 and the reductant (i.e. loses the electron). The salt bridge 420 connects the two compartments. Hydrino atoms are supplied to the cathode 405 from a hydrino source 430 including the compounds disclosed herein that comprise hydrino hydride ion(s), hydrino atom(s), dihydrino molecular ion(s), and/or dihydrino molecule(s) that release hydrino when thermally decomposed by heating or chemically decomposed by the reaction of the compound with an element that replaces hydrino atom(s), hydrino hydride ion(s), dihydrino molecular ion(s), and/or dihydrino molecule(s).

In one such embodiment, the compounds are oxidants. In another embodiment, a hydrino source 430 includes at least one of an electrolytic cell, a gas cell, a gas discharge cell, or a plasma torch cell wherein hydrinos are supplied via a hydrino passage 460. Each cell comprises: a source of atomic hydrogen; at least one of a solid, molten, liquid, or gaseous catalyst; a catalysis vessel for contacting the hydrogen and the catalyst, and a source of electrons.

The hydrinos,

$$H [ \frac{{a}_{H}}{p} ] ,$$

react with electrons at the cathode 405 of the battery to form hydrino hydrides, H⁻(n=1/p). A reductant reacts with the anode 410 to supply electrons to flow through the load 425 to the cathode 405, and a suitable cation completes the circuit by migrating from the anode compartment 402 to the cathode compartment 401 through the salt bridge 420. The reductant may be any electrochemical reductant, such as zinc. In one embodiment, the reductant has a high oxidation potential and the cathode may be copper.
The cathode half reaction is:

$$H [ \frac{{a}_{H}}{p} ] + {e}^{-} \to {H}^{-} ( n = 1 / p ) \qquad ( 33 )$$

The anode half reaction is:

reductant→reductant⁺+e⁻ (34)

The overall cell reaction is:

$$H [ \frac{{a}_{H}}{p} ] + reductant \to {reductant}^{+} + {H}^{-} ( n = 1 / p ) \qquad ( 35 )$$

In one embodiment, the cathode is the cathode half reaction compartment 401. The source of hydrino is an electrolytic cell, gas cell, gas discharge cell, or plasma torch cell hydrino hydride reactor wherein, the cell vessel comprises the cathode which is the cathode half reaction compartment 401. In another embodiment, hydrino atoms are supplied to the cathode comprising the cathode half reaction compartment 401 from a hydrino source 430 including the compounds disclosed herein that comprise hydrino hydride ion(s), hydrino atom(s), dihydrino molecular ion(s), and/or dihydrino molecule(s) that release hydrino when thermally decomposed by heating or chemically decomposed by the reaction of the compound with an element that replaces hydrino atom(s), hydrino hydride ion(s), dihydrino molecular ion(s), and/or dihydrino molecule(s). In another embodiment, a hydrino source 430 includes at least one of an electrolytic cell, a gas cell, a gas discharge cell, or a plasma torch cell wherein hydrinos are supplied via a hydrino passage 460 to the cathode half reaction compartment 401 which is the cathode. In an embodiment, the cathode is a getter for the hydrino including the case wherein the cathode is the cathode half reaction compartment 401.

### Hydrino Hydride Explosive and Rocket Fuel

Eq. (1) predicts that a stable hydrino hydride will form for the parameter p≦24. The energy released from the reduction of hydrino atoms to form a hydrino hydride ion goes through a maximum; whereas, the magnitude of the total energy of the dihydrino molecule (Eq. (24)) continuously increases as a function of p. Thus, as p approaches 24 the reaction of H⁻(n=1/p) to form

$${H}_{2}^{⋆} [ 2 {c}^{′} = \frac{\sqrt{2} {a}_{0}}{p} ]$$

by the reaction with a proton or the reaction of 2H⁻(n=1/p) to form

$${H}_{2}^{⋆} [ 2 {c}^{′} = \frac{\sqrt{2} {a}_{0}}{p} ]$$

by thermal decomposition (Eq. (31)) has a low activation energy and releases a thousand times the energy of a typical chemical reaction. For example, the reaction of the hydrino hydride H⁻(n= 1/24) (having a binding energy of about 0.6535 eV) with a proton to form dihydrino molecule

$${H}_{2}^{⋆} [ 2 {c}^{′} = \frac{\sqrt{2} {a}_{0}}{24} ]$$

(having the first binding energy of about 8,928 eV) and energy is

$${H}^{-} ( n = 1 / 24 ) + {H}^{+} \to {H}_{2}^{⋆} [ 2 {c}^{′} = \frac{\sqrt{2} {a}_{0}}{24} ] + 2500 eV \qquad ( 36 )$$

where the energy of the reaction is the sum of Eqs. (1) and (24) (which is the total energy of the product dihydrino minus the total energy of the reactant hydrino hydride).

As a further example, the thermal decomposition reaction of H⁻(n= 1/24) to form dihydrino molecule

$${H}_{2}^{⋆} [ 2 {c}^{′} = \frac{\sqrt{2} {a}_{0}}{24} ]$$

is

$$2 {M}^{+} {H}^{-} ( n = 1 / 24 ) {}^{Δ} {H}_{2}^{⋆} [ 2 {c}^{′} = \frac{\sqrt{2} {a}_{0}}{24} ] + 2500 eV + 2 M \qquad ( 37 )$$

where M⁺ is the cation of the hydrino hydride ion, M is the reduced cation, and the energy of the reaction is essentially the sum of two times Eqs. (1) and (24) (which is the total energy of the product dihydrino minus the total energy of the two reactant hydrino hydride ions).

One application of the hydrino hydride comprises an explosive involving the reaction of hydrino hydride with a proton to form dihydrino (Eq. (36)) or the thermal decomposition of hydrino hydride, or compounds of the present invention comprising hydrino or hydrino hydride to form dihydrino (e.g. Eq. (37)), releasing an explosive power. In the former case, a source of protons includes an acid (HF, HCl, H₂SO₄, or HNO₃) or a super-acid (HF+SbF₅; HCl+Al₂Cl₆; H₂SO₃F+SbF₅; or H₂SO₄+SO₂(g)), wherein the explosion is initiated by rapid mixing of the hydrino hydride or hydrino hydride containing compound with the acid or the super-acid. The W mixing includes detonation of a conventional explosive. In the case the explosive reaction comprises a rapid thermal decomposition of hydrino hydride or compounds comprising hydrino hydride, hydrino, or dihydrino, the thermal decomposition may be caused by the detonation of a conventional explosive or by percussion heating. An embodiment of the latter case, is a hydrino hydride tipped bullet that detonates on, impact via percussion heating.

Another application of the claimed hydrino hydride, and compounds comprising hydrino, hydrino hydride and/or dihydrino, is as a solid, liquid, or gaseous rocket fuel comprising the reaction of hydrino hydride with a proton to form dihydrino (Eq. (36)) or the thermal decomposition of hydrino hydride or compounds comprising hydrino, hydrino hydride and/or dihydrino to form dihydrino (e.g. Eq. (37)) with the release of rocket propellant power. In the former case, a source of protons initiates a rocket propellant reaction by its effective mixing with the hydrino hydride. A means of mixing includes initiation of a conventional rocket fuel reaction. In the latter case (the rocket fuel reaction comprises a rapid thermal decomposition of hydrino hydride and/or compounds comprising hydrino, hydrino hydride and/or dihydrino), the thermal decomposition may be caused by the initiation of a conventional rocket fuel reaction or by percussion heating. In one embodiment, the cation of the hydrino hydride is the lithium ion (Li⁺) due to its low mass.

One method to isolate and purify hydrino hydride of a specific p of Eq. (1) is by exploiting the different electron affinities of various hydrino atoms. In a first step, hydrino atoms are reacted with a composition of matter such as a metal other than an alkali or alkaline earth metal which reduces all hydrino atoms that form stable hydrides except that it does not react with

$$H [ \frac{{a}_{H}}{p} ]$$

to form H⁻(n=1/p) for a given p, where p is an integer, because the work function of the composition of matter is too high or the free energy of the reaction is positive. In a second step, the nonreactive hydrino hydride atoms are collected and reacted with a source of electrons including a plasma or an alkali or alkaline earth metal to form H⁻(n=1/p) including H⁻(n= 1/24) wherein hydrino atoms of a higher integer p of Eq. (2) are nonreactive because they do not form stable hydrino hydrides. For example, an atomic beam of hydrinos is passed into a vessel comprising tungsten in the first stage, and is allowed to make p≦23 hydrino hydrides, and the non-reactive hydrinos having p greater than 23 are allowed to pass through to the second stage. In the second stage, only for p=24, a stable alkali or alkaline earth hydride is formed. The hydrino hydride H⁻(n=1/p) including H⁻(n= 1/24) is collected as a compound by the methods described herein for the

### Hydrino Hydride Reactor

Another method to isolate and purify hydrino hydride of a specific p of Eq. (1) is by ion cyclotron resonance spectroscopic methods. In one embodiment, the hydrino hydride ion of the desired p of Eq. (1) is captured in an ion cyclotron resonance instrument and its cyclotron frequency is excited to eject the ion such that it is collected.

### Additional Catalysts

One embodiment of the present invention to form increased binding energy hydrogen compounds, including hydride ions or multi-electron atoms and ions comprises one of a solid, molten, liquid, and gaseous catalyst; a vessel containing the reactant hydride ion, or multi-electron atom or ion, and the catalyst wherein the catalysis occurs by contact of the reactant with the catalyst.

Hydrino hydride H⁻(1/p) of a desired p can be synthesized by reduction of the corresponding hydrino according to Eq. (8). Alternatively, a hydrino hydride can be catalyzed to undergo a transition to a lower-energy state to yield the desired hydrino hydride. Such a catalyst has a net enthalpy equivalent to about the difference in binding energies of the product and the reactant hydrino hydride ions each given by Eq. (1). For example, the catalyst for the reaction

$${H}^{-} ( \frac{1}{p} ) \to {H}^{-} ( \frac{1}{p + m} ) \qquad ( 38 )$$

where p and m are integers has an enthalpy of about

$$Binding Energy of {H}^{-} ( \frac{1}{p + m} ) - Binding Energy of {H}^{-} ( \frac{1}{p} ) \qquad ( 39 )$$

where each binding energy is given by Eq. (1). Another catalyst has a net enthalpy equivalent to the magnitude of the initial increase in potential energy of the reactant hydrino hydride corresponding to an increase of its central field by an integer m. For example, the catalyst for the reaction

$${H}^{-} ( \frac{1}{p} ) \to {H}^{-} ( \frac{1}{p + m} ) \qquad ( 40 )$$

where p and m are integers has an enthalpy of about

$$\frac{2 ( p + m ) {e}^{2}}{4 {πɛ}_{0} r} \qquad ( 41 )$$

where π is pi, e is the elementary charge, ε₀ the permittivity of vacuum, and r is the radius of H⁻(1/p) given by Eq. (21).

A catalyst for the transition of any atom, ion, molecule, or molecular ion to a lower-energy state has a net enthalpy equivalent to the magnitude of the initial increase in potential energy of the reactant corresponding to an increase of its central field by an integer m. For example, the catalyst for the reaction of any two electron atom with Z≧2 to a lower-energy state having a final central field which is increased by m given by

Two Electron Atom(Z)→Two Electron Atom(Z+m) (42)

where Z is the number of protons of the atom and m is an integer has an enthalpy of about

$$\frac{2 ( Z - 1 + m ) {e}^{2}}{4 {πɛ}_{0} r} \qquad ( 43 )$$

where r is the radius of the two electron atom given by Eq. (7.19) of '96 Mills GUT. The radius is

$$r = {a}_{0} ( \frac{1}{Z - 1} - \frac{\sqrt{3 / 4}}{Z ( Z - 1 )} ) \qquad ( 44 )$$

where aₒ is the Bohr radius. A catalyst for the reaction of lithium to a lower-energy state having a final central field which is increased by m has an enthalpy of about

$$\frac{( Z - 2 + m ) {e}^{2}}{4 π {ɛ}_{0} {r}_{3}} \qquad ( 45 )$$

where r₃ is the radius of the third electron of lithium given by Eq. (10.13) of '96 Mills GUT. The radius is

$${r}_{3} = \frac{{a}_{o}}{[ 1 - \frac{\sqrt{3 / 4}}{4 ( \frac{1}{2} - \frac{\sqrt{3 / 4}}{6} )} ]} \\ {r}_{3} = 2.5559 {a}_{o} . \qquad ( 46 )$$

A catalyst for the reaction of any three electron atom having Z>3 to a lower-energy state having a final central field which is increased by m has an enthalpy of about

$$\frac{( Z - 2 + m ) {e}^{2}}{4 π {ɛ}_{0} {r}_{3}} \qquad ( 47 )$$

where r₃ is the radius of the third electron of the three electron atom given by Eq. (10.37) of '96 Mills GUT. The radius is

$${r}_{3} = \frac{{a}_{o} [ 1 + [ \frac{Z - 3}{Z - 2} ] \frac{{r}_{1}}{{r}_{3}} 10 \sqrt{\frac{3}{4}} ]}{[ ( Z - 2 ) - \frac{\sqrt{\frac{3}{4}}}{4 {r}_{1}} ]} , {r}_{1} in units of {a}_{o} \qquad ( 48 )$$

where r₁ the radius of electron one and electron two given by Eq. (44).

### EXPERIMENTAL

### Identification of Hydrinos, Dihydrinos, and Hydrino Hydrides by XPS (X-ray Photoelectron Spectroscopy)

XPS is capable of measuring the binding energy, E_{b}, of each electron of an atom. A photon source with energy Eₕᵥ is used to ionize electrons from the sample. The ionized electrons are emitted with energy E_{kinetic}:

E_{kinetic}=Eₕᵥ−E_{b}−Eᵣ

where Eᵣ is a negligible recoil energy. The kinetic energies of the emitted electrons are measured by measuring the magnetic field strengths necessary to have them hit a detector. E_{kinetic} and Eₕᵥ are experimentally known and are used to calculate E_{b}, the binding energy of each atom. Thus, XPS incontrovertibly identifies an atom.

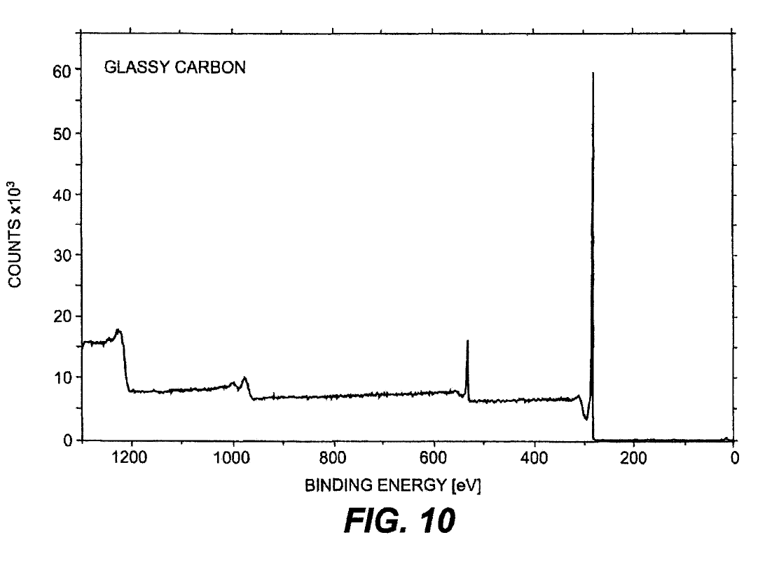

Compounds comprising hydrino hydride ion(s), hydrino atom(s), dihydrino molecular ion(s), and/or dihydrino molecule(s) as well as normal hydrogen atoms and molecules are given in the Additional Compositions Involving Hydrino Hydrides Section. The binding energy of various hydrino hydride and hydrino states may be obtained according to Eq. (1) and Eq. (2), respectively. XPS was used to confirm the production of the n=½ to n= 1/16 hydrino hydrides, E_{b}=3 eV to 73 eV, the n=½ to n=¼ hydrinos, E_{b}=54.4 eV to 217.6 eV, and the n=½ to n=¼ dihydrino molecules, E_{b}=62.3 to 248 eV. In the case of hydrino atoms and dihydrino molecules, this range is the lowest magnitude in energy. The peaks in this range are predicted to be the most abundant. In the case of hydrino hydride, n= 1/16 is the most stable hydrino hydride. Thus, XPS of the energy range E_{b}=3 eV to 73 eV detects these states. XPS was performed on a surface without background interference to these peaks by the cathode. Carbon has essentially zero background from 0 eV to 287 eV as shown in FIG. 10. Thus, in the case of a carbon cathode, there was no interference in the n=½ to n= 1/16 hydrino hydride, the n=½ to n=¼ hydrino, and the n=½ to n=¼ dihydrino peaks.

The hydrino hydride binding energies according to Eq. (1) are given in TABLE 1, hydrino binding energies according to Eq. (2) appear in TABLE 2, and dihydrino molecular binding energies according to Eq. (29a) are given in TABLE 3.

TABLE 2
The representative binding energy of the hydrino atom
as a function of n, Eq. (2).

| n | E_{b} (eV) |
|---|---|
| 1 | 13.6 |
| $\frac{1}{2}$ | 54.4 |
| $\frac{1}{3}$ | 122.4 |
| $\frac{1}{4}$ | 217.6 |

TABLE 3
The representative binding energy of the dihydrino molecule
as a function of n, Eq. (29a).

| n | E_{b} (eV) |
|---|---|
| 1 | 15.46 |
| $\frac{1}{2}$ | 62.3 |
| $\frac{1}{3}$ | 139.5 |
| $\frac{1}{4}$ | 248 |

### A. Experimental Method of Hydrino Atom and Dihydrino Molecule XPS

A series of XPS analyses were made on a carbon cathode used in electrolysis of aqueous potassium carbonate by the Zettlemoyer Center for Surface Studies, Sinclair Laboratory, Lehigh University to identify hydrino and dihydrino binding energy peaks wherein the sample was thoroughly washed to remove water soluble hydrino hydride compounds. A high quality spectrum was obtained over a binding energy range of 300 to 0 eV. This energy region completely covers the C 2p region as well as the region around 55 eV which is the approximate location of the H(n=½) binding energy, 54.4 eV, the region around 123 eV which is the approximate location of the H(n=⅓) binding energy, 122.4 eV, the region around 218 eV which is the approximate location of the H(n=¼) binding energy, 217.6 eV, the region around 63 eV which is the approximate location of the dihydrino molecule

$${H}_{2}^{*} [ n = \frac{1}{2} ; 2 {c}^{′} = \frac{\sqrt{2} {a}_{0}}{2} ]$$

binding energy, 62.3 eV, the region around 140 eV which is the approximate location of the dihydrino molecule

$${H}_{2}^{*} [ n = \frac{1}{3} ; 2 {c}^{′} = \frac{\sqrt{2} {a}_{0}}{3} ]$$

binding energy, 139.5 eV, and the region around 250 eV which is the approximate location of the dihydrino molecule

$${H}_{2}^{*} [ n = \frac{1}{4} ; 2 {c}^{′} = \frac{\sqrt{2} {a}_{0}}{4} ]$$

binding energy, 248 eV.

Sample #1. The cathode and anode each comprised a 5 cm by 2 mm diameter high purity glassy carbon rod. The electrolyte comprised 0.57 M K₂CO₃ (Puratronic 99.999%). The electrolysis was performed at 2.75 volts for three weeks. The cathode was removed from the cell, thoroughly rinsed immediately with distilled water, and dried with a N₂ stream. A piece of suitable size was cut from the electrode, mounted on a sample stub, and placed in the vacuum system.

### B. Results and Discussion

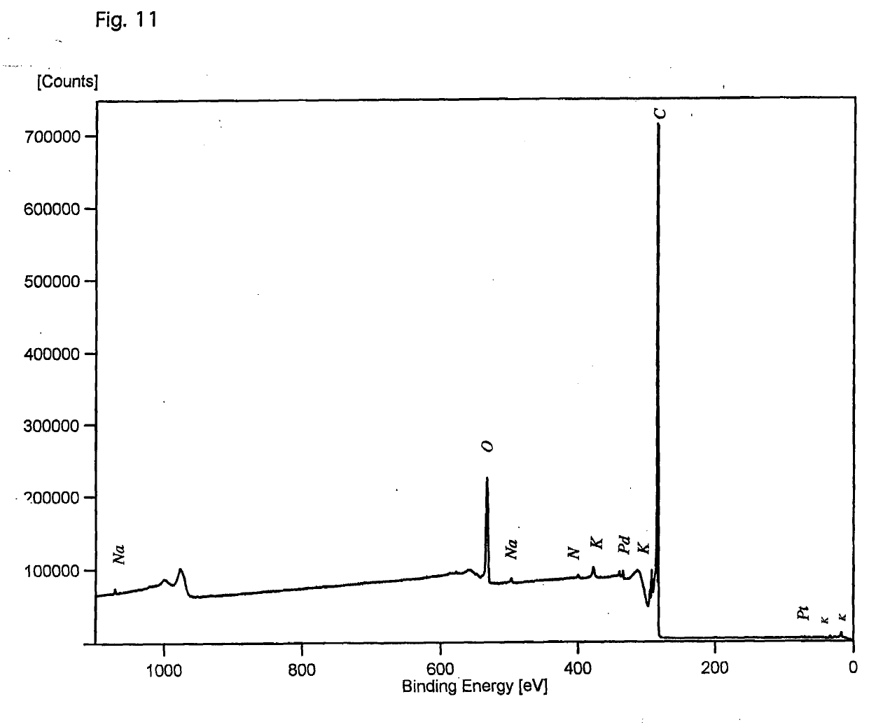

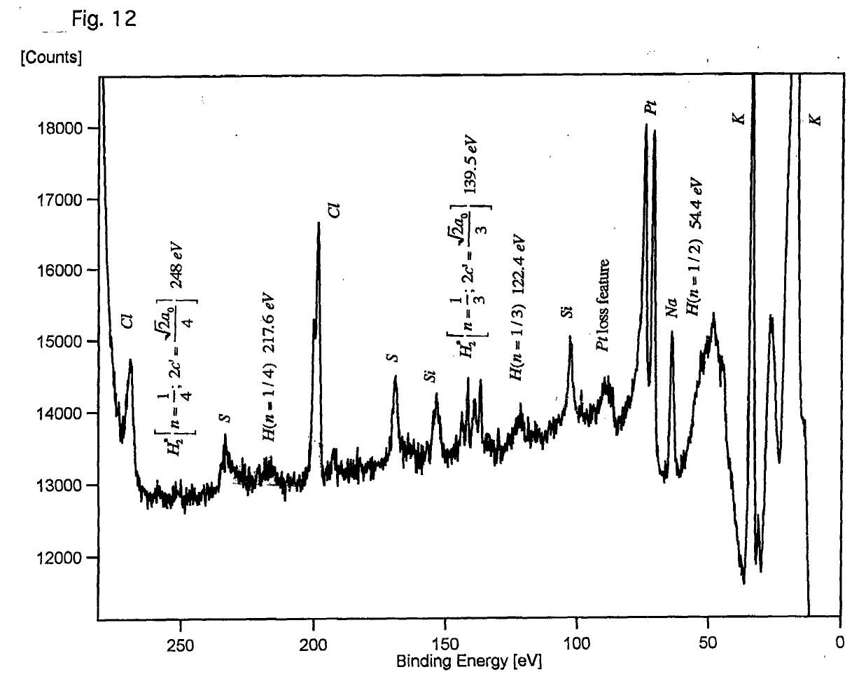

The 0 to 1200 eV binding energy region of an X-ray Photoelectron Spectrum (XPS) of a control glassy carbon rod is shown in FIG. 10. A survey spectrum of sample #1 is shown in FIG. 11. The primary elements are identified on the figure. Most of the unidentified peaks are secondary peaks or loss features associated with the primary elements. FIG. 12 shows the low binding energy range (0-285 eV) for sample #1. Shown in FIG. 12 is the hydrino atom H(n=½) peak at a binding energy of 54 eV, the hydrino atom H(n=⅓) at a binding energy of 122.5 eV, and the hydrino atom H(n=¼) at a binding energy of 218 eV. These broad labeled peaks are the ones of most interest because they fall near the predicted binding energy for the hydrino (n=½), 54.4 eV, (n=⅓), 122.4 eV, and (n=¼), 217.6 eV, respectively. Although the agreement is remarkable, it was necessary to eliminate all other possible known explanations before assigning the 54 eV, 122.5 eV, and 218 eV features to the hydrino, H(n=½), H(n=⅓), and H(n=¼), respectively. As shown below, each of these possible known explanations are eliminated.

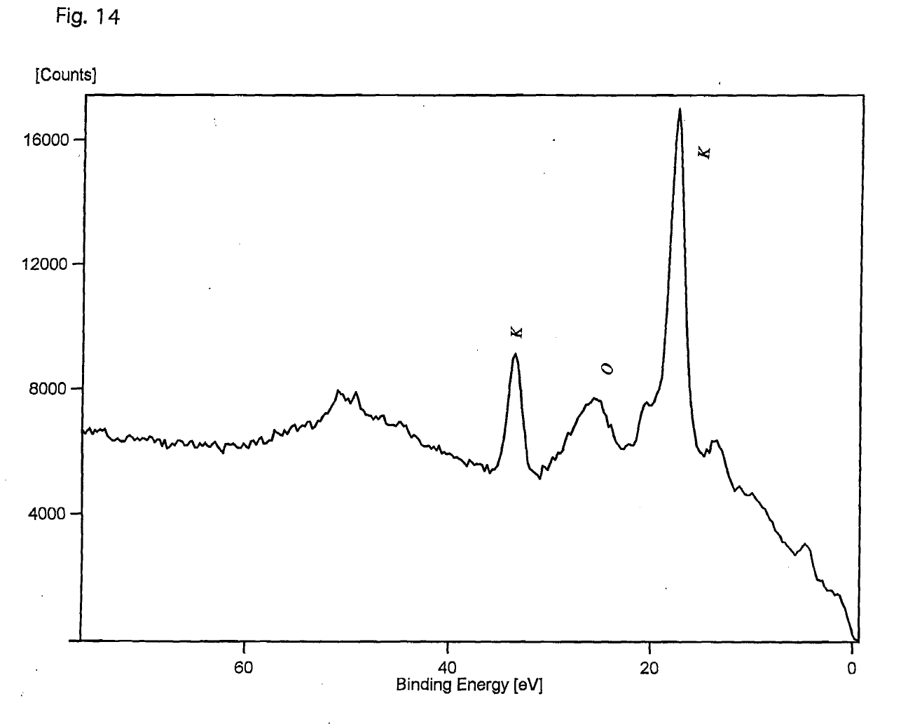

Elements that potentially could give rise to a peak near 54 eV can be divided into three categories: 1.) fine structure or loss features associated with one of the major surface components—carbon (C) and potassium (K); 2.) elements that have their primary peaks in the vicinity of 54 eV—lithium (Li); 3.) elements that have their secondary peaks in the vicinity of 54 eV—iron (Fe). The first case with carbon is eliminated due to the absence of such fine structure or loss features associated with carbon as shown in the XPS spectrum of pure carbon, FIG. 10. The first case with potassium is eliminated because the shape of the 54 eV feature is distinctly different from the recoil feature as shown in FIG. 14. Lithium (Li) and iron (Fe) are eliminated due to the absence of the other peaks of these elements some of which would appear with much greater intensity than the peak of about 54 eV (e.g. the 710 and 723 eV peaks of Fe are missing from the survey scan and the oxygen peak at 23 eV is too small to be due to LiO). The XPS results are consistent with the assignment of the broad peak at 54 eV to the hydrino, H(n=½).

Elements that potentially could give rise to a peak near 122.4 eV can be divided into two categories: fine structure or loss features associated with one of the major surface components—carbon (C); elements that have their secondary peaks in the vicinity of 122.4 eV—copper (Cu) and iodine (I). The first case with carbon is eliminated due to the absence of such fine structure or loss features associated with carbon as shown in the XPS spectrum of pure carbon, FIG. 10. The second two cases are eliminated due to the absence of the other peaks of these elements some of which would appear with much greater intensity than the peak of about 122.4 eV (e.g. the 620 and 631 eV peaks of I are missing and the 931 and 951 eV peaks of Cu are missing). The XPS results are consistent with the assignment of the broad peak at 122.5 eV to the hydrino, H(n=⅓).

Elements that potentially could give rise to a peak near 217.6 eV can be divided into two categories: fine structure or loss features associated with one of the major surface components—carbon (C); fine structure or loss features associated with one of the major surface contaminants—chlorine (Cl). The first case with carbon is eliminated due to the absence of such fine structure or loss features associated with carbon as shown in the XPS spectrum of pure carbon, FIG. 10. The second case is unlikely because its binding energies in this region are 199 eV and 201 eV which does not match the peak at 217.6 eV, and the flat baseline is inconsistent the assignment of a chlorine recoil peak. The XPS results are consistent with the assignment of the broad peak at 218 to H(n=¼).

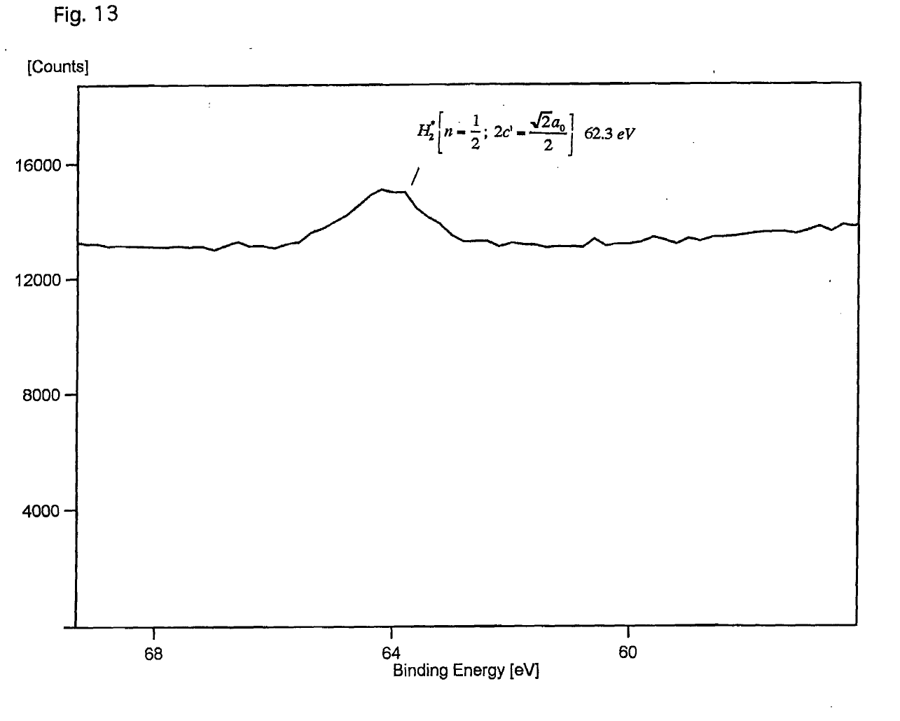

Shown in FIG. 13 is the dihydrino molecule

$${H}_{2}^{*} [ n = \frac{1}{2} ; 2 {c}^{′} = \frac{\sqrt{2} {a}_{0}}{2} ]$$

peak at a binding energy of 63 eV as shoulder on the Na peak. Shown in FIG. 12 are the dihydrino molecular

$${H}_{2}^{*} [ n = \frac{1}{3} ; 2 {c}^{′} = \frac{\sqrt{2} {a}_{0}}{3} ]$$

peak at a binding energy of 140 eV and the dihydrino molecular

$${H}_{2}^{*} [ n = \frac{1}{4} ; 2 {c}^{′} = \frac{\sqrt{2} {a}_{0}}{4} ]$$

peak at a binding energy of 249 eV. Although the agreement is remarkable, it was necessary to eliminate all other possible explanations before assigning the 63 eV, 140 eV, and 249 eV features to the dihydrino,

$${H}_{2}^{*} [ n = \frac{1}{2} ; 2 {c}^{′} = \frac{\sqrt{2} {a}_{0}}{2} ] , {H}_{2}^{*} [ n = \frac{1}{3} ; 2 {c}^{′} = \frac{\sqrt{2} {a}_{0}}{3} ] ,$$

and

$${H}_{2}^{*} [ n = \frac{1}{4} ; 2 {c}^{′} = \frac{\sqrt{2} {a}_{0}}{4} ] ,$$

respectively. The only substantial candidate element that potentially could give rise to a peak near 63 eV is Ti; however, none of the other Ti peaks are present. In the case of the 140 eV peak, the only substantial candidate elements are Zn and Pb. These elements are eliminated because both elements would give rise to other peaks of equal or greater intensity (e.g. 413 eV and 435 eV for Pb and 1021 eV and 1044 eV for Zn) which are absent. In the case of the 249 eV peak, the only substantial candidate element is Rb. This element is eliminated because it would give rise to other peaks of equal or greater intensity (e.g. 240, 111, and 112 Rb peaks) which are absent. The XPS results are consistent with the assignment of the shoulder at 63 eV to

$${H}_{2}^{*} [ n = \frac{1}{2} ; 2 {c}^{′} = \frac{\sqrt{2} {a}_{0}}{2} ] ,$$

the split peaks at 140 eV to

$${H}_{2}^{*} [ n = \frac{1}{3} ; 2 {c}^{′} = \frac{\sqrt{2} {a}_{0}}{3} ] ,$$

and the split peaks at 249 eV to

$${H}_{2}^{*} [ n = \frac{1}{4} ; 2 {c}^{′} = \frac{\sqrt{2} {a}_{0}}{4} ] .$$

These results agree with the predicted binding energies given by Eq. (29a) as shown in Table 3.

The hydrino atoms and dihydrino molecules are bound with hydrino hydride as compounds such as NiH₆ and NaNiH₆ as demonstrated in the Identification of Hydrino Hydride Compounds by Mass Spectroscopy Section, which presents novel chemistry. The presence of hydrino and dihydrino peaks is enhanced by the presence of platinum and palladium on this sample which can form such bonds. The abnormal breath of the peaks, shifting of their energy, and the splitting of peaks is consistent with this type of bonding to different elements.

### C. Experimental Method of Hydrino Hydride XPS

A series of XPS analyses were made on a carbon cathodes used in electrolysis of aqueous potassium carbonate and on crystalline samples by the Zettlemoyer Center for Surface Studies, Sinclair Laboratory, Lehigh University, to identify hydrino hydride binding energy peaks. A high quality spectrum was obtained over a binding energy range of 300 to 0 eV. This energy region completely covers the C 2p region and the region around the hydrino hydride binding energies 3 eV (H⁻(n=½)) to 73 eV (H⁻(n= 1/16)). (In some cases, the region around 3 eV was difficult to obtain due to sample charging). The samples were prepared as follows:

a. Carbon Electrode Samples

Sample #2. The cathode and anode each comprised a 5 cm by 2 mm diameter high purity glassy carbon rod. The electrolyte comprised 0.57 M K₂CO₃ (Puratronic 99.999%). The electrolysis was performed at 2.75 volts for three weeks. The cathode was removed from the cell, rinsed immediately with distilled water, and dried with a N₂ stream. A piece of suitable size was cut from the electrode, mounted on a sample stub, and placed in the vacuum system.

Sample #3. The remaining portion of the electrode of sample #2 was stored in a sealed plastic bag for three months at which time a piece of suitable size was cut from the electrode, mounted on a sample stub, placed in the vacuum system, and XPS scanned.

b. Crystal Samples from an Electrolytic Cell

Hydrino hydride was prepared during the electrolysis of an aqueous solution of K₂CO₃ corresponding to the catalyst K⁺/K⁺. The cell comprised a 10 gallon (33 in.×15 in.) Nalgene tank (Model # 54100-0010). Two 4 inch long by ½ inch diameter terminal bolts were secured in the lid, and a cord for a calibration heater was inserted through the lid. The cell assembly is shown in FIG. 2.

The cathode comprised 1.) a 5 gallon polyethylene bucket which served as a perforated (mesh) support structure where 0.5 inch holes were drilled over all surfaces at 0.75 inch spacings of the hole centers and 2.) 5000 meters of 0.5 mm diameter clean, cold drawn nickel wire (NI 200 0.0197″, HTN36NOAG1, A1 Wire Tech, Inc.). The wire was wound uniformly around the outside of the mesh support as 150 sections of 33 meter length. The ends of each of the 150 sections were spun to form three cables of 50 sections per cable. The cables were pressed in a terminal connector which was bolted to the cathode terminal post. The connection was covered with epoxy to prevent corrosion.

The anode comprised an array of 15 platinized titanium anodes (10—Engelhard Pt/Ti mesh 1.6″×8″ with one ¾″ by 7″ stem attached to the 1.6″ side plated with 100 U series 3000; and 5—Engelhard 1″ diameter×8″ length titanium tubes with one ¾″×7″ stem affixed to the interior of one end and plated with 100 U Pt series 3000). A ¾″ wide tab was made at the end of the stem of each anode by bending it at a right angle to the anode. A ¼″ hole was drilled in the center of each tab. The tabs were bolted to a 12.25″ diameter polyethylene disk (Rubbermaid Model #JN²-2669) equidistantly around the circumference. Thus, an array was fabricated having the 15 anodes suspended from the disk. The anodes were bolted with ¼″ polyethylene bolts. Sandwiched between each anode tab and the disk was a flattened nickel cylinder also bolted to the tab and the disk. The cylinder was made from a 7.5 cm by 9 cm long×0.125 mm thick nickel foil. The cylinder traversed the disk and the other end of each was pressed about a 10 AWG/600 V copper wire. The connection was sealed with shrink tubing and epoxy. The wires were pressed into two terminal connectors and bolted to the anode terminal. The connection was covered with epoxy to prevent corrosion.

Before assembly, the anode array was cleaned in 3 M HCL for 5 minutes and rinsed with distilled water. The cathode was cleaned by placing it in a tank of 0.57 M K₂CO₃/3%. H₂O₂ for 6 hours and then rinsing it with distilled water. The anode was placed in the support between the central and outer cathodes, and the electrode assembly was placed in the tank containing electrolyte. The power supply was connected to the terminals with battery cables.

The electrolyte solution comprised 28 liters of 0.57 M K₂CO₃ (Alfa K₂CO₃ 99±%).

The calibration heater comprised a 57.6 ohm 1000 watt Incolloy 800 jacketed Nichrome heater which was suspended from the polyethylene disk of the anode array. It was powered by an Invar constant power (±0.1% supply (Model #TP 36-18). The voltage (±0.1%) and current (±0.1%) were recorded with a Fluke 8600A digital multimeter.

Electrolysis was performed at 20 amps constant current with a constant current (±0.02%) power supply (Kepco Model # ATE 6—100M).

The voltage (±0.1%) was recorded with a Fluke 8600A digital multimeter. The current (±0.5%) was read from an Ohio Semitronics CTA 101 current transducer.

The temperature (±0.1° C.) was recorded with a microprocessor thermometer Omega HH21 using a type K thermocouple which was inserted through a ¼″ hole in the tank lid and anode array disk. To eliminate the possibility that temperature gradients were present, the temperature was measured throughout the tank. No position variation was found to within the detection of the thermocouple (±0.1° C.).

The temperature rise above ambient (ΔT=T(electrolysis only)−T(blank)) and electrolysis power were recorded daily. The heating coefficient was determined “on the fly” by turning an internal resistance heater off and on, and inferring the cell constant from the difference between the losses with and without the heater. 20 watts of heater power were added to the electrolytic cell every 72 hours where 24 hours was allowed for steady state to be achieved. The temperature rise above ambient (ΔT₂=T(electrolysis+heater)−T(blank)) was recorded as well as the electrolysis power and heater power.

In all temperature measurements, the “blank” comprised 28 liters of water in a 10 gallon (33″×15″) Nalgene tank with lid (Model #54100-0010). The stirrer comprised a 1 cm diameter by 43 cm long glass rod to which an 0.8 cm by 2.5 cm Teflon half moon paddle was fastened at one end. The other end was connected to a variable speed stirring motor (Talboys Instrument Corporation Model # 1075C). The stirring rod was rotated at 250 RPM.

The “blank” (nonelectrolysis cell) was stirred to simulate stirring in the electrolytic cell due to gas sparging. The one watt of heat from stirring resulted in the blank cell operating at 0.2° C. above ambient.

The temperature (±0.1° C.) of the “blank” was recorded with a microprocessor thermometer (Omega HH21 Series) which was inserted through a ¼″ hole in the tank lid.

The crystals were obtained from the electrolyte:

Sample #4. The sample was prepared by filtering the K₂CO₃, electrolyte from the cell described herein that produced 6.3×10⁸ J of enthalpy of formation of hydrino hydride with a Whatman 110 mm filter paper (Cat. No. 1450 110) to obtain white crystals. XPS and mass spectra were obtained. XPS was obtained of the crystals by mounting the sample on a polyethylene support.

Sample #5. The sample was prepared by acidifying the K₂CO₃ electrolyte from the cell described herein that produced 6.3×10⁸ J of enthalpy of formation of hydrino hydride with HNO₃, and concentrating the acidified solution until yellow-white crystals formed on standing at room temperature (the yellow color may be due to the continuum absorption of H⁻(n=½) in the near UV, 407 nm continuum). During neutralization the pH repetitively increased from 7 to 9 at which time additional acid was added with carbon dioxide release. The increase in pH (release of base by the solute) was dependent on the temperature and concentration of the solution. This observation was consistent with HCO₃⁻ release from hydrino hydride compounds such as HNa₂HCO₃ and LiHNaHCO₃ given in the Identification of Hydrino Hydride Compounds by Mass Spectroscopy Section. A reaction consistent with this observation is the displacement reaction of NO₃⁻ for HCO₃⁻. The XPS and mass spectra were obtained. XPS was obtained of the crystals by mounting the sample on a polyethylene support.

Sample #6. Thermacore, Inc. operated a K₂CO₃ electrolytic cell hydrino hydride reactor for 15 months [R. Mills, W. Good, and R. Shaubach, Fusion Technol. 25, 103 (1994)] whereby the 1.6×10⁹ J of enthalpy of formation of hydrino hydride exceeded the total input enthalpy given by the product of the electrolysis voltage and current over time by a factor greater than 8. The sample was prepared by concentrating the K₂CO₃ electrolyte from a cell operated until yellow-white crystals just formed (the yellow color may be due to the continuum absorption of H⁻(n=½) in the near UV, 407 nm continuum). XPS was obtained of the crystals by mounting the sample on a polyethylene support.

### D. Results and Discussion

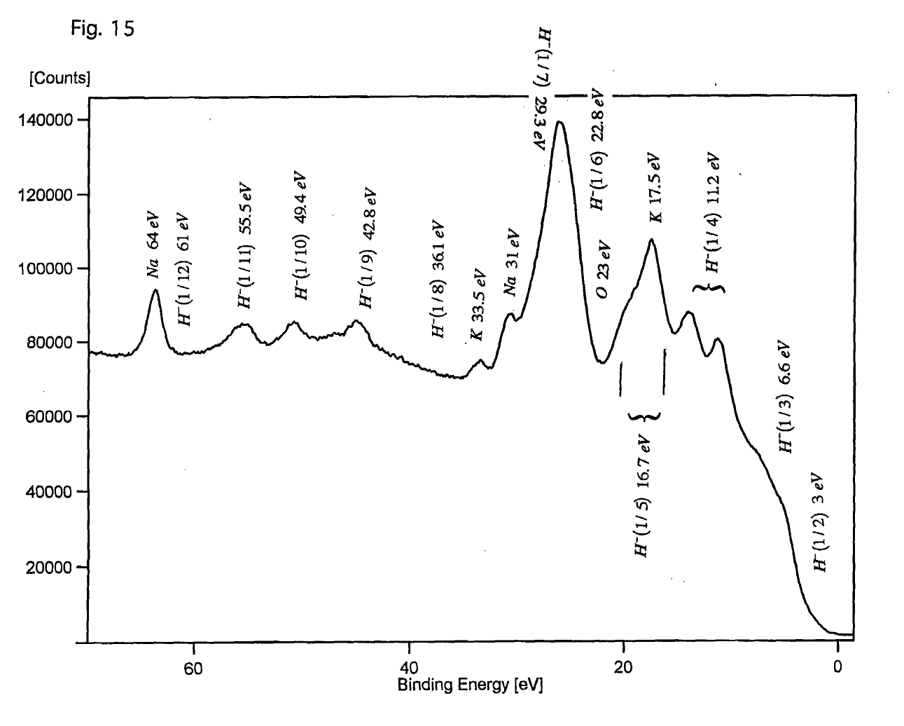

The low binding energy range (0-75 eV) of the glassy carbon rod cathode following electrolysis of a 0.57M K₂CO₃ electrolyte before (sample #2) and after (Sample # 3) storage for three months is shown in FIG. 14 and FIG. 15, respectively. For the sample scanned immediately following electrolysis, the position of the potassium peaks, K, and the oxygen peak, 0, are identified in FIG. 14. The high resolution XPS of the same electrode following three months of storage is shown in FIG. 15. The hydrino hydride peaks H⁻(n=1/p) for p=2 to p=12, the potassium peaks, K, and the sodium peaks, Na, and the oxygen peak, O, (which is a minor contributor since it must be smaller than the potassium peaks) are identified in FIG. 15. (Further hydrino hydride peaks to p=16 were identified in the survey scan in the region 65 eV to 73 eV (not shown)). The peaks at the positions of the predicted binding energies of hydrino hydride significantly increased while the potassium peaks at 18 and 34 significantly deceased relatively. Sodium peaks at 1072 eV and 495 eV (in the survey scan (not shown)), 64 eV, and 31 eV (FIG. 15) also developed with storage. The mechanism of the enhancement of the hydrino hydride peaks on storage is crystal growth from the bulk of the electrode of a predominantly sodium hydrino hydride compound. (X-ray diffraction of crystals grown on a stored nickel cathode showed peaks that could not be assigned to known compounds as given in the Identification of Hydrino Hydride Compounds by XRD Section.) These changes with storage substantially eliminate impurities as the source of the peaks assigned to hydrino hydrides since impurity peaks would broaden and decrease in intensity due to oxidation if any change would occur at all.

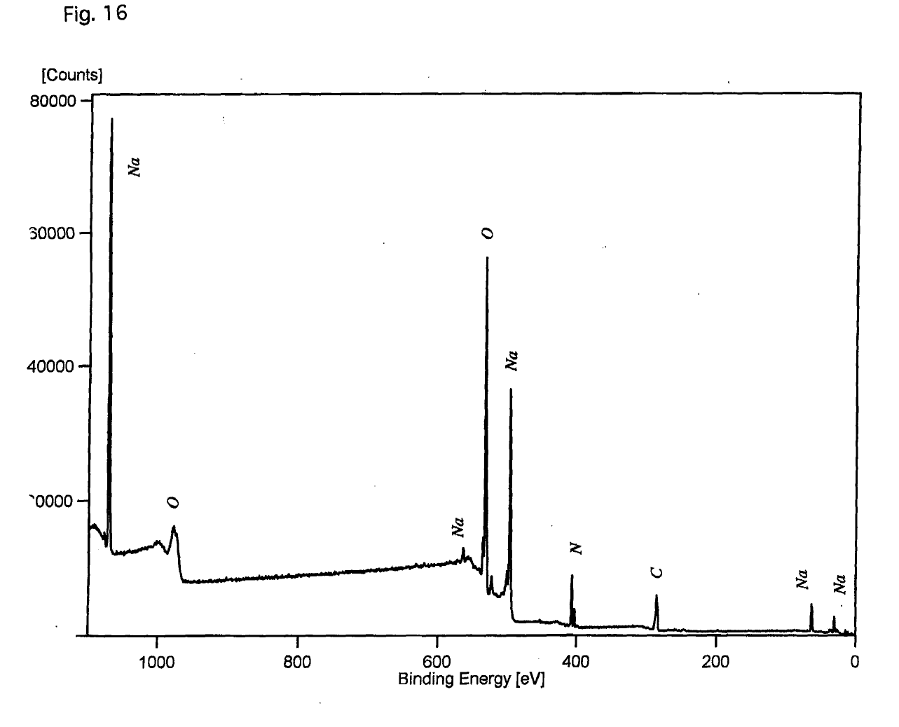

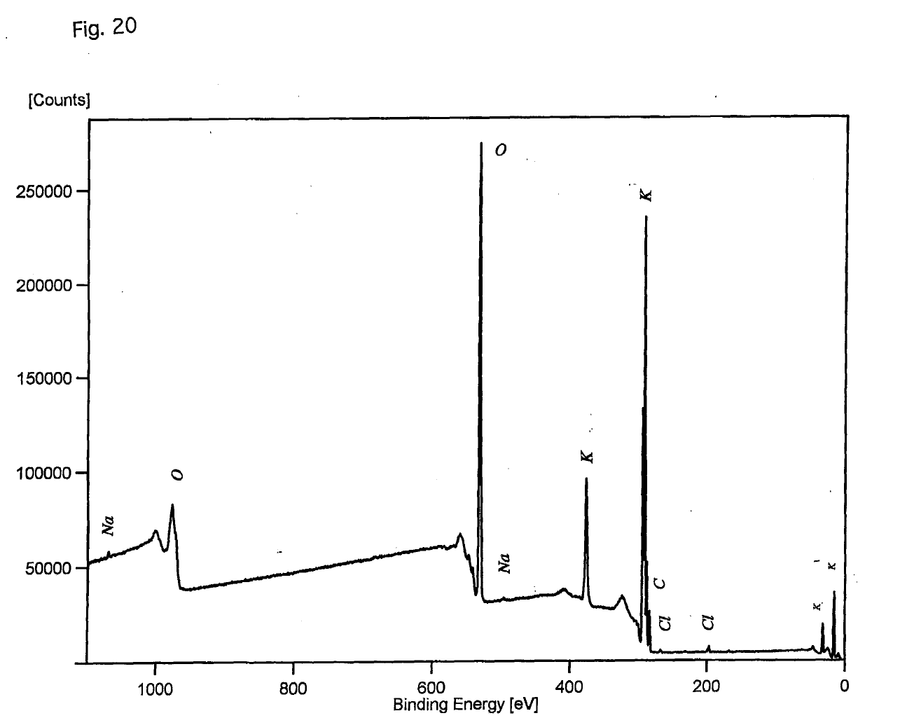

Isolation of pure hydrino hydride compounds from the electrolyte is the means of eliminating impurities from the XPS sample which concomitantly dispositively eliminates impurities as an alternative assignment to the hydrino hydride peaks. Samples #4, #5, and #6 were purified from a K₂CO₃ electrolyte. The survey scans are shown in FIGS. 16, 18, and 20, respectively, with the primary elements identified. No impurities are present in the survey scans which can be assigned to peaks in the low binding energy region with the exception of sodium at 64 and 31 eV, potassium at 18 and 34 eV, and oxygen at 23 eV. Accordingly, any other peaks in this region must be due to novel compositions.

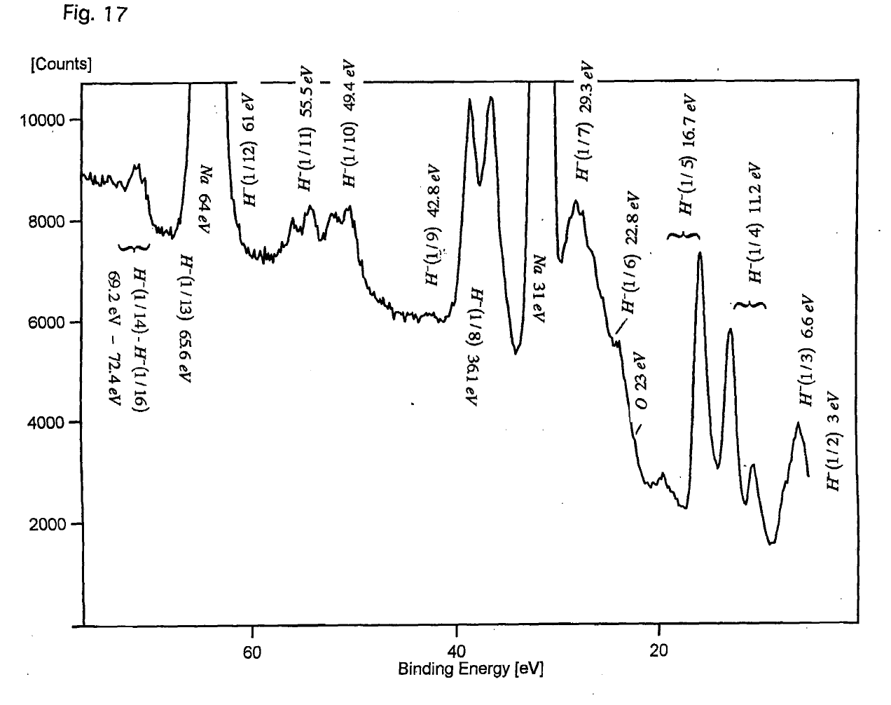

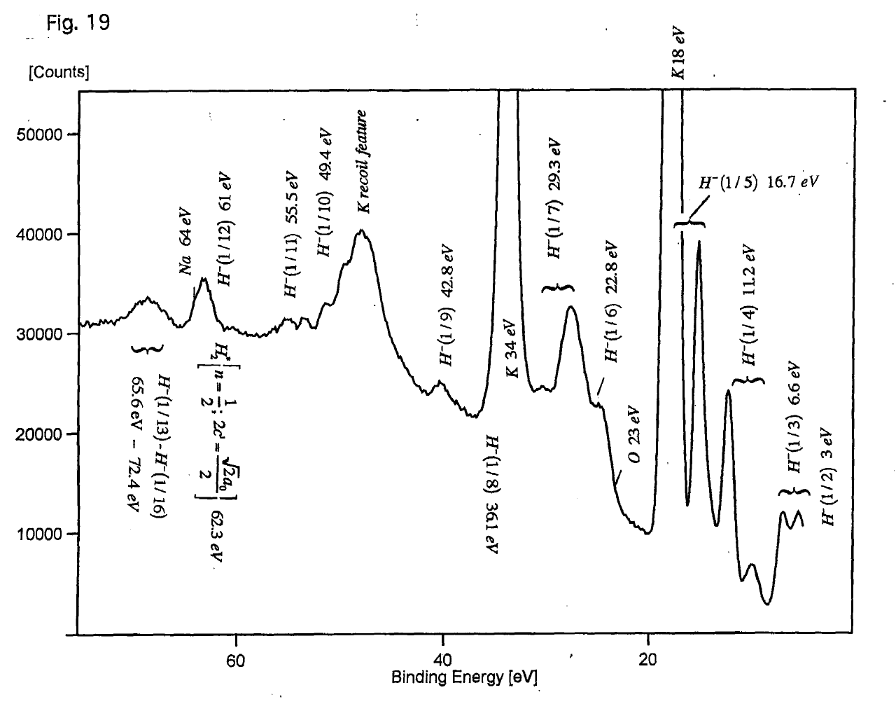

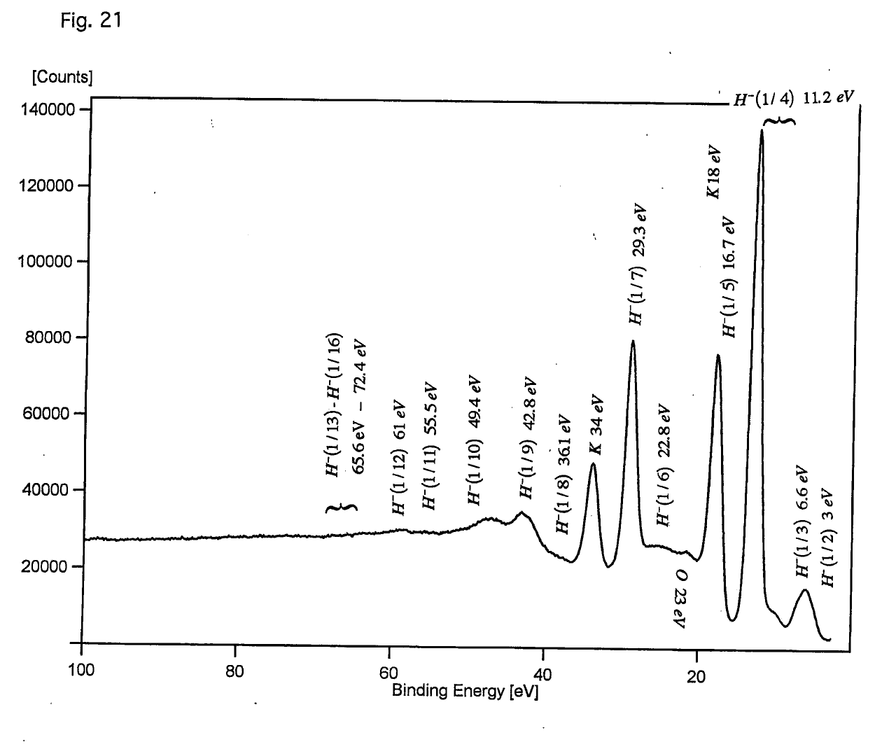

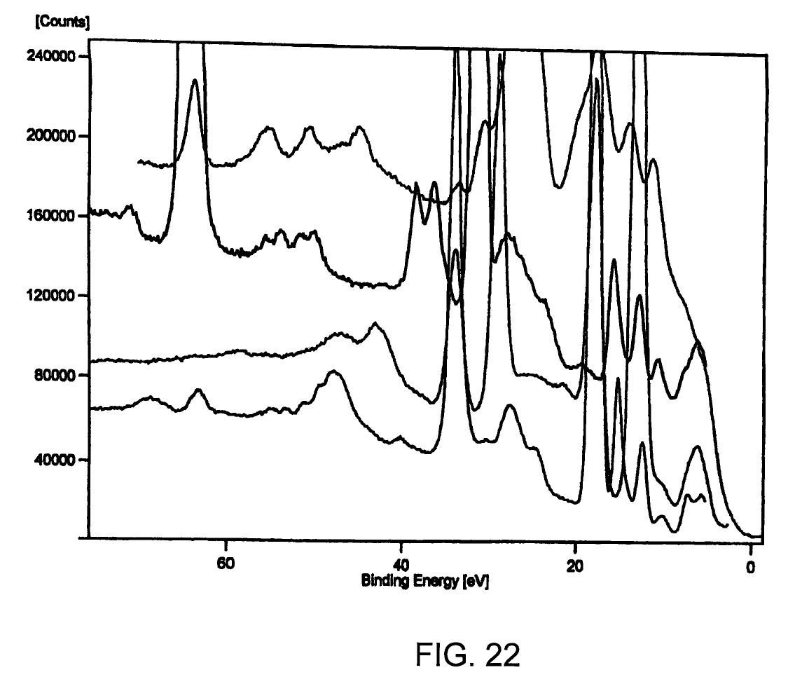

The hydrino hydride peaks H⁻(n=11p) for p=2 to p=16 and the oxygen peak, O, are identified for each of the samples #4, #5, and #6 in FIGS. 17, 19, and 21, respectively. In addition, the sodium peaks, Na, of sample #4 and sample #5 are identified in FIG. 17 and FIG. 19, respectively. The potassium peaks, K, of sample #5 and sample # 6 are identified in FIG. 19 and FIG. 21, respectively. The low binding energy range (0-75 eV) XPS spectra of crystals from a 0.57M K₂CO₃ electrolyte (sample #4, #5, and #6) are superimposed in FIG. 22 which demonstrates that the correspondence of the hydrino hydride peaks from the different samples is excellent. These peaks were not present in the case of the XPS of matching samples except that Na₂CO₃ replaced K₂CO₃ as the electrolyte.

The data provide the identification of hydrino hydride compounds whose XPS peaks can not be assigned to impurities. Several of the peaks are split such as the H⁻(n=¼), H⁻(n=⅕), H⁻(n=⅛), H⁻(n= 1/10), and H⁻(n= 1/11) peaks shown in FIG. 17. The splitting indicates that several compounds comprising the same hydrino hydride ion are present and further indicates the possibility of bridged structures of the compounds given in the Identification of Hydrino Hydride Compounds by Mass Spectroscopy Section such as

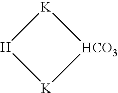

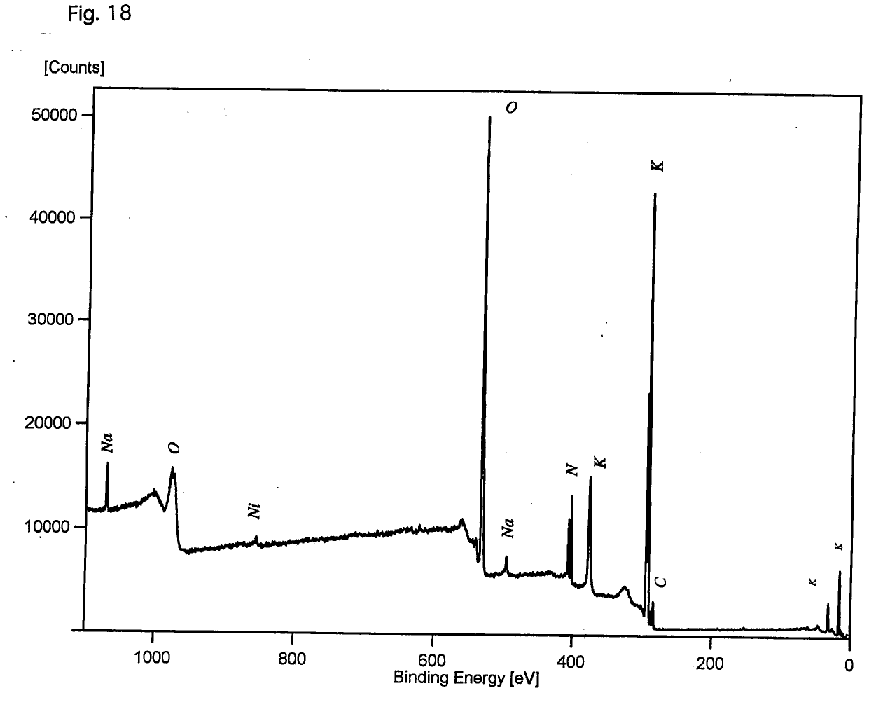

including dimers such as K₂H₂ and Na₂H₂. FIG. 18 indicates a water soluble nickel compound (Ni is present in the survey scan of sample #5). Furthermore, the

$${H}_{2}^{⋆} [ n = \frac{1}{2} ; 2 {c}^{′} = \frac{\sqrt{2} {a}_{0}}{2} ]$$

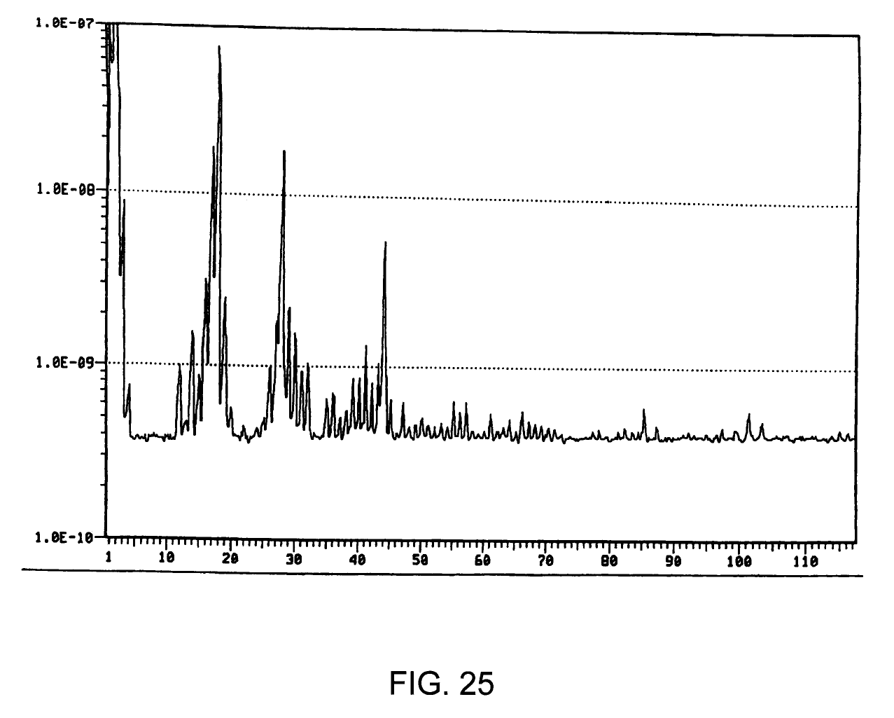

peak is shown in the 0-75 eV scan of sample #5 (FIG. 19). The XPS and mass spectroscopy results (FIG. 25) are consistent in the identification of compounds such as NiH₆, LiNiH₆, NaNiH₆, and KNiH₆ which comprises hydrino hydride and dihydrino. For example, a structure for NiH₆ is

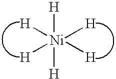

The large sodium peaks of the XPS of the stored carbon cathode of a K₂CO₃ electrolytic cell (sample #3) and the crystals from a K₂CO, electrolyte (sample #4) indicate that hydrino hydrides compounds preferentially form with sodium over potassium. The hydrino hydride peak H⁻(n=⅛) shown in FIGS. 15, 19, and 21 at a binding energy of 36.1 eV is broad due to a contribution from the loss feature of potassium at 33 eV that superimposes the hydrino hydride peak H⁻(n=⅛) in these XPS scans. The data further indicate that the distribution of hydrino hydrides tends to successively lower states over time. From Eq. (1), the most stable hydrino hydride is H⁻(n= 1/16) which is predicted to be the favored product over time. No hydrino hydride states of higher binding energy were detected.

### Identification of Hydrino Hydride Compounds by Mass Spectroscopy

A cell that produced 6.3×10⁸ J of enthalpy of formation of hydrino hydride was operated by BlackLight Power, Inc. (Malvern Pa.) Elemental analysis of the electrolyte of the 28 liter K₂CO₃ electrolytic cell, equivalent to that of Mills et al. [R. Mills, W. Good, and R. Shaubach, Fusion Technol. 25, 103 (1994)] except that it lacked the additional central cathode, demonstrated that the potassium content of the electrolyte had decrease from the initial 56% composition by weight to 33% composition by weight. The measured pH was 9.85; whereas, the pH at the initial time of operation was 11.5. The pH of the cell operated by Thermacore, Inc. (Lancaster, Pa.) [R. Mills, W. Good, and R. Shaubach, Fusion Technol. 25, 103 (1994)] was originally 11.5 corresponding to the K₂CO₃ concentration of 0.57 M which was confirmed by elemental analysis. This cell had produced an enthalpy of formation of hydrino hydride of 1.6×10⁹ J that exceeded the total input enthalpy given by the product of the electrolysis voltage and current over time by a factor greater than 8. Following the 15 month long energy production run, the pH was measured to be 9.04, and it was observed by drying the electrolyte and weighing it that over 90% of the electrolyte had been lost from the cell. The loss in both cases was assigned to the formation of volatile potassium hydrino hydride compounds whereby hydrino was produced by catalysis of hydrogen atoms that then reacted with water to form hydrino hydride and oxygen. The reaction is:

$$\begin{matrix}2 H [ \frac{{a}_{H}}{p} ] + {H}_{2} O \to 2 {H}^{-} ( 1 / p ) + 2 {H}^{+} + \frac{1}{2} {O}_{2} & ( 50 ) \\ 2 {H}^{-} ( 1 / p ) + 2 {K}_{2} {CO}_{3} + 2 {H}^{+} \to 2 K H {CO}_{3} + 2 K H ( 1 / p ) & ( 51 ) \\ 2 H [ \frac{{a}_{H}}{p} ] + {H}_{2} O + 2 {K}_{2} {CO}_{3} \to 2 K H {CO}_{3} + 2 K H ( 1 / p ) + \frac{1}{2} {O}_{2} & ( 52 )\end{matrix}$$

This reaction is consistent with the elemental analysis (Galbraith Laboratories) of the electrolyte of the BlackLight Power, Inc. cell as predominantly KHCO₃ and hydrino hydride compounds including KH(1/p) based on the excess hydrogen content which was 30% in excess of that of KHCO₃ (1.3 versus 1 atomic percent). The volatility of KH(1/p) would give rise to a potassium deficit over time.

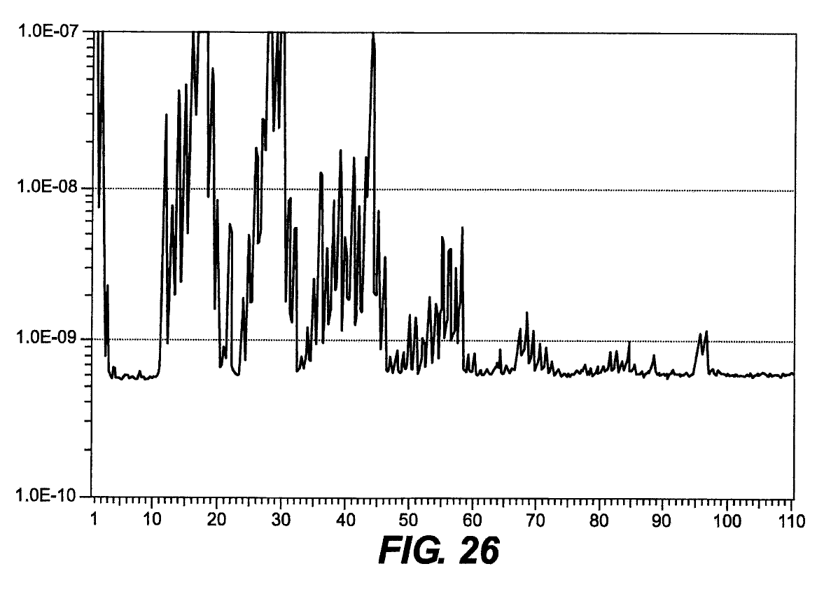

The possibility of using mass spectroscopy to detect volatile hydrino hydride compounds was explored. A number of hydrino hydride compounds were identified by mass spectroscopy by forming vapors of heated crystals from electrolytic cell, gas cell, gas discharge cell, and plasma torch cell hydrino hydride reactors. In all cases, hydrino hydride peaks were also observed by XPS of the crystals used for mass spectroscopy that were isolated from each hydrino hydride reactor. For example, the XPS of the crystals isolated from the electrolytic cell hydride reactor corresponding to the mass spectrum shown in FIG. 26 and FIG. 25 are shown in FIG. 17 and FIG. 19, respectively.

### A. Sample Collection and Preparation

A reaction to prepare hydrino hydride is given by Eq. (8). Sources of hydrino atoms which react to form hydrino hydride are 1.) an electrolytic cell hydride reactor, 2.) a gas cell hydrino hydride reactor, 3.) a gas discharge cell hydrino hydride reactor, 4.) a plasma torch cell hydrino hydride reactor. These reactors were used to prepare crystal samples for mass spectroscopy. The hydrino hydride was collected directly or it was purified for solution by precipitation and recrystallization. In the case of one electrolytic sample, the K₂CO₃ electrolyte was made 1M in LiNO₃ and acidified with HNO₃ before crystals were precipitated.

a. Electrolytic Sample

Hydrino hydride was prepared during the electrolysis of an aqueous solution of K₂CO₃ corresponding to the transition catalyst K⁺/K⁺. The cell description is given in the Crystal Samples from an Electrolytic Cell Section. The cell assembly is shown in FIG. 2.

The crystals were obtained from the electrolyte:

1.) a control electrolytic cell that was identical to the experimental cell of 3 and 4 below except that NaCO₃ replaced K₂CO₃ was operated at Idaho National Engineering Laboratory for 6 months. The Na₂CO₃ electrolyte was concentrated by evaporation until crystals formed. The crystals were analyzed at BlackLight Power, Inc. by mass spectroscopy.

2.) a further control comprised the K₂CO₃ used as the electrolyte of the K₂CO₃ electrolytic cell (Alfa K₂CO₃ 99%).

3.) the sample was prepared by: 1.) adding LiNO₃ to the K₂CO₃ electrolyte from the cell described herein that produced 6.3×10⁸ J of enthalpy of formation of hydrino hydride to a final concentration of 1 M; 2.) acidifying the solution with HNO₃, and 3.) concentrating the acidified solution until yellow-white crystals formed on standing at room temperature. XPS and mass spectra were obtained.

4.) the sample was prepared by filtering the K₂CO₃ electrolyte from the cell described herein that produced 6.3×10⁸ J of enthalpy of formation of hydrino hydride with a Whatman 110 mm filter paper (Cat. No. 1450 110). XPS and mass spectra were obtained.

b. Gas Cell Sample

Hydrino hydride was prepared in a vapor phase gas cell with a tungsten filament and KI as the catalyst. The high temperature gas cell shown in FIG. 4 was used to produce hydrino hydride compounds wherein hydrino atoms are formed from the transition reaction using potassium ions and hydrogen atoms in the gas phase. The cell was rinsed with deionized water following a reaction. The rinse was filtered, and hydrino hydride crystals were precipitated by concentration.

The experimental gas cell hydrino hydride reactor shown in FIG. 4 comprised a tungsten filament 1, a quartz cell 2, a catalyst reservoir 3, a quartz plug 4, a Pyrex cap 5, electrical leads 6, Baratron gauges 7, a vacuum pump 8, a power supply 9, a mass flow controller 10, mass flow controller valve 30, a hydrogen tank 11, a helium tank 12, a hydrogen control valve 13, a helium control valve 15, Perlite insulation 14, catalyst reservoir heater 20, gas outlet 21, gas inlet 25, electrical lead inlets 22 and 24, lifting rod of the quartz plug 26, port for the lifting rod of the quartz plug 23, vacuum pump valve 27, outlet valve 28, inlet valve 29, and mass flow controller bypass valve 31. The cell comprised a quartz tube 2 five hundred (50) millimeters in length and fifty (50) millimeters in diameter. One end of the cell was necked down and attached to a fifty (50) cubic centimeter catalyst reservoir 3. The other end of the cell was fitted with a Conflat style high vacuum flange that was mated to a Pyrex cap 5 with an identical Conflat style flange. The high vacuum seal was maintained with a Viton O-ring and stainless steel clamp. The Pyrex cap 5 included five glass to metal tubes for the attachment of gas inlet line 25 and outlet line 21, two inlets 22 and 24 for electrical leads 6 to the filament 1, and a port 23 for the lifting rod 26 of the quartz plug 4 separating the catalyst reservoir 3 from the reaction vessel 2.

H₂ gas was supplied to the cell through the inlet 25 from a compressed gas cylinder of ultra high purity hydrogen 11 controlled by the valve 13, mass flow controller 10, mass flow controller valve 30, and inlet valve 29. where the bypass valve 31 was closed. Excess gas was removed through the gas outlet 21 by a molecular drag pump 8 capable of reaching pressures of 10⁻⁴ torr controlled by valves 27 and 28. Pressures were measured by a 0-1000 torr Baratron pressure gauge and a 0-100 torr Baratron pressure gauge 7. The filament 1 was 0.381 millimeters in diameter and two hundred (200) centimeters in length. It was suspended on a ceramic support to maintain its shape when heated. The filament was resistively heated using a Sorensen DCS 80-13 power supply 9 controlled by a custom built constant power controller. Thus, the power supply was capable of delivering a constant power to the filament. The catalyst reservoir 3 was heated independently using a band heater 20, also powered by a constant power supply. The entire quartz cell was enclosed inside an insulation package comprised of Perlite type insulation 14. Several K type thermocouples were placed in the insulation to measure key temperatures of the cell and insulation. The thermocouples were read with a multichannel computer data acquisition system.

The cell was operated under flow conditions with a total pressure of less than two (2) torr of hydrogen or control helium via flow controller 10. The filament was heated to a temperature of approximately 1000-1400° C. as calculated by its resistance. This created a “hot zone” within the quartz tube as well as atomization of the hydrogen gas. The catalyst reservoir was heated to a temperature of 700° C. to establish the vapor pressure of the catalyst. The quartz plug 4 separating the catalyst reservoir 3 from the reaction vessel 2 was removed using the lifting rod 26 which was slid about 2 cm through the port 23. This introduced the vaporized catalyst into the “hot zone” containing the atomic hydrogen, and allowed the catalytic reaction to occur.

As described above, a number of thermocouples were positioned to measure the linear temperature gradient in the outside insulation. The gradient was measured for several known input powers over the experimental range with the catalyst valve closed. Helium supplied from the tank 12 and controlled by the valves 15, 29, 30, and 31, and flow controller 10 was flowed through the cell during the calibration where the helium pressure and flow rates were identical to those of hydrogen in the experimental cases. The thermal gradient was determined to be linearly proportional to input power. Comparing an experimental gradient (catalyst valve open/hydrogen flowing) to the calibration gradient allowed the determination of the requisite power to generate that gradient. In this way, calorimetry was performed on the cell to measure the heat output with a known input power. The data was recorded with a Macintosh based computer data acquisition system (PowerComputing PowerCenter Pro 180) and a National Instruments, Inc. NI-DAQ PCI-MIO-16XE-50 Data Acquisition Board.

Enthalpy of catalysis from the gas energy cell having a gaseous transition catalyst (K⁺/K⁺) was observed with low pressure hydrogen in the presence of potassium iodide (KI) which was volatilized at the operating temperature of the cell. The enthalpy of formation of hydrino hydride resulted in a steady state power of about 15 watts that was observed from the quartz reaction vessel containing about 200 mtorr of KI when hydrogen was flowed over the hot tungsten filament. However, no excess enthalpy was observed when helium was flowed over the hot tungsten filament or when hydrogen was flowed over the hot tungsten filament with no KI present in the cell.

The samples were prepared by 1.) rinsing the catalyst and hydrino hydride from the cell with sufficient water that all water soluble compounds dissolved (the hydrino hydride was separately rinsed from the cap where it was preferentially cryopumped), 2.) filtering the solution to remove water insoluble compounds such as metal, 3.) concentrating the solution until a precipitate just formed with the solution at 50° C., 4.) allowing white crystals (yellowish-reddish-brown crystals in the case of the rinse from the cap of the cell) to form on standing at room temperature, 4.) filtering and drying the crystals before the XPS and mass spectra were obtained. The crystals isolated from the cell and used for mass spectroscopy studies where recrystallized in distilled water to obtain high purity crystals which were then studied by XPS.

c. Discharge Cell Sample

Hydrino hydride compounds can be synthesized in a hydrogen gas discharge cell wherein transition catalyst is present in the vapor phase. The transition reaction occurs in the gas phase with a catalyst that is volatilized from the electrodes by the hot plasma current. Gas phase hydrogen atoms are generated with the discharge. The general schematic of the experimental discharge apparatus of FIG. 6 comprises a gas discharge cell 507 (Sargent-Welch Scientific Co. Cat. No. S 68755 25 watts, 115 VAC, 50 60 Hz), a power supply 590, a hydrogen supply 580, a hydrogen supply line 544, a hydrogen supply line valve 550, a vacuum pump 570, a vacuum line 543, a vacuum line valve 560, a pressure gauge 540, a sampling port 530; a sampling line 545, a sampling line valve 535, and a common hydrogen supply line/vacuum line 542. The lines 542, 543, 544, and 545 comprise stainless steel tubing hermetically joined using Swagelok connectors. With the hydrogen supply line valve 550 and the sampling line valve 535 closed and the vacuum line valve 560 open, the vacuum pump 570, the vacuum line 543, and common hydrogen supply line/vacuum line 542 are used to obtain a vacuum in the discharge chamber 500. With the sampling line valve 535 and the vacuum line valve 560 closed and the hydrogen supply line valve 550 open, the gas discharge cell 507 is filled with hydrogen at a controlled pressure using the hydrogen supply 580, the hydrogen supply line 544, and the common hydrogen supply line/vacuum line 542. With the hydrogen supply line valve 550 and the vacuum line valve 560 closed and the sampling line valve 535 open, the sampling port 530 and the sampling line 545 are used to obtain a gas sample for study by methods such as gas chromatography and mass spectroscopy.

The discharge cell 507 comprised a 10″ flint glass (½″ ID) vessel 501, the vessel chamber 500, the hollow cathode 510, and the anode 520 to generate an arc discharge in low pressure hydrogen. The electrodes (½″ height and ¼″ diameter) were connected to the power supply 590 with stainless steel lead wires penetrating the top and bottom ends of the discharge cell. The cell was operated at a hydrogen pressure range of 10 millitorr to 100 torr and a current under 10 mA. During hydrino hydride synthesis, the electrodes 520 and 510 were coated with a potassium salt such as a potassium halide catalyst (e.g. KI). The catalyst was introduced inside the discharge cell 507 by disconnecting it from the common hydrogen supply line/vacuum line 542 and wetting the electrodes with a saturated water or alcohol catalyst solution. The solvent is removed by drying the cell chamber 500 in an oven, by connecting the discharge cell 507 to the common hydrogen supply line/vacuum line 542 shown in FIG. 6, and pulling a vacuum on the discharge cell 507. The synthesis of hydrino hydride comprised the following steps: (1) putting the catalyst solution inside the discharge cell 507 and drying it to form a catalyst coating on the electrodes 510 and 520; (2) vacuuming the discharge cell at 10-30 mtorr for several hours to remove any contaminant gases and residual solvent; and (3) filling the discharge cell with a few mtorr to 100 torr hydrogen and carrying out an arc discharge for at least 0.5 hour.

The samples were prepared by 1.) rinsing the catalyst from the cell with sufficient water that all water soluble compounds dissolved, 2.) filtering the solution to remove water insoluble compounds such as metal, 3.) concentrating the solution until a precipitate just formed with the solution at 50° C., 4.) allowing crystals to form on standing at room temperature, 4.) filtering and drying the crystals before the XPS and mass spectra were obtained. No crystal were obtained when NaI replaced KI.

d. Plasma Torch Sample

Hydrino hydride was synthesized using a plasma torch wherein the transition reaction occurred in the gas phase with a catalyst that was aerosolized into the hot plasma. Gas phase hydrogen atoms were generated by the plasma. Hydrino hydride was prepared in a plasma torch comprising a reservoir containing a KI catalyst with an agitator to mechanically disperse the catalyst into flowing hydrogen. Catalyst and hydrogen were continuously supplied. The hydrino hydride was formed in the plasma and was cryopumped to the walls of the plasma manifold. The cryopumped crystals were removed and purified.

The experimental plasma torch cell hydride reactor of FIG. 8 comprised a plasma torch 702 with a hydrogen plasma 704 enclosed by a manifold 706, a hydrino hydride traps 708, a vacuum pump 710, an argon plasma gas supply 712, a hydrogen supply 738, a hydrogen-plasma-gas mixer and mixture flow regulator 721, KI catalyst 714, a catalyst reservoir 716, a mechanical agitator comprising a magnetic stirring bar 718 and magnetic stirring bar motor 720, a tunable microwave cavity 722, and a microwave generator 724. The hydrogen was supplied to the torch 702 by the passage for both hydrogen and catalyst 728. The argon plasma gas was supplied to the torch by the plasma gas passage 726 and passage for plasma gas and catalyst 728. During operation, hydrogen flowed from the hydrogen supply 738 to the catalyst reservoir 716 via passage 742 and passage 725 wherein the flow of hydrogen was controlled by hydrogen flow controller 744 and valve 746. Argon plasma gas flowed from the plasma gas supply 712 directly to the plasma torch via passage 732 and 726 and to the catalyst reservoir 716 via passage 732 and 725 wherein the flow of plasma gas was controlled by plasma gas flow controller 734 and valve 736. The mixture of plasma gas and hydrogen supplied to the torch via passage 726 and to the catalyst reservoir 716 via passage 725 was controlled by the hydrogen-plasma-gas mixer and mixture flow regulator 721. The hydrogen and plasma gas mixture served as a carrier gas for catalyst particles which were dispersed into the gas stream as fine particles by mechanical agitation. The mechanical agitator comprised the magnetic stirring bar 718 and the magnetic stirring motor 720. The aerosolized catalyst and hydrogen gas of the mixture flowed into the plasma torch 702 and became gaseous hydrogen atoms and vaporized catalyst ions (K⁺ ions from KI) in the plasma 704.

The plasma was powered by microwave generator 724 (Astex Model S1500I) wherein the microwaves were tuned by the tunable microwave cavity 722. Catalysis occurred in the gas phase.

The amount of gaseous catalyst was controlled by controlling the rate that catalyst was aerosolized with the mechanical agitator and the carrier gas flow rate where the carrier gas was a hydrogen/argon gas mixture. The amount of gaseous hydrogen atoms was controlled by controlling the hydrogen flow rate and the ratio of hydrogen to plasma gas in the mixture. The hydrogen flow rate, the plasma gas flow rate, and the mixture directly to the torch and the mixture to the catalyst reservoir were controlled with flow rate controllers 734 and 744, valves 736 and 746, and hydrogen-plasma-gas mixer and mixture flow regulator 721. The aerosol flow rates were 0.8 standard liters per minute (slm) hydrogen and 0.15 slm argon. The argon plasma flow rate was 5 slm. The catalysis rate was also controlled by controlling the temperature of the plasma with the microwave generator 724. The forward input power was 1000 W, the reflected power was 10-20 W.

Hydrino atoms and hydrino hydride were produced in the plasma 704. Hydrino hydride was cryopumped onto the manifold 706, and it flowed into the trap 708 through passage 748. A flow to the trap 708 was effected by a pressure gradient controlled by the vacuum pump 710, vacuum line 750, and vacuum valve 752.

Hydrino hydride samples were collected directly from the manifold and from the hydrino hydride trap.

### B. Mass Spectroscopy

Mass spectroscopy was performed by BlackLight Power, Inc. with a Dycor System 1000 Quadrapole Mass Spectrometer Model #D200MP with a a HOVAC Dri-2 Turbo 60 Vacuum System. One end of a 4 mm ID fritted capillary tube containing about 5 mg of the sample was sealed with a 0.25 in. Swagelock union and plug (Swagelock Co., Solon, Ohio). The other end was connected directly to the sampling port of a Dycor System 1000 Quadrapole Mass Spectrometer (Model D200MP, Ametek, Inc., Pittsburgh, Pa.). The mass spectrometer was maintained at a constant temperature of 115° C. by heating tape. The sampling port and valve were maintained at 150° C. with heating tape. The capillary was heated with a Nichrome wire heater wrapped around the capillary. Mass spectrum was obtained in the region m/e=0-220 at the ionization energy of 70 eV at different sample temperatures. A high resolution scan was then performed over the range which covered all of the peaks observed over the m/e=0-220 mass range (m/e=0−≦117). (Following obtaining the mass spectra shown in FIGS. 25, 26, 27, 28, 32, and 33, the mass spectrum of hydrogen (m/e=2 and (m/e=1), water (m/e=18, m/e=2, and (m/e=1), carbon dioxide (m/e=44 and m/e=12), and hydrocarbon fragment CH₃⁺ (m/e=15), and carbon (m/e=12) were recorded as a function of time.

### C. Results and Discussion

In all samples, the only usual peaks detected in the mass range m/e=1 to 220 were consistent with trace air contamination. No peaks were observed for m/e>117. Peak identifications were compared to the elemental composition. X-ray photoelectron spectrum (XPS) was performed on all of the mass spectroscopy samples to identify hydrino hydride peaks and to determine the elemental composition. In all cases, hydrino hydride peaks were observed, and the trace contaminants were identified.

For example, XPS was performed on the crystals filtered from the electrolyte of the K₂CO₃ electrolytic cell as shown in FIGS. 16 and 17. The K₂CO₃ electrolyte was acidified with HNO₃ to form KNO₃, and an XPS was performed on the crystals which precipitated out of solution as shown in FIGS. 18 and 19. The impurities were concentrated by evaporating the solution to dryness and subliming the KNQ, under vacuum at 300° C. XPS was performed on the residue to further determine the elemental composition. Some of the impurities were concentrated up to a 100 fold. All of the mass spectroscopy samples produced using a potassium catalyst contained lithium, sodium, potassium, magnesium, sulfur, and chlorine. The samples from the electrolytic cell and gas discharge hydrino hydride reactors contained nickel from the nickel electrodes. The sample from the K₂CO₃ electrolytic cell hydrino hydride reactor contained CO₃²⁻ and HCO₃⁻. The sample from the K₂CO₃ electrolytic cell hydrino hydride reactor that was made 1M in LiNO₃ and acidified with HNO₃ contained No₃⁻. The samples from the gas cell hydrino hydride reactors contained nickel and/or iron from the stainless steel leads. The sample from the plasma torch contained SiO₂ and Al from the quartz and the alumina of the plasma torch.

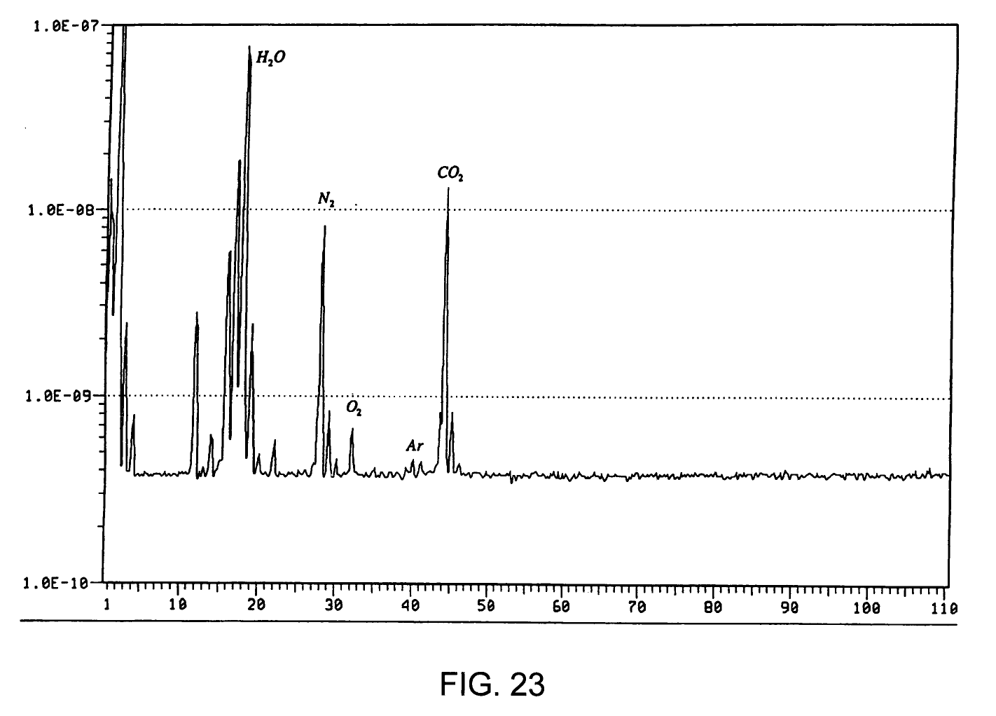

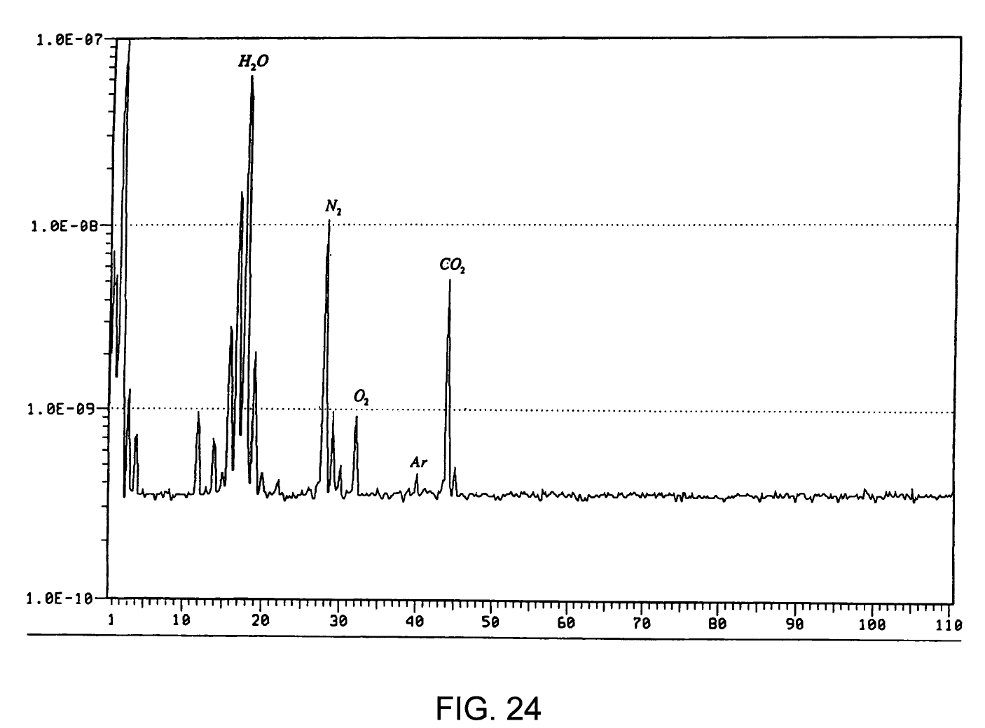

The mass spectrum (m/e=0-110) of the vapors from the crystals from the electrolyte of the Na₂CO₃ electrolytic cell with a sample heater temperature of 225° C. is shown in FIG. 23. No unusual peaks were identified. The mass spectrum (m/e=0-110) of the vapors from the K₂CO₃ used in the K₂CO₃ electrolytic cell hydrino hydride reactor with a sample heater temperature of 225° C. is shown in FIG. 24. No unusual peaks were identified. The mass spectrum (m/e=0-117) of the vapors from the crystals from the electrolyte of the K₂CO₃ electrolytic cell hydrino hydride reactor that was made 1M in LiNO₃ and acidified with HNO₃ with a sample heater temperature of 170° C. is shown in FIG. 25. The parent peak assignments of hydrino hydride compounds followed by the corresponding fragment peaks appear in TABLE 4. The spectrum included peaks of increasing mass as a function of temperature up to the highest mass observed, m/e=117, at a temperature of 170° C. and greater. For example, the m/e=103-97 peaks corresponding to the parent compound KNiH₆ were observed as the temperature was increased from 110° C. to 170° C. The m/e=87 peak of the NaNiH₆ series (m/e=87-81) was also observed upon increasing the temperature. The observation was reproducibly reversible. Decreasing the temperature resulted in the lower temperature spectrum.

TABLE 4
The hydrino hydride compounds assigned as parent peaks
with the corresponding fragment peaks of the mass spectrum
(m/e = 0-117) of the crystals from the electrolyte of the K₂CO₃ electrolytic
cell that was made 1 M in LiNO₃ and acidified with HNO₃ with a sample
heater temperature of 170° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48, 28-26; 27-25; 26-24 |
| NaSiH₆ | 57-51; 32-28; 24-23 |
| NiH₆ | 64-58 |
| LiNiH₆ | 71-65; 58; 8-7 |
| K₂(H(1/p))₂ | 80-78; 43-41; 41-39; 42-41; 40-39 |
| NaNiH₆ | 87-81; 58; 24-23 |
| LiHNaNO₃ | 93-92; 24-23; 8-7 |
| KNiH₆ | 103-97; 58; 43-41; 41-39; 42-41; 40-39 |
| Ni₂H(1/p) | 117-116; 58 |

The mass spectrum (m/e=0-110) of the vapors from the crystals filtered from the electrolyte of the K₂CO₃ electrolytic cell hydrino hydride reactor with a sample heater temperature of 185° C. is shown in FIG. 26. The parent peak assignments of hydrino hydride compounds followed by the corresponding fragment peaks appear in TABLE 5.

TABLE 5
The hydrino hydride compounds assigned as parent peaks
with the corresponding fragment peaks of the mass spectrum
(m/e = 0-110) of the vapors from the crystals filtered from the electrolyte
of the K₂CO₃ electrolytic cell hydrino hydride reactor with a sample
heater temperature of 185° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| HNa₂OH | 64-63; 40; 24-23 |
| NiH₆ | 64-58 |
| LiNiH₆ | 71-65; 58; 8-7 |
| KSiH₆ | 73-67; 32-28; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| NaNiH₆ | 87-81; 58; 24-23 |
| LiHNaHCO₃ | 92-91; 84; 68; 24-23; 8-7 |
| HK₂OH | 96-95; 56; 42-41; 40-39 |
| HNa₂HCO₃ | 108-107; 84; 24-23 |

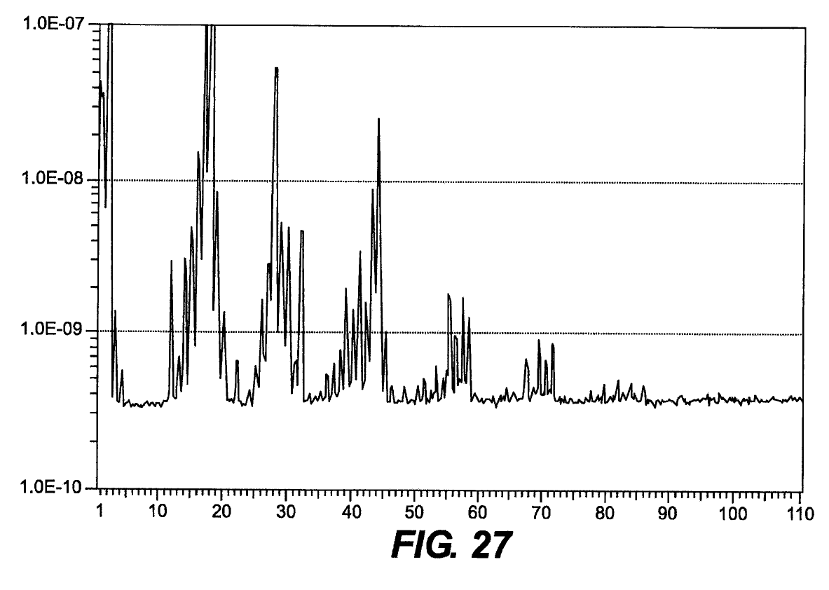

The mass spectrum (m/e=0-110) of the vapors from the crystals W from a gas cell hydrino hydride reactor comprising a KI catalyst, stainless steel filament leads, and a Pt filament with a sample heater temperature of 210° C. is shown in FIG. 27. The parent peak assignments of hydrino hydride compounds followed by the corresponding fragment peaks appear TABLE 6.

TABLE 6
The hydrino hydride compounds assigned as parent peaks
with the corresponding fragment peaks of the mass spectrum
m/e = 0-110 of the of the crystals from the gas cell hydrino hydride
reactor comprising a KI catalyst, stainless steel filament leads, and a Pt
filament with a sample heater temperature of 210° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| NiH₆ | 64-58 |
| LiNiH₆ | 71-65; 58; 8-7 |
| K₂(H(1/p))₂ | 80-78; 43-41; 41-39; 42-41; 40-39 |
| HNa₂Cl | 82-81; 58; 24-23 |
| NaNiH₆ | 87-81; 58; 24-23 |
| LiHNaHCO₃ | 92-91; 84; 68; 24-23; 8-7 |

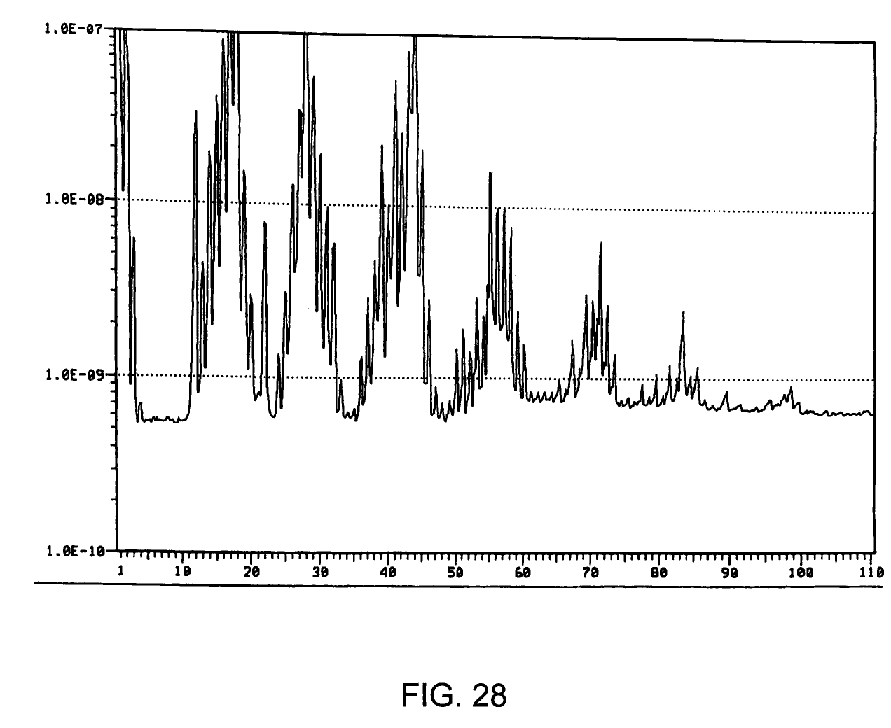

The mass spectrum (m/e=0-110) of the vapors from the crystals from a gas cell hydrino hydride reactor comprising a KI catalyst, stainless steel filament leads, and a W filament with a sample heater temperature of 175° C. is shown in FIG. 28. The parent peak assignments of hydrino hydride compounds followed by the corresponding fragment peaks appear in TABLE 7.

TABLE 7
The hydrino hydride compounds assigned as parent peaks
with the corresponding fragment peaks of the mass spectrum
m/e = 0-110 of the crystals from a gas cell hydrino hydride reactor
comprising a KI catalyst, stainless steel filament leads, and a W filament
with a sample heater temperature of 175° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| NiH₆ | 64-58 |
| LiFeH₆ | 69-63; 8-7 |
| LiNiH₆ | 71-65; 58; 8-7 |
| KSiH₆ | 73-67; 32-28; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| NaFeH₆ | 85-79; 24-23 |
| HClMg₂H₂ | 86-84; 60-59; 28-26; 27-25; 26-24 |
| NaNiH₆ | 87-81; 58; 24-23 |
| LiHNaHCO₃ | 92-91; 84; 68; 24-23; 8-7 |
| LiHNaNO₃ | 93-92; 85; 69; 24-23; 8-7 |
| KFeH₆ | 101-95; 43-41; 41-39; 42-41; 40-39 |

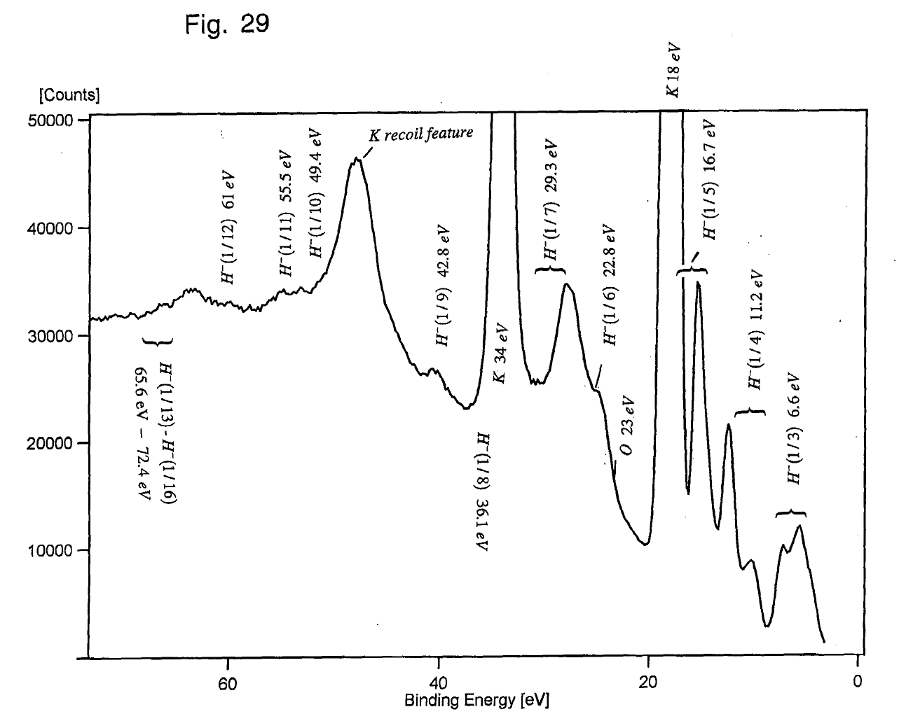

The 0 to 75 eV binding energy region of a high resolution X-ray Photoelectron Spectrum (XPS) of recrystallized crystals prepared from the gas cell hydrino hydride reactor comprising a KI catalyst, stainless steel filament leads, and a W filament corresponding to the mass spectrum shown in FIG. 28 is shown in FIG. 29. The survey scan showed that the recrystallized crystals were that of a pure potassium compound. Isolation of pure hydrino hydride compounds from the gas cell is the means of eliminating impurities from the XPS sample which concomitantly eliminates impurities as an alternative assignment to the hydrino hydride peaks. No impurities are present in the survey scan which can be assigned to peaks in the low binding energy region. With the exception of potassium at 18 and 34 eV, and oxygen at 23 eV, no other peaks in the low binding energy region can be assigned to known elements. Accordingly, any other peaks in this region must be due to novel compositions. The hydrino hydride peaks H⁻(n=1/p) for p=3 to p=16, the potassium peaks, K, and the oxygen peak, O, are identified in FIG. 29. The agreement with the results for the crystals isolated from the electrolytic cells summarized in FIG. 22 are excellent.

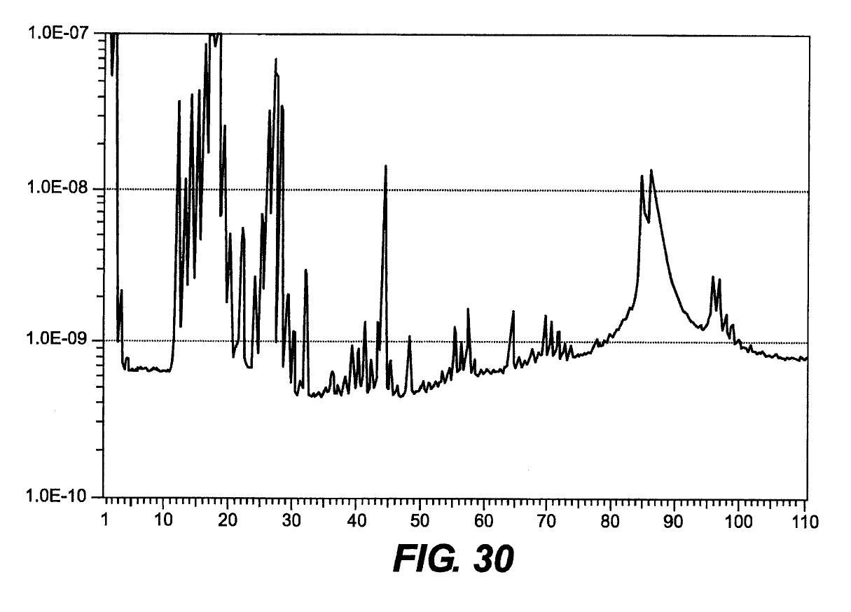

Shown in FIG. 30 is the mass spectrum (m/e=0-110) of the vapors from the cryopumped crystals isolated from the 40° C. cap of a gas cell hydrino hydride reactor comprising a KI catalyst, stainless steel filament leads, and a W filament with the sample dynamically heated from 90° C. to 120° C. while the scan was being obtained in the mass range m/e=75-100. The parent peak assignments of hydrino hydride compounds followed by the corresponding fragment peaks appear in TABLE 8.

TABLE 8
The hydrino hydride compounds assigned as parent peaks
with the corresponding fragment peaks of the mass spectrum
(m/e = 0-110) of the vapors from the cryopumped crystals isolated from
the 40° C. cap of a gas cell hydrino hydride reactor comprising a KI
catalyst, stainless steel filament leads, and a W filament with the sample
dynamically heated from 90° C. to 120° C. while the scan was being
obtained in the mass range m/e = 75-100.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| HNa₂OH | 64-63; 40; 24-23 |
| LiNiH₆ | 71-65; 58; 8-7 |
| KSiH₆ | 73-67; 32-28; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| HClMg₂H₂ | 86-84; 60-59; 28-26; 27-25; 26-24 |
| HK₂OH | 96-95; 56; 42-41; 40-39 |
| KFeH₆ | 101-95; 43-41; 41-39; 42-41; 40-39 |

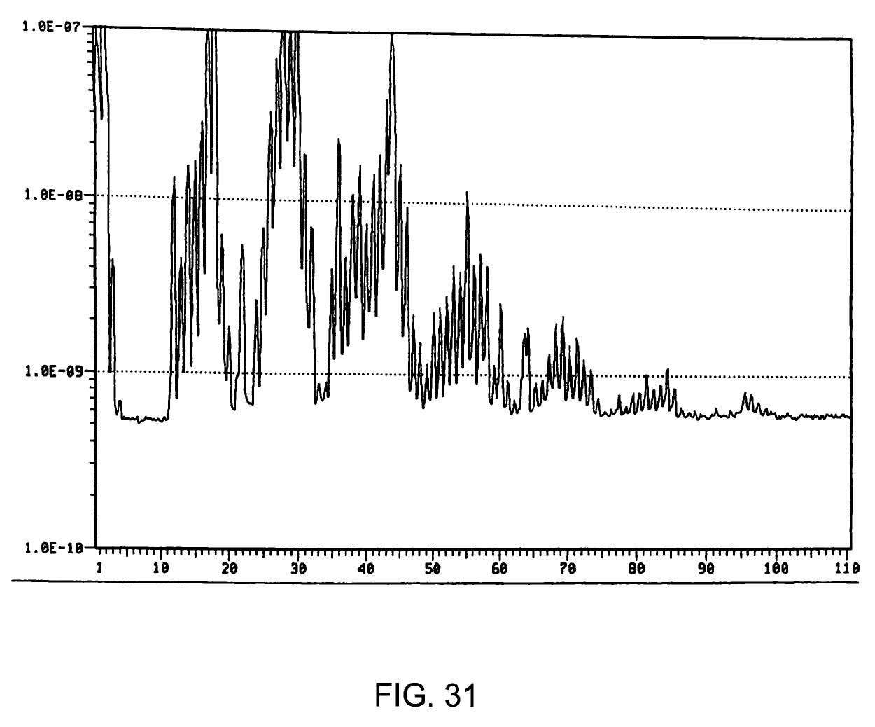

The hydrino hydride compound HClMg₂H₂ (m e=86) with fragment HClMg₂ (m/e=84) and the hydrino hydride compound HK₂OH (m/e=96) with fragment K₂OH (m/e=95) appeared in abundance with dynamic heating. Shown in FIG. 31 is the mass spectrum (m/e=0-110) of the sample shown in FIG. 30 with the succeeding repeat scan where the total time of each scan was 75 seconds. Thus, it took about the time interval 30 to 75 seconds after heating to rescan the region m/e=24-60. The parent peak assignments of hydrino hydride compounds followed by the corresponding fragment peaks appear in TABLE 9.

TABLE 9
The hydrino hydride compounds assigned as parent peaks
with the corresponding fragment peaks of the mass spectrum
(m/e = 0-110) of the sample shown in FIG. 30 with the succeeding
repeat scan where the total time of each scan was 75 seconds.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| HNa₂OH | 64-63; 40; 24-23 |
| NiH₆ | 64-58 |
| LiNiH₆ | 71-65; 58; 8-7 |
| KSiH₆ | 73-67; 32-28; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| NaFeH₆ | 85-79; 24-23 |
| HClMg₂H₂ | 86-84; 60-59; 28-26; 27-25; 26-24 |
| NaNiH₆ | 87-81; 58; 24-23 |
| LiHNaHCO₃ | 92-91; 84; 68; 24-23; 8-7 |
| HK₂OH | 96-95; 56; 42-41; 40-39 |
| KFeH₆ | 101-95; 43-41; 41-39; 42-41; 40-39 |

Comparing FIG. 30 to FIG. 31 shows that the hydrino hydride compound HClMg₂H₂ (m/e=86) with fragment HClMg₂ (m/e=84) has given rise to MgHCl (m/e=60) with fragment MgCl (m/e=59) and MgH₂ (m/e=26) with fragments MgH (m/e=25) and Mg (m/e=24). Also present at the higher temperature is the hydrino hydride compound Mg₂H₄ (m/e=52) with fragments Mg₂H₃ (m/e=51), Mg₂H₂ (m/e=50), Mg₂H (m/e=49), and Mg₂ (m/e=48). And, the hydrino hydride compound HK20H (m/e=96) with fragment K₂OH (m/e=95) has given rise to KOH (m/e=56), and KH₂ (m/e=41) with fragments KH(m/e=40) and K(m/e=39). Further hydrino hydride compounds of similar structural formula that appear in FIG. 31 at the higher temperature are: HNa₂Cl (m/e=82) with fragments Na₂Cl (m/e=81) and NaCl(m/e=58); HNa₂OH (m/e=64) with fragments Na₂OH (m/e=63) and NaH (m/e=24); K₂H₂ (m/e=80) with fragments K₂H (m/e=79), K₂ (m/e=78), KH₂ (m/e=41), KH (m e=40) and K (m/e=39), and Na₂H₂ (m/e=48) with fragments Na₂H (m/e=47), Na₂ (m/e=46), NaH₂ (m/e=25), and NaH (m e=24). The origin of the yellowish-reddish-brown color of the crystals is assigned to the continuum absorption of H⁻(n=½) in the near UV, 407 nm continuum. This assignment is supported by the XPS results which show a large peak at the binding energy of H⁻(n=½), 3 eV (TABLE 1).

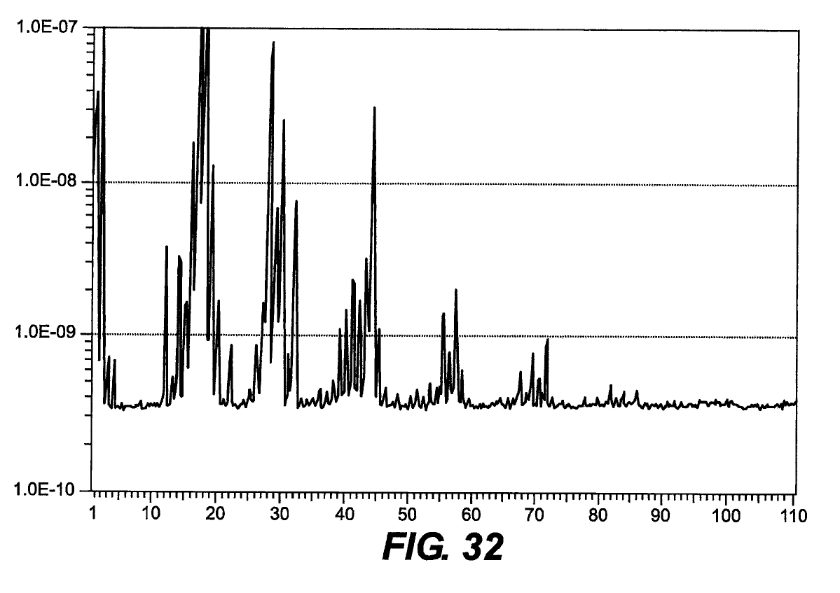

The mass spectrum (m/e=0-110) of the vapors from the crystals from a gas discharge cell hydrino hydride reactor comprising a KI catalyst and a Ni electrodes with a sample heater temperature of 133° C. is shown in FIG. 32. The parent peak assignments of hydrino hydride compounds followed by the corresponding fragment peaks appear in TABLE 10.

TABLE 10
The hydrino hydride compounds assigned as parent peaks
with the corresponding fragment peaks of the mass spectrum
m/e = 0-110 of the crystals from a gas discharge cell hydrino hydride
reactor comprising a KI catalyst and a Ni electrodes with a sample
heater temperature of 133° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| HNa₂OH | 64-63; 40; 24-23 |
| NiH₆ | 64-58 |
| LiNiH₆ | 71-65; 58; 8-7 |
| KSiH₆ | 73-67; 32-28; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| NaNiH₆ | 87-81; 58; 24-23 |

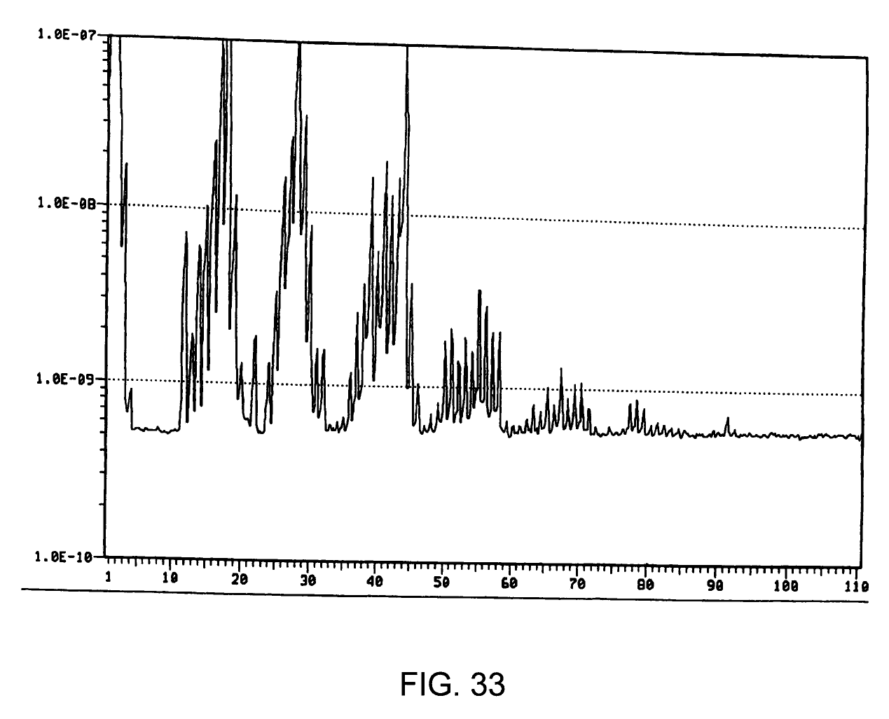

The mass spectrum (m/e=0-110) of the vapors from the crystals from a plasma torch cell hydrino hydride reactor with a sample heater temperature of 375° C. is shown in FIG. 33. The parent peak assignments of hydrino hydride compounds followed by the corresponding fragment peaks appear in TABLE 11.

TABLE 11
The hydrino hydride compounds assigned as parent peaks
with the corresponding fragment peaks of the mass spectrum
m/e = 0-110 of the crystals from a plasma torch cell hydrino hydride
reactor with a sample heater temperature of 375° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| NaH(1/p) | 24-23 |
| ²⁴Mg(H(1/p))₂ | 26-24 |
| ²⁵Mg(H(1/p))₂ | 27-25 |
| ²⁶Mg(H(1/p))₂ | 28-26 |
| (H(1/p))₂S | 34-32 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiAlH₆ | 40-34; 8-7 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaAlH₆ | 56-50; 24-23 |
| NaSiH₆ | 57-51; 32-28; 24-23 |
| Al₂H₄ | 58-54 |
| MgHCl | 60-59; 27-26; 26-25; 25-24 |
| HNa₂OH | 64-63; 40; 24-23 |
| SiO₂H₆ | 66-60 |
| KAlH₆ | 72-66; 43-41; 41-39; 42-41; 40-39 |
| K₂(H(1/p))₂ | 80-78; 43-41; 41-39; 42-41; 40-39 |
| HNa₂Cl | 82-81; 58; 24-23 |
| NaNiH₆ | 87-81; 58; 24-23 |
| LiHNaHCO₃ | 92-91; 84; 68; 24-23; 8-7 |

In some plasma torch samples, the hydrino hydride peaks of NaOHAlClH₂ (series (m/e=102-104)) were observed in addition to the hydrino hydride peaks shown in FIG. 33 having the assignments that appear in TABLE 11. The presence of SiO₂H₆ is consistent with the elemental analysis by XPS which indicated that the plasma torch sample was predominantly SiO₂ as shown in TABLE 16. The source is the quartz of the torch that was etched during operation. Quartz etching was also observed during the operation of the gas cell hydrino hydride reactor.

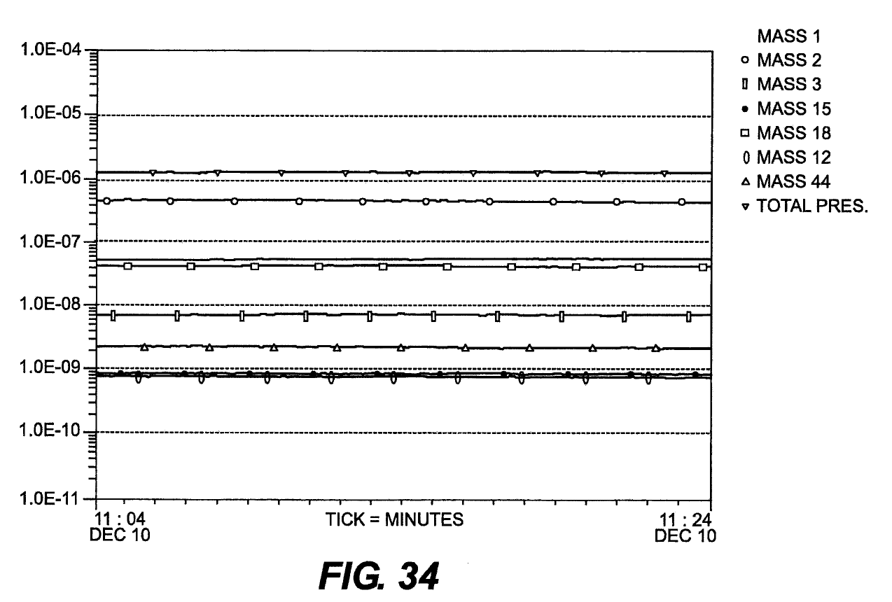

The mass spectrum as a function of time of hydrogen (m/e=2 and (m/e=1), water (m/e=18, m/e=2, and (m/e=1), carbon dioxide (m/e=44 and m/e=12), and hydrocarbon fragment CH₃′ (m/e=15), and carbon (m/e=12) obtained following recording the mass spectra shown in FIGS. 25, 26, 27, 28, 32, and 33 is shown in FIG. 34. The spectra is that of hydrogen where the intensity of the ion current of m/e=2 and m/e=1 is higher than that of m/e=18; even though, no hydrogen was injected into the spectrometer. The source is assigned to compounds comprising hydrino hydride ion(s), hydrino atom(s), dihydrino molecular ion(s), and/or dihydrino molecule(s) as well as normal hydrogen atoms and molecules given in the Additional Compositions Involving Hydrino Hydrides Section.

### Identification of Hydrino Hydride Compounds by XRD

### (X-Ray Diffraction Spectroscopy)

XRD measures the scattering of X-rays by crystal atoms, producing a diffraction pattern that yields information about the structure of the crystal. Known compounds can be identified by their characteristic diffraction pattern. XRD was used to identify the composition of an ionic hydrogen spillover catalytic material: 40% by weight potassium nitrate (KNO₃) on Grafoil with 5% by weight 1%-Pt-on-graphitic carbon before and after hydrogen was supplied to the catalyst, as described at pages 57-62 of the PCT/US96/07949. Calorimetry was performed when hydrogen was supplied to test for catalysis as evidenced by the enthalpy balance. The new product of the reaction was studied using XRD. XRD was also obtained on crystals grown on the stored cathode and isolated from the electrolyte of the K₂CO₃ electrolytic cell described in the Crystal Samples from an Electrolytic Cell Section.

### A. Experimental Methods

a. Spillover Catalyst Sample

Catalysis was confirmed by calorimetry. The enthalpy released by catalysis (heat of formation) was determined from flowing hydrogen in the presence of ionic hydrogen spillover catalytic material: 40% by weight potassium nitrate (KNO₃) on Grafoil with 5% by weight 1%-Pt-on-graphitic carbon by heat measurement, i.e., thermopile conversion of heat into an electrical output signal or Calvet calorimetry. Steady state enthalpy of reaction of greater than 1.5 W was observed with flowing hydrogen over 20 cc of catalyst. However, no enthalpy was observed with flowing helium over the catalyst mixture. Enthalpy rates were reproducibly observed which were higher than that expected from reacting of all the hydrogen entering the cell to water, and the total energy balance observed was over 8 times greater than that expected if all the catalytic material in the cell were converted to the lowest energy state by “known” chemical reactions. Following the run, the catalytic material was removed from the cell and was exposed to air. XRD was rd performed before and after the run.

b. Electrolytic Cell Samples

Hydrino hydride was prepared during the electrolysis of an aqueous solution of K₂CO₃ corresponding to the transition catalyst K⁺/K⁺. The cell description is given in the Crystal Samples from an Electrolytic Cell Section. The cell assembly is shown in FIG. 2. The crystals were obtained from the cathode or from the electrolyte:

Sample #1A. The cathode of the K₂CO₃ electrolytic cell described in the Crystal Samples from an Electrolytic Cell Section that produced 6.3×10⁸ J of enthalpy of formation of hydrino hydride was removed from the cell without rinsing and stored in a plastic bag for one year. White-green crystals were collected physically from the nickel wire. Elemental analysis, XPS, mass spectroscopy, and XRD were performed.

Sample #1B. The cathode of a K₂CO₃ electrolytic cell run at Idaho National Engineering Laboratories (INEL) for 6 months that was identical to that of Sample #1A was placed in 28 liters of 0.6M K₂CO₃/10% H₂O₂. A violent exothermic reaction occurred which caused the solution to boil for over one hour. An aliquot of the solution was concentrated ten fold with a rotary evaporator at 50° C. A precipitate formed on standing at room temperature. The crystals were filtered, and XRD was performed.

Samples #2 and #3. Thermacore, Inc. operated a K₂CO₃ electrolytic cell hydrino hydride reactor for 15 months [R. Mills, W. Good, and R. Shaubach, Fusion Technol. 25, 103 (1994)] whereby the 1.6×10⁹ J of enthalpy of formation of hydrino hydride exceeded the total input enthalpy given by the product of the electrolysis voltage and current over time by a factor greater than 8. The sample was prepared by 1.) acidifying the K₂CO₃ electrolyte with HNO₃, 2.) concentrating the acidified solution to a volume of 10 cc, 3.) placing to concentrated solution on a crystallization dish, and 4.) allowing crystals to form slowly upon ml standing at room temperature. Yellow-white crystals formed on the w outer edge of the crystallization dish (the yellow color may be due to the—continuum absorption of H⁻(n=½) in the near UV, 407 nm continuum). These crystals comprised Sample #2. Clear needles formed in the center. These crystals comprised Sample #3. The crystals were separated carefully, but some contamination of Sample #3 with Sample #2 crystals probably occurred to a minor extent.

Sample #4. The K₂CO₃ electrolyte from the cell described herein that produced 6.3×10⁸ J of enthalpy of formation of hydrino hydride was made 1M in LiNO₃ and acidified with HNO₃. The solution was dried and heated to a melt at 120° C. whereby NiO formed. The solidified melt was dissolved in H₂O, and the NiO was removed by filtration. The solution was concentrated until crystals just appeared at 50° C. White crystals formed from the solution standing at room temperature. The crystals were obtained by filtration, and further purified from KNO₃ by recrystallizing with distilled water.

c. Gas Cell Sample.

Sample #5. Hydrino hydride was prepared in a vapor phase gas cell with a tungsten filament and KI as the catalyst. The high temperature gas cell shown in FIG. 4 was used to produce hydrino hydride compounds wherein hydrino atoms are formed from the transition reaction using potassium ions and hydrogen atoms in the gas phase as described for the Gas Cell Sample of the Identification of Hydrino Hydride Compounds by Mass Spectroscopy Section. The sample was prepared by 1.) rinsing the hydrino hydride from the cap of the cell where it was preferentially cryopumped with sufficient water that all water soluble compounds dissolved, 2.) filtering the solution to remove water insoluble compounds such as metal, 3.) concentrating the solution until a precipitate just formed with the solution at 50° C., 4.) allowing yellowish-reddish-brown crystals to form on standing at room temperature in the near UV, 407 nm continuum), 4.) filtering and drying the crystals before XPS, mass spectra, and XRD were obtained.

### B. Results and Discussion

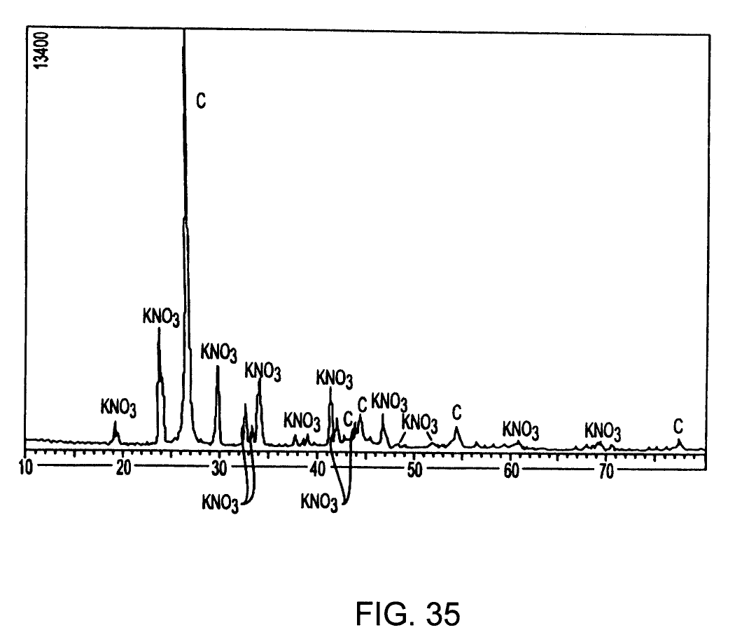

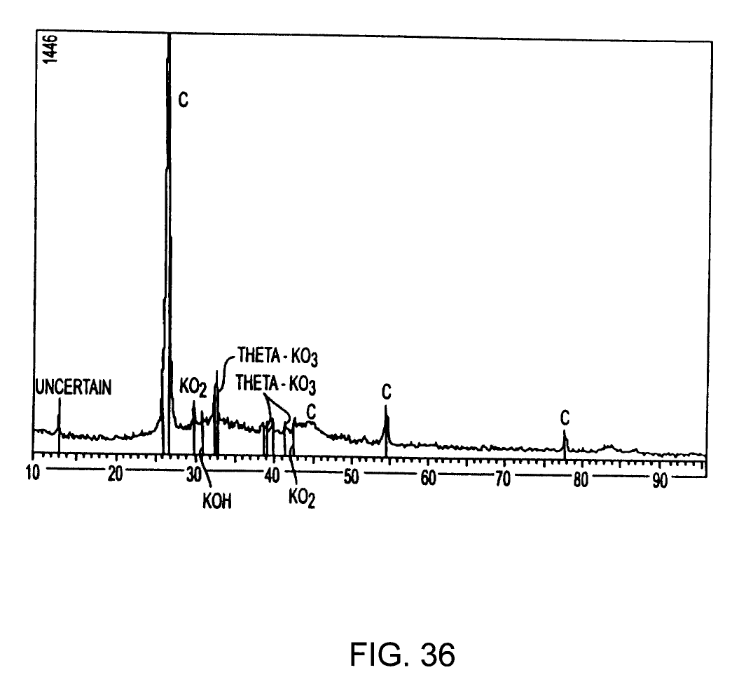

The XRD patterns of the spillover catalyst samples were obtained at Pennsylvania State University. The XRD pattern before supplying hydrogen to the spillover catalyst is shown in FIG. 35. All the peaks are identifiable and correspond to the starting catalyst material. The XRD pattern following the catalysis of hydrogen is shown in FIG. 36. The identified peaks correspond to the known reaction products of potassium metal with oxygen as well as the known peaks of carbon. In addition, a novel, unidentified peak was reproducibly observed. The novel peak without identifying assignment at 13°2Θ corresponds and identifies potassium hydrino hydride, and according to the present invention.

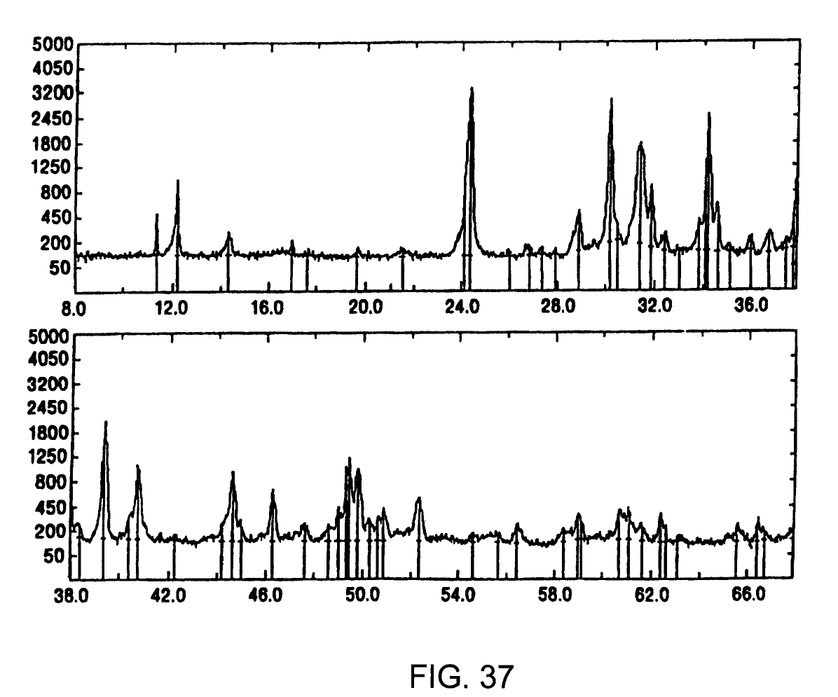

The XRD pattern of the crystals from the stored nickel cathode of the K₂CO₃ electrolytic cell hydrino hydride reactor (sample #1A) was obtained at IC Laboratories and is shown in FIG. 37. The identifiable peaks corresponded to KHCO₃. In addition, the spectrum contained a number of unidentified peaks. The 2-theta and d-spacings of the unidentified XRD peaks of the crystals from the cathode of the K₂CO₃ electrolytic cell hydrino hydride reactor are given in TABLE 12. The novel peaks without identifying assignment given in TABLE 12 corresponds and identifies hydrino hydride, according to the present invention.

In addition, the elemental analysis of the crystals was obtained at Galbraith Laboratories. It was consistent with the sample comprising KHCO₃, but the atomic hydrogen percentage was 30% in excess. The mass spectrum was similar to that of the crystals from the electrolyte of the electrolytic cell hydrino hydride reactor that was made 1M in and acidified with HNO₃ shown in FIG. 25. The XPS contained hydrino hydride peaks H⁻(n=1/p) for p=2 to p=16 that were partially masked by the dominant spectrum of KHCO₃. These results are consistent with the production of KHCO₃ and hydrino hydride compounds from K₂CO₃ by the formation of hydrinos by the K₂CO₃ electrolytic cell hydrino hydride reactor and the reaction of hydrinos with water (Eqs. (50-52).

TABLE 12
The 2-theta and d-spacings of the unidentified XRD peaks of
the crystals from the cathode of the K₂CO₃ electrolytic cell hydrino
hydride reactor (sample #1A).

| | 2-Theta | d |
|---|---|---|
| Peak Number | (Deg) | (Å) |
| 1 | 11.36 | 7.7860 |
| 3 | 14.30 | 6.1939 |
| 4 | 16.96 | 5.2295 |
| 5 | 17.62 | 5.0322 |
| 6 | 19.65 | 4.5168 |
| 7 | 21.51 | 4.1303 |
| 10 | 26.04 | 3.4226 |
| 11 | 26.83 | 3.3230 |
| 12 | 27.34 | 3.2621 |
| 13 | 27.92 | 3.1957 |
| 19 | 32.43 | 2.7612 |
| 26 | 35.98 | 2.4961 |
| 27 | 36.79 | 2.4433 |
| 33 | 40.41 | 2.2319 |
| 36 | 44.18 | 2.0502 |
| 39 | 46.28 | 1.9618 |
| 40 | 47.60 | 1.9104 |

For sample #1B, the XRD pattern corresponded to identifiable peaks of KHCO₃. In addition, the spectrum contained unidentified peaks at 2-theta values and d-spacings given in TABLE 13. The novel peaks of TABLE 13 without identifying assignment corresponds and identifies hydrino hydride that formed during the reaction with 0.6M K₂CO₃/10% H₂O₂, according to the present invention.

TABLE 13
The 2-theta and d-spacings of the unidentified XRD peaks of
the crystals isolated following reaction of the cathode of the INEL K₂CO₃
electrolytic cell with 0.6M K₂CO₃/10% H₂O₂ (sample #1B).

| 2-Theta | d |
|---|---|
| (Deg) | (Å) |
| 12.9 | 6.852 |
| 30.5 | 2.930 |
| 35.9 | 2.501 |

For sample #2, the XRD pattern corresponded to identifiable peaks of KNO₃. In addition, the spectrum contained unidentified peaks at 2-theta values and d-spacings given in TABLE 14. The novel peaks of TABLE 14 without identifying assignment corresponds and identifies hydrino hydride, according to the present invention. The assignment of hydrino hydride was confirmed by the XPS of these crystals shown in FIG. 21.

TABLE 14
The 2-theta and d-spacings of the unidentified XRD peaks of
the yellow-white crystals that formed on the outer edge of a
crystallization dish from the acidified electrolyte of the K₂CO₃ electrolytic
cell operated by Thermacore, Inc. that produced 1.6 × 10⁹ J of enthalpy of
formation of hydrino hydride (sample #2).

| 2-Theta | d |
|---|---|
| (Deg) | (Å) |
| 20.2 | 4.396 |
| 22.0 | 4.033 |
| 24.4 | 3.642 |
| 26.3 | 3.391 |
| 27.6 | 3.232 |
| 30.9 | 2.894 |
| 31.8 | 2.795 |
| 39.0 | 2.307 |
| 42.6 | 2.124 |
| 48.0 | 1.897 |

For sample #3, the XRD pattern corresponded to identifiable peaks of KNO₃. In addition, the spectrum contained very small unidentified peaks at 2-theta values of 20.2 and 22.0 which were attributed to minor contamination with crystals of sample #2. An XPS was obtained which was consistent with KNO₃.

For sample #4, the XRD pattern corresponded to identifiable peaks of KNO₃. In addition, the spectrum contained unidentified peaks at a 2-theta value of 40.3 and d-spacing of 2.237 and at a 2-theta value of 62.5 and d-spacing of 1.485. The novel peaks without identifying assignment corresponds and identifies hydrino hydride, according to the present invention. The assignment of hydrino hydride was confirmed by the XPS. The spectrum obtained of these crystals had the same hydrino hydride peaks as that shown in FIG. 19. Also, mass spectroscopy was performed by the method given in the Identification of Hydrino Hydride Compounds by Mass Spectroscopy Section. The mass ranges m/e=1 to 220 and m/e=1 to 120 were scanned. No peaks were observed at m/e>114. The mass spectrum was equivalent to that of the crystals from the electrolyte of the K₂CO₃ electrolytic cell that was made 1M in LiNO₃ and acidified with HNO₃ (shown in FIG. 25 with parent peak identifications shown in TABLE 4) except that the following new hydrino hydride peaks were present: K₂SiH₈ series (m/e=106-114), Si₂H₈ (m/e=64), SiH₈ (m/e=36), SiH₂ (m/e=30), and LiHNaNO₃ (m/e=93) in addition to the peak of LiHNaHCO₃ (m/e=92).

For sample #5, the XRD spectrum contained a broad peak with a maximum at a 2-theta value of 21.291 and d-spacing of 4.1699 and one sharp intense peak at a 2-theta value of 29.479 and d-spacing of 3.0277. The novel peaks without identifying assignment corresponds and identifies hydrino hydride, according to the present invention. The assignment of hydrino hydride was confirmed by the XPS. The origin of the yellowish-reddish-brown color of the crystals is assigned to the continuum absorption of H⁻(n=½) in the near UV, 407 nm continuum. This assignment is supported by the XPS results which showed a large peak at the binding energy of H⁻(n=½), 3 eV (TABLE 1). Also, mass spectroscopy was performed as given in the Identification of Hydrino Hydride Compounds by Mass Spectroscopy Section. Mass spectra appear in FIGS. 30 and 31, and the peak assignments are give in TABLE 8 and 9, respectively. Hydrino hydride compounds were observed.

Identification of Hydrino Hydride Compounds and Dihydrino by Gas Chromatography with Calorimetry of the Decomposition of Hydrino Hydride Compounds

Compounds comprising hydrino hydride ion(s), hydrino atom(s), dihydrino molecular ion(s), and/or dihydrino molecule(s) as well as normal hydrogen atoms and molecules are given in the Additional Compositions Involving Hydrino Hydrides Section. It was observed that NiO formed and precipitated out over time from the filtered electrolyte (Whatman 110 mm filter paper (Cat. No. 1450 110)) of the K₂CO₃ electrolytic cell described in the Identification of Hydrinos, Dihydrinos, and Hydrino Hydrides by XPS (X-ray Photoelectron Spectroscopy) Section. The XPS contains nickel as shown in FIG. 18, and the crystals isolated from the electrolyte of the K₂CO₃ electrolytic cell contained compounds such as NiH₆ and KNiH₆. Since Ni(OH)₂ and NiCO₃ are extremely insoluble in a solution with a measured pH of 9.85, the source of the NiO from a soluble nickel compound is likely the decomposition of compounds such as NiH₆ and KNiH₆ to NiO. This was tested by adding an equal atomic percent LiNO₃ and acidifying the electrolyte with HNO₃ to form potassium nitrate. The solution was dried and heated to a melt at 120° C. whereby NiO formed. The solidified melt was dissolved in H₂O, and the NiO was removed by filtration. The solution was concentrated until crystals just appeared at 50° C. White crystals formed from the solution standing at room temperature. The crystals were obtained by filtration. The crystals were recrystallized with distilled water, and mass spectroscopy was performed by the method given in the Identification of Hydrino Hydride Compounds by Mass Spectroscopy Section. The mass ranges m/e=1 to 220 and m/e=1 to 120 were scanned. No peaks were observed at m/e>114. The mass spectrum was equivalent to that of the crystals from the electrolyte of the K₂CO₃ electrolytic cell that was made 1M in LiNO₃ and acidified with HNO₃ (shown in FIG. 25 with parent peak identifications shown in TABLE 4) except that the following new hydrino hydride peaks were present: K₂SiH₈ series (m/e=106-114), SiH₈ (m/e=64), SiH₈ (m/e=36), SiH₂ (m/e=30), and LiHNaNO₃ (m/e=93) in addition to the peak of LiHNaHCO₃ (m/e=92). In addition, X-ray diffraction of these crystals showed peaks that could not be assigned to known compounds as given in the Identification of Hydrino Hydride Compounds by XRD Section (Sample #4).

Aluminum analogues of NiH₆ are produced in the plasma torch as shown in FIG. 33. These are expected to decomposed under appropriate conditions and hydrogen may be released from these hydrogen containing hydrino hydride compounds. The ortho and para forms of molecular hydrogen can readily be separated by chromatography at low temperatures which with its characteristic retention time is a definitive means of identifying the presence of hydrogen in a sample. The possibility of releasing dihydrino molecules by thermally decomposing hydrino hydride compounds with identification by gas chromatography was explored.

Dihydrino molecules may be synthesized according to Eq. (32) by the reaction of a proton with a hydrino atom. A gas discharge cell is a source of ionized hydrogen atoms (protons) and a source of hydrino atoms. The catalysis of hydrogen atoms occurs in the gas phase with a catalyst that is volatilized from the electrodes by the hot plasma current. Gas phase hydrogen atoms are also generated with the discharge. Thus, the possibility of synthesizing dihydrino in a gas discharge cell with identification by gas chromatography was explored.

Lower-energy hydrogen has an internuclear distance which is fractional

$$( \frac{1}{integer} )$$

compared with that of normal hydrogen. The ortho and para forms of molecular hydrogen can readily be separated by chromatography at low temperatures. The possibility of using gas chromatography at cryogenic temperatures to discriminate ortho and para H_{2[}2c′=\sqrt{2}aₒ] from ortho and para

$${H}_{2}^{⋆} [ 2 {c}^{′} = \frac{\sqrt{2} {a}_{o}}{p} ] ,$$

respectively, as well as other dihydrino molecules on the basis of the difference in sizes of hydrogen versus dihydrino was explored.

### A. Gas Chromatography Methods

Gas samples were analyzed with a Hewlett Packard 5890 Series II gas chromatograph equipped with a thermal conductivity detector and a 60 meter, 0.32 mm ID fused silica Rt-Alumina PLOT column (Restek, Bellefonte, Pa.). The column was conditioned at 200° C. for 18-72 hours before each series of runs. Samples were run at −196° C. using Ne as the carrier gas.

The 60 meter column was run with the carrier gas at. 3.4 psi with the following flow rates: carrier—2.0 ml/min., auxiliary—3.4 ml/min., and reference—3.5 ml/min., for a total flow rate of 8.9 ml/min. The split rate was 10.0 ml/min.

a. Control Sample

The control hydrogen gas was ultrahigh purity (MG Industries).

b. Plasma Torch Sample

Hydrino hydride was generated in the plasma torch hydrino hydride reactor with a KI catalyst by the method described in the Plasma Torch Sample Section. A 10 mg sample was placed in a 4 mm ID by 25 mm long quartz tube that was sealed at one end and connected at the open end with Swagelock™ fittings to a T that was connected to a Welch Duo Seal model 1402 mechanical vacuum pump and a septum port. The apparatus was evacuated to between 25 and 50 millitorr. Hydrogen was generated by thermally decomposing hydrino hydride. The heating was performed in the evacuated quartz chamber containing the sample with an external Nichrome wire heater. The sample was heated in 100° C. increments by varying the transformer voltage of the Nichrome heater. Gas released from the sample was collected with a 500 μl gas tight syringe through the septum port and immediately injected into the gas chromatograph.

c. Coated Cathode Sample

Dihydrino molecules were generated in an evacuated chamber via thermally decomposing hydrino hydride compounds. The source of hydrino hydride compounds was the coating from a 0.5 mm diameter nickel wire from a K₂CO₃ electrolytic cell that produced 6.3×10⁸ J of enthalpy of formation of hydrino hydride. The wire was dried and heated to about 800° C. The heating was performed in an evacuated quartz chamber by passing a current through the cathode. Samples were taken and analyzed by gas chromatography.

A 60 meter long nickel wire cathode from a potassium carbonate electrolytic cell was coiled around a 7 mm OD, 30 cm long hollow quartz tube and inserted into a 40 cm long, 12 mm OD quartz tube. The larger quartz tube was sealed at both ends with Swagelock™ fittings and connected to a Welch Duo Seal model 1402 mechanical vacuum pump with a stainless steel Nupro™ “H” series bellows valve. A thermocouple vacuum gauge tube and rubber septum were installed on the apparatus side of the pump. The nickel wire cathode was connected to leads through the Swagelock™ fittings to a 220V AC transformer. The apparatus containing the nickel wire was evacuated to between 25 and 50 millitorr. The wire was heated to a range of temperatures by varying the transformer voltage. Gas released from the heated wire was collected with a 500 μl gas tight syringe through the installed septum port and immediately injected into the gas chromatograph. White hydrino hydride crystals which did not thermally decompose were cryopumped to the cool ends of the evacuated tube.

d. Gas Discharge Cell Sample

The transition reaction occurred in the gas phase with the catalyst KI that was volatilized from the electrodes by the hot plasma current. Gas phase hydrogen atoms were generated with the discharge. Dihydrino molecules were synthesized using the discharge cell described in the Discharge Cell Sample Section by: (1) putting the catalyst solution inside the lamp and drying it to form a coating on the electrodes; (2) vacuuming the system at 10-30 mtorr for several hours to remove contaminant gases and residual solvent; (3) filling the discharge tube with a few torr hydrogen and carrying out an arc discharge for at least 0.5 hour. The chromatographic column was submerged in liquid nitrogen and connected to the thermal conductivity detector of the gas chromatograph. The gases flowed through a 100% CuO recombiner and were analyzed by the on-line gas chromatography using a three way valve.

### B. Adiabatic Calorimetry Methods

The enthalpy of the decomposition reaction of the coated cathode sample was measured with an adiabatic calorimeter comprising the decomposition apparatus described above that was suspended in an insulated vessel containing 12 liters of distilled water. The temperature rise of the water was used to determine the enthalpy of the decomposition reaction. The water was stabilized for one hour at room temperature before each experiment. Continuous paddle stirring was set at a predetermined rpm to eliminate temperature gradients in the water without input of measurable energy. The temperature of the water was measured by two type K thermocouples. The cold junction temperature was utilized to monitor room temperature changes. Data points were taken every tenth of a second, averaged every ten seconds, and recorded with a computer DAS. The experiment was run with a wire temperature of 800° C. determined by a resistance measurement that was confirmed by optical pyrometry. For the control cases, 600 watts of electrical input power was typically necessary to maintain the wire at this temperature.

The input power to the filament was recorded over time with a Clarke Hess volt-amp-watt meter with analog output to the computer DAS. The power balance for the calorimeter was:

0=Pᵢₙₚᵤₜ−(mCₚdT/dt+Pₗₒₛₛ−PD) (53)

where Pᵢₙₚᵤₜ was the input power measured by the watt meter, m was the mass of the water (12,000 g), Cₚ is the specific heat of water (4.184 J/g ° C.), dT/dt was the rate of change in water temperature, Pₗₒₛₛ was the power loss of the water reservoir to the surroundings (deviation from adiabatic) which was measured to be negligible over the temperature range of the tests, and PD was the power released from the hydrino hydride compound decomposition reaction.

The rise in temperature was plotted versus the total input enthalpy. Using 12,000 grams as the mass of the water and using the specific heat of water of 4.184 J/g ° C., the theoretical slope was 0.020° C./kJ. For the experiment, an unrinsed 60 meter long nickel wire cathode from the potassium carbonate electrolytic cell that produced 6.3×10⁸ J of enthalpy of formation of hydrino hydride was used Controls comprised hydrogen gas hydrided nickel wire (NI 200 0.0197″, HTN36NOAG1, A1 Wire Tech, Inc.), and cathode wires from an identical Na₂CO₃ electrolytic cell.

### C. Enthalpy of the Decomposition Reaction of Hydrino Hydride Compounds and Gas Chromatography Results

a. Enthalpy Measurement Results

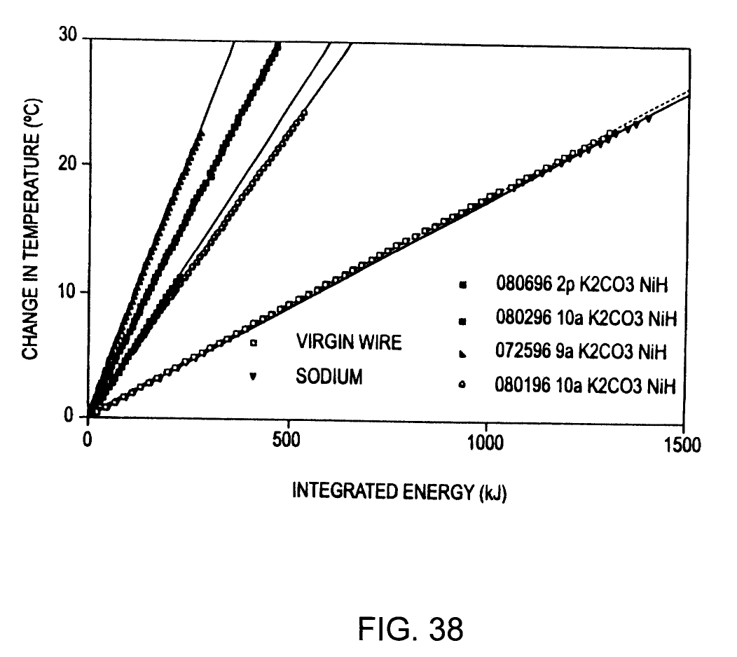

The results of the measurement of the enthalpy of the decomposition reaction of hydrino hydride compounds measured with the adiabatic calorimeter are shown in FIG. 38 and TABLE 15. The wires from the Na₂CO₃ electrolytic cell and the hydrided virgin nickel wires produced slopes of water temperature rise versus integrated input enthalpy that were identical to the theoretical slope (0.020° C./kJ). Each wire cathode from the K₂CO₃ cell produced a result that deviated substantially from the theoretical slope, and much less input power was necessary to maintain the wire at 800° C. as shown in TABLE 15. The results indicate that the decomposition reaction of hydrino hydride compounds is very exothermic. In the best case, the enthalpy was 1 MJ (25° C.×12,000 g×4.184 J/g° C.-250 kJ) released over 30 minutes (25° C.×12,000 g×4.184 J/g° C./693 W).

TABLE 15
The results of the measurement of the enthalpy of the decomposition
reaction of hydrino hydride compounds using an adiabatic
calorimeter with virgin nickel wires and cathodes from a Na₂CO₃
electrolytic cell and a K₂CO₃ electrolytic cell that produced 6.3 × 10⁸ J
of enthalpy of formation of hydrino hydride.

| | | | |
|---|---|---|---|
| | | | Average |
| | Input Power | Slope | Slope |
| trial | (W) | (° C./kJ) | (° C./kJ) |

Virgin Wire Control

| | | | |
|---|---|---|---|
| 1 | 151 | 0.017 | 0.017 |
| 2 | 345 | 0.018 | |
| 3 | 452 | 0.017 | |
| 4 | 100 | 0.017 | |

Sodium Carbonate Control

| | | | |
|---|---|---|---|
| 1 | 354 | 0.020 | 0.018 |
| 2 | 272 | 0.016 | |
| 3 | 288 | 0.017 | |
| 4a | 100 | 0.017 | |
| 4b | 100 | 0.018 | |

Potassium Carbonate

| | | | Average | Output | |
|---|---|---|---|---|---|
| | Input Power | Slope | Slope | Power | P_{D} |
| trial | (W) | (° C./kJ) | (° C./kJ) | (W) | (W) |
| 1a | 152 | 0.082 | 0.066 | 693 | 541 |
| 1b | 172 | 0.074 | | 706 | 534 |
| 2 | 186 | 0.045 | | 464 | 278 |
| 3 | 182 | 0.050 | | 503 | 321 |
| 4 | 138 | 0.081 | | 622 | 484 |
| 5a | 103 | 0.062 | | 357 | 254 |
| 5b | 92 | 0.064 | | 327 | 235 |
| 5c | 99 | 0.094 | | 517 | 418 |

b. Gas Chromatography Results

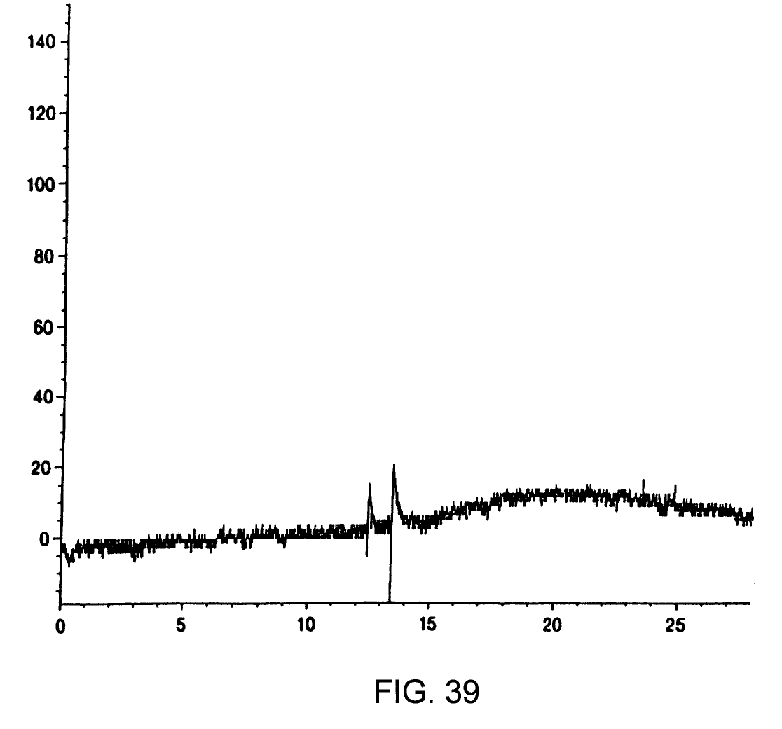

The gas chromatograph of the normal hydrogen gave the retention time for para hydrogen and ortho hydrogen as 12.5 minutes and 13.5 minutes, respectively. For the plasma torch sample collected from the hydrino hydride trap (filter paper), the gas chromatographic analysis of gasses released by heating in 100° C. increments in the temperature range 100° C. to 900° C. showed no hydrogen release at any temperature. For the plasma torch sample collected from the torch manifold, the gas chromatographic analysis of gasses released by heating in 100° C. increments in the temperature range 100° C. to 900° C. showed hydrogen release at 400° C. and 500° C. The gas chromatograph of the gases released from the sample collected from the plasma torch manifold when the sample was heated to 400° C. is shown in FIG. 39. The elemental analysis of the plasma torch samples were determined by EDS and XPS. The concentration of elements detected by XPS in atomic percent is shown in TABLE 16.

TABLE 16
Concentration of Elements Detected by XPS (in Atomic %).

| Sample | Na | I | O | C | Cl | Si | Al | K | Mg | K/I |
|---|---|---|---|---|---|---|---|---|---|---|
| Manifold | 1.1 | 0.4 | 61.3 | 6.4 | 0.5 | 28.2 | 0.1 | 2.0 | 0.1 | 5 |
| Filter Paper | 0.2 | 2.3 | 60.0 | 6.0 | 0.1 | 28.5 | 0.1 | 2.8 | 0.1 | 1.2 |
| KI | 3.4 | 23.1 | 8.8 | 34.3 | 1.7 | 0.0 | 0.0 | 28.6 | 0.1 | 1.2 |

The XPS of the sample collected from the torch manifold was remarkable in that the potassium to iodide ratio was five; whereas, the ratio was 1.2 for KI and 1.2 for sample collected from the hydrino hydride trap (filter paper). The EDS and XPS of the sample collected from the torch manifold indicated an elemental composition of predominantly SiO₂ and KI with small amounts of aluminum, silicon, sodium, and magnesium. The mass spectrum of the sample collected from the torch manifold is shown in FIG. 33 which demonstrates hydrino hydride compounds consistent with the elemental composition. None of the elements identified are known to store and release hydrogen in the temperature range of 400-500° C. These data indicate that the crystals from the plasma torch contain hydrogen and are fundamentally different from previously known compounds. These results are consistent with the identification of the compounds as comprising hydrino hydride.

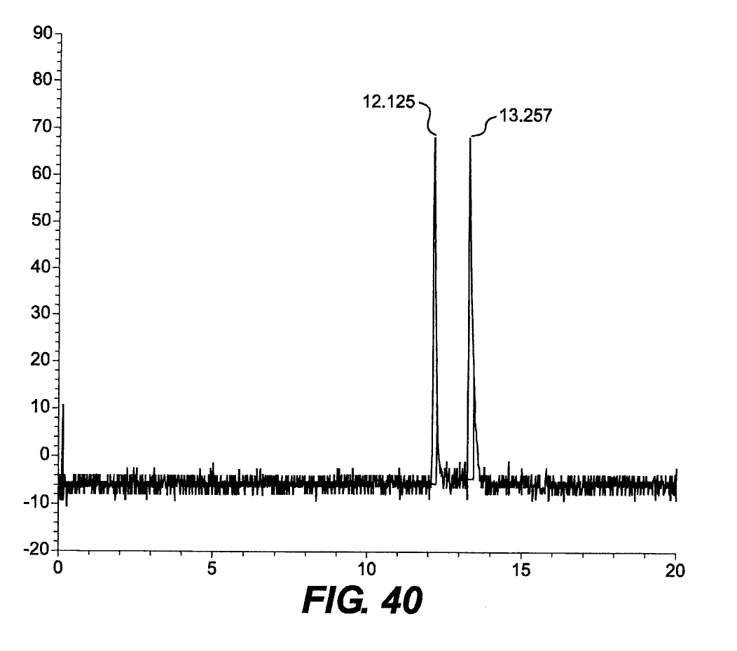

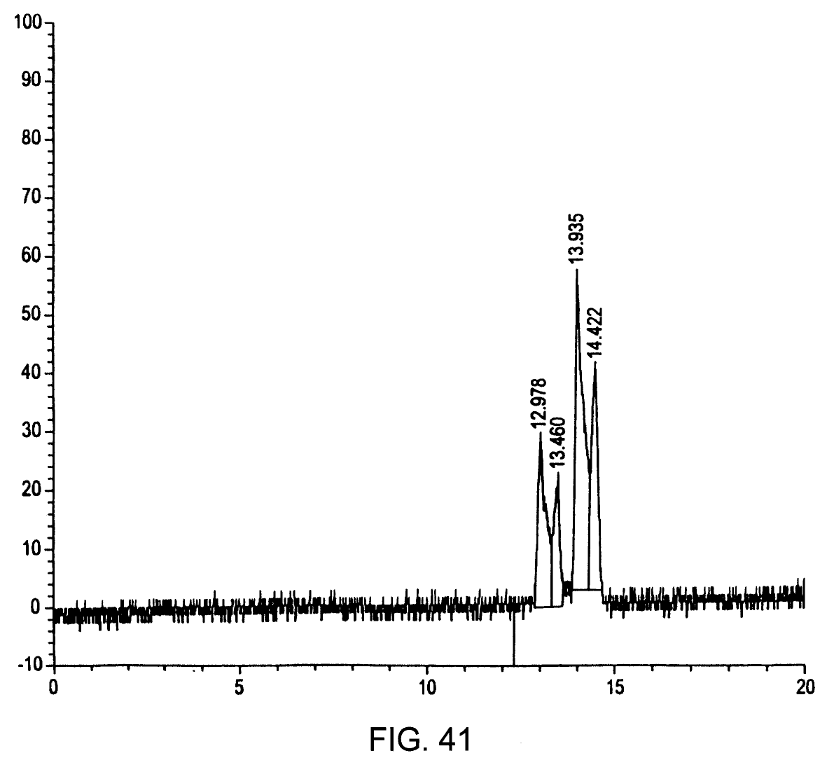

The gas chromatographic analysis (60 meter column) of high purity hydrogen is shown in FIG. 40. The results of the gas chromatographic analysis of the heated nickel wire cathode appear in FIG. 41. The results indicate that a new form of hydrogen molecule was detected based on the presence of peaks with migration times comparable but distinctly different from those of the normal hydrogen peaks.

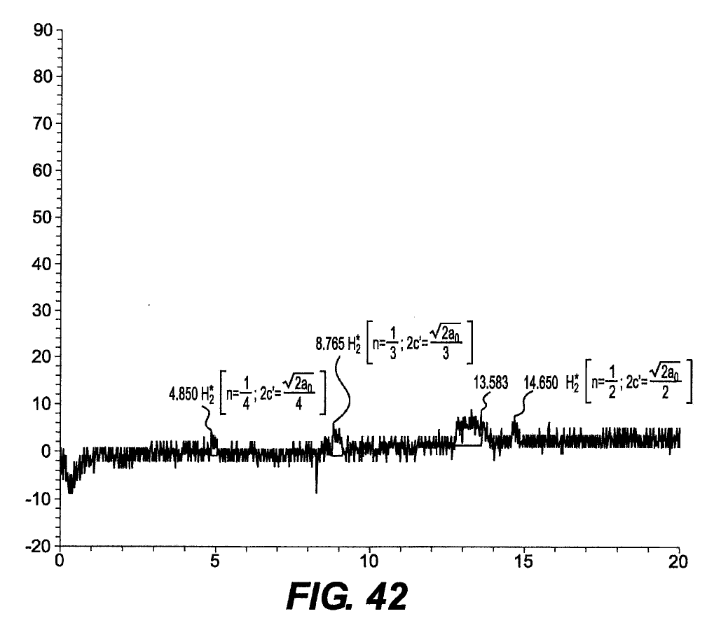

FIG. 42 shows peaks assigned to

$${H}_{2}^{⋆} [ 2 {c}^{′} = \frac{\sqrt{2} {a}_{o}}{2} ] , {H}_{2}^{⋆} [ 2 {c}^{′} = \frac{\sqrt{2} {a}_{o}}{3} ] , and {H}_{2}^{⋆} [ 2 {c}^{′} = \frac{\sqrt{2} {a}_{o}}{3} ] .$$

The results indicate that new forms of hydrogen molecules were detected based on the presence of peaks that did not react with the recombiner with migration times distinctly different from those of the normal hydrogen peaks. Control hydrogen run (FIG. 40) before and after the result shown in FIG. 42 showed no peaks due to recombination by the 100% CuO recombiner.

### D. Discussion

In addition to calorimetry of the decomposition reaction, other tests confirm novel hydrogen chemistry. The cathode of the K₂CO₃ electrolytic cell described in the Crystal Samples from an Electrolytic Cell Section that produced 6.3×10⁸ J of enthalpy of formation of hydrino hydride was removed from the cell without rinsing and stored in a plastic bag for one year. White-green crystals were collected physically from the nickel wire. Elemental analysis, XPS, mass spectroscopy, and XRD were performed. The elemental analysis is discussed in the Identification of Hydrino Hydride Compounds by Mass Spectroscopy Section. The results were consistent with the reaction given by Eqs. (50-52). The XPS results indicated the presence of hydrino hydride. The mass spectrum was similar to that of the crystals from the electrolyte of the K₂CO₃ electrolytic cell hydrino hydride reactor that was made 1M in LiNO₃ and acidified with HNO₃ shown in FIG. 25. Hydrino hydride compounds were observed. Peaks were observed in the X-ray diffraction pattern which could not be assigned to any known compound as shown in the Identification of Hydrino Hydride Compounds by XRD (X-ray Diffraction Spectroscopy) Section. Heat and dihydrino were observed by thermal decomposition with calorimetry and gas chromatography studies, respectively, as shown herein. In addition, Thermacore, Inc. operated an identical K₂CO₃ electrolytic cell hydrino hydride reactor (except that it had an additional central cathode) for 15 months [R. Mills, W. Good, and R. Shaubach, Fusion Technol. 25, 103 (1994)] whereby the 1.6×10⁹ J of enthalpy of formation of hydrino hydride exceeded the total input enthalpy given by the product of the electrolysis voltage and current over time by a factor greater than 8. Nickel wire form the cathode was reacted with a 0.6 M K₂CO₃/3% H₂O₂ solution. The reaction was violent and strongly exothermic. These results confirm the formation of hydrino hydride compounds and indicate their potential as solid fuels.

Identification of Hydrino. Hydrino Hydride Compounds, and Dihydrino Molecular Ion Formation by Extreme Ultraviolet Spectroscopy

The catalysis of hydrogen was detected by the extreme ultraviolet (EUV) emission (912 Å) from transitions of hydrogen atoms to form hydrino. The principle reactions of interest are given by Eqs. (4-6). The corresponding extreme UV photon is:

$$H [ \frac{{a}_{H}}{1} ] {}^{{K}^{+} / {K}^{+}} H [ \frac{{a}_{H}}{2} ] + 912 Å \qquad ( 54 )$$

Hydrinos can act as a catalyst because the excitation and/or ionization energies are m×27.2 eV (Eq. (3)). For example, the equation for the absorption of 27.21 eV, m=1 in Eq. (3), during the catalysis of

$$H [ \frac{{a}_{H}}{2} ]$$

by the hydrino

$$H [ \frac{{a}_{H}}{2} ]$$

that is ionized is

$$\begin{matrix}27.21 eV + H [ \frac{{a}_{H}}{2} ] + H [ \frac{{a}_{H}}{2} ] \to {H}^{+} + {e}^{-} + H [ \frac{{a}_{H}}{3} ] + [ {3}^{2} - {2}^{2} ] \times 13.6 eV - 27.21 eV & ( 55 ) \\ {H}^{+} + {e}^{-} \to H [ \frac{{a}_{H}}{1} ] + 13.6 eV & ( 56 )\end{matrix}$$

And, the overall reaction is

$$H [ \frac{{a}_{H}}{2} ] + H [ \frac{{a}_{H}}{2} ] \to H [ \frac{{a}_{H}}{1} ] + H [ \frac{{a}_{H}}{3} ] + [ {3}^{2} - {2}^{2} - 4 ] \times 13.6 eV + 13.6 eV \qquad ( 57 )$$

The corresponding extreme UV photon is:

$$H [ \frac{{a}_{H}}{2} ] {}^{H [ \frac{{a}_{H}}{2} ]} H [ \frac{{a}_{H}}{3} ] + 912 Å \qquad ( 58 )$$

The same transition can also be catalyzed by potassium ions

$$H [ \frac{{a}_{H}}{2} ] {}^{{K}^{+} / {K}^{+}} H [ \frac{{a}_{H}}{3} ] + 912 Å \qquad ( 59 )$$

The reaction of a proton with the hydrino atom to form the dihydrino molecular ion H₂*[2c′=aₒ] according to the first stage of the reaction given by Eq. (32) was detected by EUV spectroscopy. The corresponding extreme UV photon corresponding to the reaction of hydrino atom

$$H ( \frac{1}{p} )$$

with a proton is:

$$H [ \frac{{a}_{H}}{p} ] + {H}^{+} \to {{H}_{2}^{⋆} [ 2 {c}^{′} = \frac{2 {a}_{o}}{p} ]}^{+} + hv ( 120 nm ) \qquad ( 60 )$$

The emission of the dihydrino molecular ion may be split due to coupling with rotational transitions. The rotational wavelength including vibration given in the Vibration of Hydrogen—Type Molecular Ions Section of '96 Mills GUT is

$$λ = \frac{169}{{n}^{2} [ J + 1 ]} μm \qquad ( 61 )$$

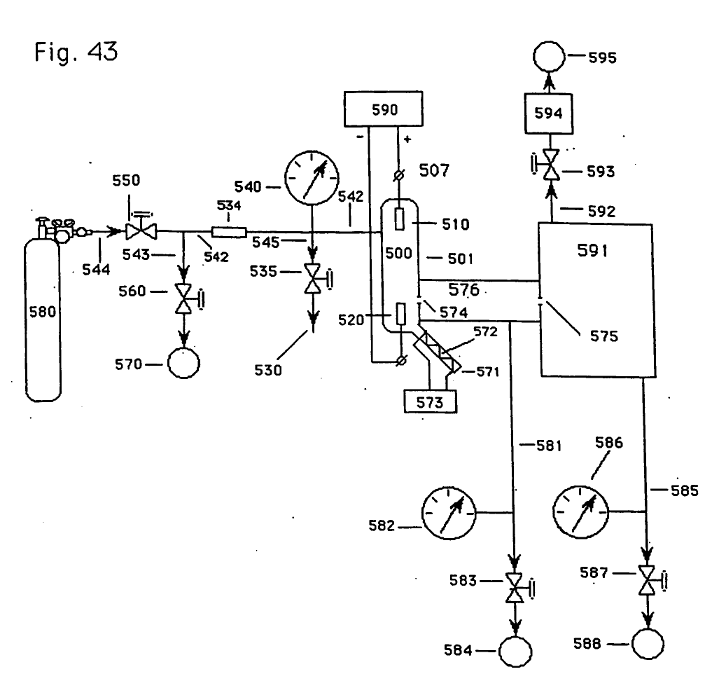

The hydrino hydride compounds with transitions in the regions of the hydrino hydride ion binding energies given in TABLE 1 and the corresponding continua were also detected by EUV spectroscopy. The reactions occurred in a gas discharge cell shown in FIG. 43. Due to the extremely short wavelength of the radiation to be detected, “transparent” optics do not exist. Therefore, a windowless arrangement was used wherein the sample or source of the studied species was connected to the same vacuum vessel as the grating and detectors of the UV spectrometer. Windowless EUV spectroscopy was performed with an extreme ultraviolet spectrometer that was mated with the cell by a differentially pumped connecting section that had a pin hole light inlet and outlet. The cell was operated under hydrogen flow conditions while maintaining a constant hydrogen pressure with a mass flow controller. The apparatus used to study the extreme UV spectra of the gaseous reactions is shown in FIG. 43. It contains four major components: gas discharge cell 507, UV spectrometer 591, mass spectrometer 594, and connector 576 which was differentially pumped.

### A. Experimental Methods

The schematic of the discharge cell light source, the extreme ultraviolet (EUV) spectrometer for windowless EUV spectroscopy, and the mass spectrometer used to observe hydrino, hydrino hydride compound, and dihydrino molecular ion formations and transitions is shown in FIG. 43. The apparatus for the extreme UV studies of the gaseous transition reaction comprised the discharge cell light source 507 described in the Discharge Cell Sample Section except that it further comprised a catalyst reservoir 571 for KNO₃ or KI catalyst that was vaporized from the catalyst reservoir by heating with the catalyst heater 572 using heater power supply 573.

In the case of KNO₃, the catalyst reservoir temperature was 450-500° C. In the case of KI catalyst, the catalyst reservoir temperature was 700-800° C. The cathode 520 and anode 510 were nickel. In one run, the cathode 520 was nickel foam metal coated with KI catalyst. For other experiments, 1.) the cathode was a hollow copper cathode coated with KI catalyst, and the conducting cell 501 was the anode, 2.) the w cathode was a ⅛ inch diameter stainless steel tube hollow cathode, the conducting cell 501 was the anode, and KI catalyst was vaporized directly into the center of the cathode by heating the catalyst reservoir to 700-800° C., or 3.) the cathode and anode were nickel and the KI catalyst was vaporized from the KI coated cell walls by the plasma discharge. The cell further comprised a hydrogen mass flow controller 534 that maintained the hydrogen pressure in the cell 507 with differential pumping at 2 torr.

The mass spectrometer apparatus comprised a Dycor System 1000 Quadrapole Mass Spectrometer Model #D200MP with a HOVAC Dri-2 Turbo 60 Vacuum System 595 that was connected to the EUV spectrometer 591 by line 592 and valve 593. The EUV spectrometer 591 comprised a the McPherson extreme UV region spectrometer, Model 234/302VM (0.2 meter vacuum ultraviolet spectrometer) with a 7070 VUV channel electron multiplier. The scan interval was 0.01 nm, the inlet and outlet slit were 30-50 μm, and the detector voltage was 2400 volts. The EUV spectrometer was connected to a turbomolecular pump 588 by line 585 and valve 587. The spectrometer was continuously evacuated to 10⁻⁵-10⁻⁶ torr by the turbomolecular pump 588 wherein the pressure was read by cold cathode pressure gauge 586. The EUV spectrometer was connected to the discharge cell light source 507 with the connector 576 which provided a light path through the 2 mm diameter pin hole inlet 574 and the 2 mm diameter pin hole outlet 575 to the aperture of the EUV spectrometer. The connector 576 was differentially pumped to 10⁻⁴ torr by a turbomolecular pump 588 wherein the pressure was read by cold cathode pressure gauge 582. The turbomolecular pump 584 connected to the connector 576 by line 581 and valve 583.

The vapor phase transition reaction was continuously carried out in gas discharge cell 507 such that a flux of extreme UV emission was produced therein. The cell was operated under flow conditions with a total pressure of 1-2 torr controlled by mass flow controller 534 where the hydrogen was supplied from the tank 580 through the valve 550. The 2 torr pressure under which cell 507 was operated significantly exceeded the pressure acceptable to run the UV spectrometer 591; thus, the connector 576 with differential pumping served as “window” from the cell 507 to the spectrometer 591. The hydrogen that flowed through light path inlet pin hole 574 was continuously pumped away by pumps 584 and 588. The catalyst was partially vaporized by heating the catalyst reservoir 571, or it was vaporized from the cathode 520 by the plasma discharge. Hydrogen atoms were produced by the plasma discharge. Hydrogen catalysis occurred in the gas phase with the contact of catalyst ions with hydrogen atoms. The catalysis followed by disproportionation of atomic hydrinos resulted in the emission of photons directly, or emission occurred by subsequent reactions to form dihydrino molecular ions and by formation of hydrino hydride compounds with emission by excitation by the plasma.

### B. Results and Discussion

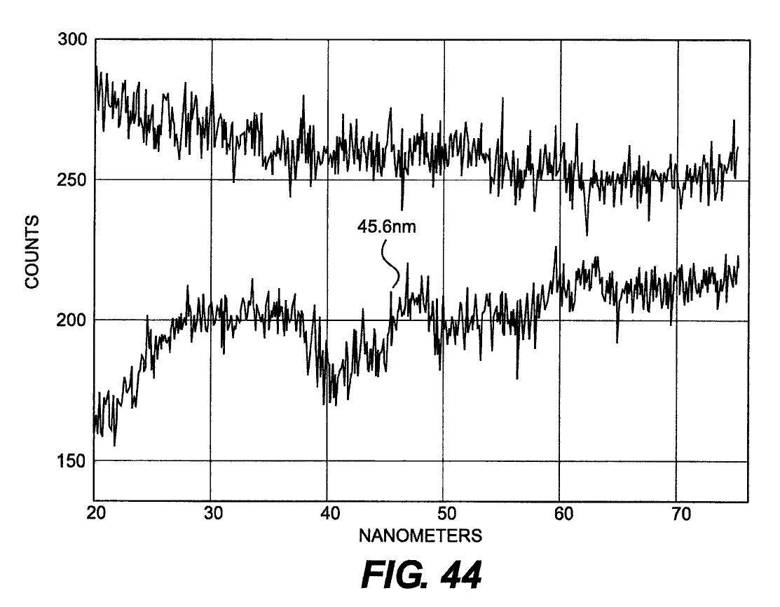

The EUV spectrum (20-75 nm) recorded of hydrogen alone and hydrogen catalysis with KNO₃ catalyst vaporized from the catalyst reservoir by heating is shown in FIG. 44. The broad peak at 45.6 nm with the presence of catalyst is assigned to the potassium electron recombination reaction given by Eq. (5). The predicted wavelength is 45.6 nm which is agreement with that observed. The broad nature of the peak is typical of the predicted continuum transition associated with the electron transfer reaction. The broad peak at 20-40 nm is assigned to the continuum spectra of compounds comprising hydrino hydride ions H⁻(⅛)—H⁻( 1/12), and the broad peak at 54-65 nm is assigned to the continuum spectra of compounds comprising hydrino hydride ion H⁻(⅙).

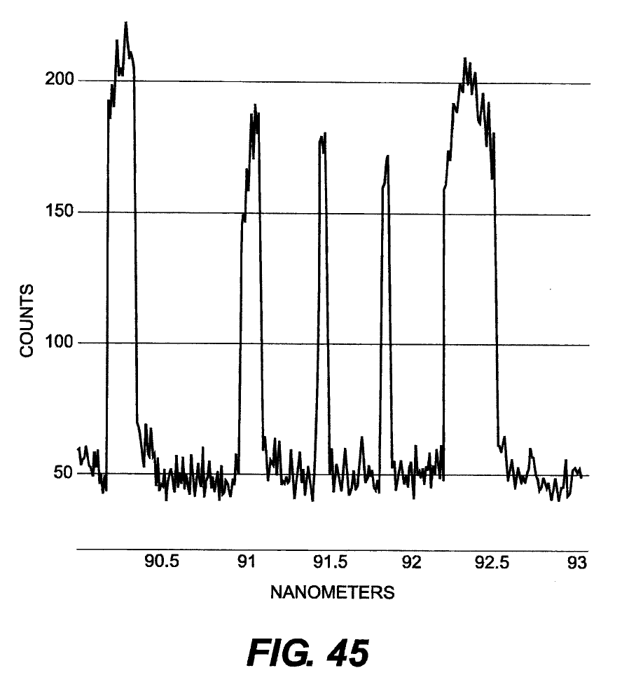

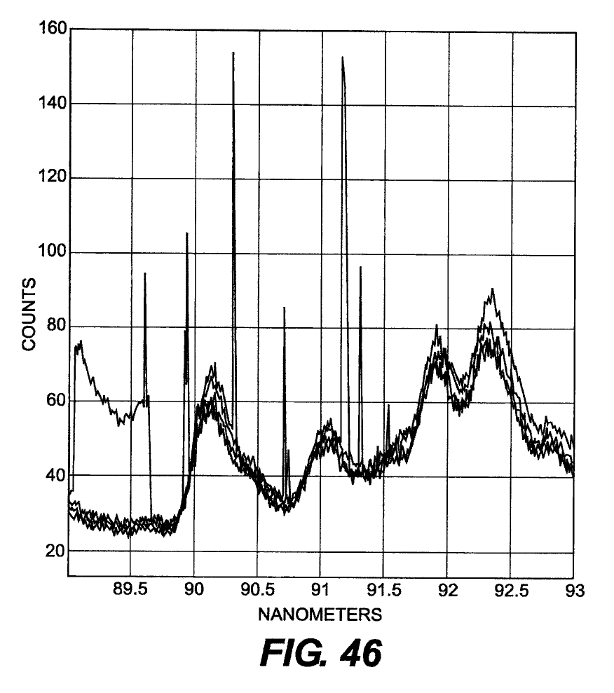

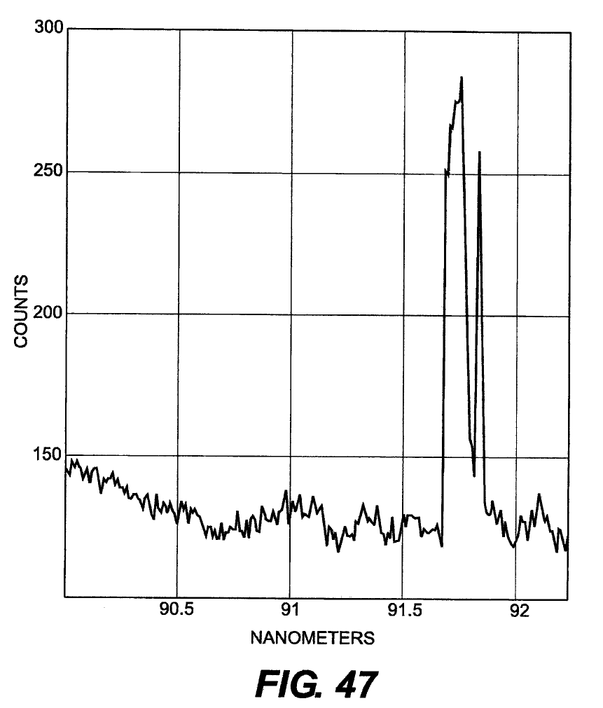

The EUV spectrum (90-93 nm) recorded of hydrogen catalysis with KI catalyst vaporized the nickel foam metal cathode by the plasma discharge is shown in FIG. 45. The EUV spectrum (89-93 nm) recorded of hydrogen catalysis with a five way stainless steel cross discharge cell that served as the anode, a stainless steel hollow cathode, and KI catalyst that was vaporized directly into the plasma of the hollow cathode from the catalyst reservoir by heating which is superimposed on four control (no catalyst) runs is shown in FIG. 46. Several peaks are observed which are not present in the spectrum of hydrogen alone as shown in FIG. 44. These peaks are assigned to the catalysis of hydrogen by K⁺/K⁺(Eqs. (4-6); Eq. (54)) wherein the line splitting of about 600 cm⁻¹ is assigned to vibrational coupling with gaseous KI dimers which comprise the catalyst [S. Datz, W. T. Smith, E. H. Taylor, The Journal of Chemical Physics, Vol. 34, No. 2, (1961), pp. 558-564]. The splitting of the 91.75 nm line corresponding to hydrogen catalysis by vibrational coupling is demonstrated by comparing the spectrum shown in FIG. 45 with the EUV spectrum (90-92.2 nm) recorded of hydrogen catalysis with KI catalyst vaporized from the hollow copper cathode by the plasma discharge shown in FIG. 47. With sufficient vibrational energy provided by the catalysis of hydrogen, the dimer is predicted to dissociate. The feature broad feature at 89 nm of FIG. 46 may represent the KI dimer dissociation energy of 0.34 eV. Vibrational excitation occurs during catalysis according to Eq. (4) to give shorter wavelength emission for the reaction given by Eq. (54) or longer wavelength emission in the case that the transition simultaneously excites a vibrational mode of the KI dimer.

In addition to the line spectra shown in FIGS. 45, 46, and 47, the catalysis of hydrogen was predicted to release energy through excitation of normal hydrogen which could be observed via EUV spectroscopy by eliminating the contribution due to the discharge. The catalysis reaction requires hydrogen atoms and gaseous catalyst which are provided by the discharge. The time constant to turn off the plasma was measured with an oscilloscope to be less than 100 μsec. The half-life of hydrogen atoms is of a different time scale, about one second [N. V. Sidgwick, The Chemical Elements and Their Compounds, Volume I, Oxford, Clarendon Press, (1950), p. 17], and the half-life of hydrogen atoms from the stainless steel cathode following termination of the discharge power is much longer (seconds to minutes). The catalyst pressure was constant. To eliminate the background emission directly caused by the plasma, the discharge was gated with an off time of 10 milliseconds up to 5 seconds and an on time of 10 milliseconds to 10 seconds. The discharge cell comprised a five way stainless steel cross that served as the anode with a stainless steel hollow cathode. The KI catalyst was vaporized directly into the plasma of the hollow cathode from the catalyst reservoir by heating.

The EUV spectrum was obtained which was similar to that shown in FIG. 46. During the gated EUV scan at about 92 nm, the dark counts (gated plasma turned off) with no catalyst were 20±2; whereas, the counts in the catalyst case were about 70. Thus, the energy released by catalysis of hydrogen, disproportionation, and hydrino hydride w compound reactions appears as line emission and emission due to the excitation of normal hydrogen. The half-life for hydrino chemistry that excited hydrogen emission was determined by recording the decay in the emission over time after the power supply was switched off. The half-life with the stainless steel hollow cathode with constant catalyst vapor pressure was determined to be about five to 10 seconds.

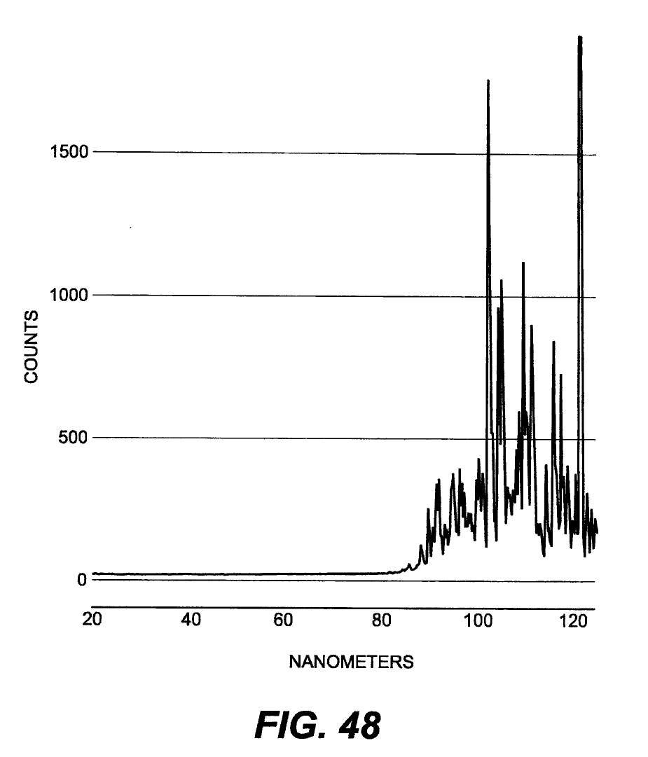

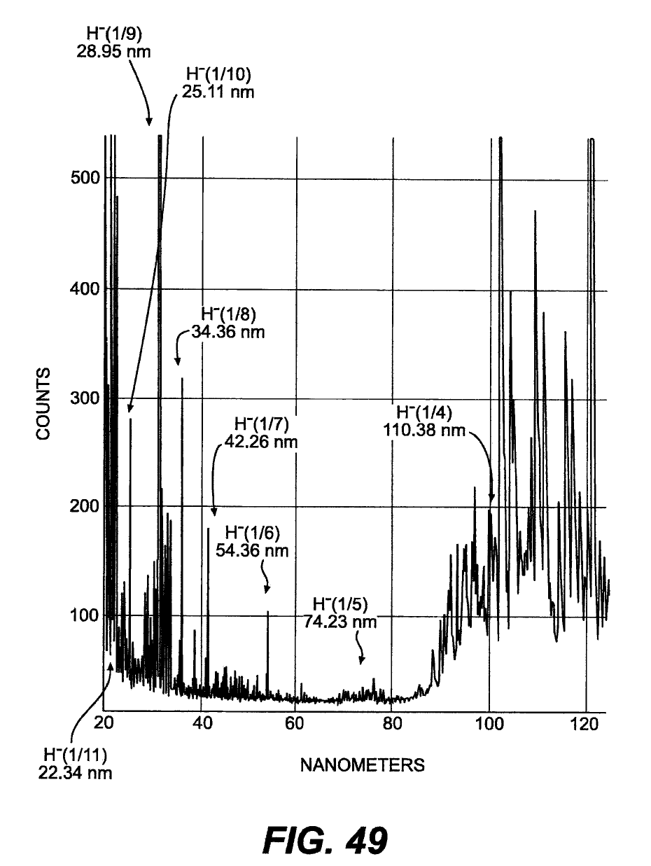

The EUV spectrum (20-120 nm) recorded of normal hydrogen and hydrino hydride compounds that were excited by a plasma discharge is shown in FIG. 48 and FIG. 49, respectively. The discharge cell comprised a five way stainless steel cross that served as the anode with a hollow stainless steel cathode. In the case of the reaction to form hydrino hydride compounds, the KI catalyst was vaporized directly into the plasma of the hollow cathode from the catalyst reservoir by heating. Compared to a discharge of standard hydrogen shown in FIG. 48, the spectrum of hydrino hydride compounds with hydrogen shown in FIG. 49 has an additional feature at λ=110.4 nm as well as other features at shorter wavelengths (λ<80 nm) that are not present in the spectrum of a discharge of standard hydrogen.

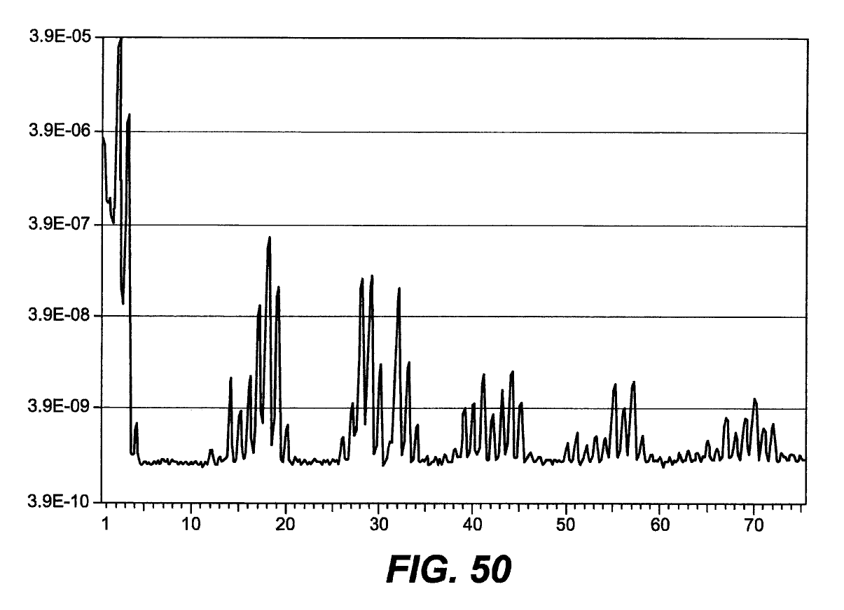

A representative mass spectrum (m/e=0-75) of the gaseous hydrino hydride compounds recorded alternatively with the EUV spectrum with catalyst is shown in FIG. 50. The assignment of the parent peaks of hydrino hydride compounds followed by the corresponding fragment peaks are given in TABLE 17.

TABLE 17
The hydrino hydride compounds assigned as parent peaks
with the corresponding fragment peaks of the mass spectrum
m/e = 0-110 of the crystals from a gas discharge cell hydrino hydride
reactor comprising a KI catalyst and a Ni electrodes with a sample
heater temperature of 133° C.

| | m/e of Parent Peak |
|---|---|
| Hydrino Hydride Compound | with Corresponding Fragments |
| H₃⁺H⁻(1/p) | 4 |
| LiH(1/p) | 8-7 |
| Li₂(H(1/p))₂ | 16; 8-7 |
| ²⁴Mg(H(1/p))₂ | 26-24 |
| ²⁵Mg(H(1/p))₂ | 27-25 |
| ²⁶Mg(H(1/p))₂ | 28-26 |
| ³⁹KH(1/p) | 40-39 |
| ⁴¹KH(1/p) | 42-41 |
| ³⁹K(H(1/p))₂ | 41-39 |
| ⁴¹K(H(1/p))₂ | 43-41 |
| LiSiH₆ | 41-35; 32-28 |
| K⁺H⁻(1/p)H₃⁺H⁻(1/p) | 44-39; 43-41; 41-39; 42-41; 40-39 |
| Na₂(H(1/p))₂ | 48-46; 24-23 |
| Mg₂H₄ | 52-48; 28-26; 27-25; 26-24 |
| NaSiH₆ | 57-51; 32-28; 24-23 |
| MgHCl | 60-59; 27-26; 26-25; 25-24 |
| HNa₂OH | 64-63; 40; 24-23 |
| NiH₆ | 64-58 |
| LiNiH₆ | 71-65; 58; 8-7 |
| KSiH₆ | 73-67; 32-28; 43-41; 41-39; 42-41; 40-39 |

The spectrum was similar to that shown in FIG. 32 with parent peak identifications shown in TABLE 10. The EUV peaks can not be assigned to hydrogen, and the energies match those assigned to hydrino hydride compounds given in the Identification of Hydrinos, Dihydrinos, and Hydrino Hydrides by XPS (X-ray Photoelectron Spectroscopy) Section. Thus, these EUV peaks are assigned to the spectra of compounds comprising hydrino hydride ions H⁻(¼)−H⁻( 1/11) having transitions in the regions of the binding energies of the hydrino hydride ions shown in TABLE 1. The mass spectra and XPS results of hydrino hydride compounds with the mass spectra given in the Identification of Hydrinos, Dihydrinos, and Hydrino Hydrides by XPS (X-ray Photoelectron Spectroscopy) Section and the Identification of Hydrino Hydride Compounds by Mass Spectroscopy Section, respectively, and the EUV spectroscopy results given herein confirm hydrino hydride compounds.

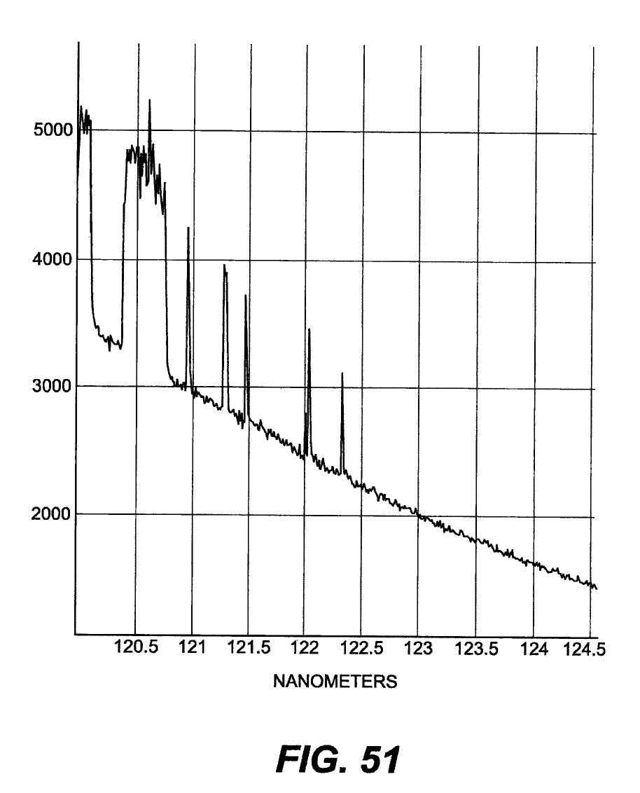

The EUV spectrum (120-124.5 nm) recorded of hydrogen catalysis to form hydrino that reacted with discharge plasma protons is shown in FIG. 51. The KI catalyst was vaporized from the walls of the quartz cell by the plasma discharge at nickel electrodes. The peaks are assigned to the emission due to the reaction given by Eq. (60). The 0.03 eV(42 μm) splitting of the EUV emission lines is assigned to the J+1 to J rotational transitions of H₂*[2c′=aₒ]+given by Eq. (61) wherein the transitional energy of the reactants may excite a rotational mode whereby the rotational energy is emitted with the reaction energy to cause a shift to shorter wavelengths, or the molecular ion may form in an excited rotational level with a shift of the emission to longer wavelengths. The agreement of the predicted rotational energy splitting and the position of the peaks is excellent.

1. A composition of matter comprising a hydride ion having a binding energy of about 0.65 eV.

2. A method for the explosive release of energy comprising reacting a hydride ion having a binding energy of about 0.65 eV, or a compound of said hydride ion, with a proton to produce a molecular hydrogen having a first binding energy of about 8,928 eV.

3. A method of claim 2 wherein the proton is supplied by an acid or a super-acid.

4. A method of claim 3 wherein the acid or super-acid is selected from the group consisting of HF, HCl, H₂SO₄, HNO₃, the reaction product of HF and SbF₅, the reaction product of HCl and Al₂Cl₆₁ the reaction product of H₂SO₃F and SbF₅, the reaction product of H₂SO₄ and SO₂, and combinations thereof.

5. A method of claim 2 wherein the reaction is initiated by rapid mixing of the hydride ion or hydride ion compound with the acid or super-acid.

6. A method of claim 5 wherein the rapid mixing is achieved by detonation of a conventional explosive proximal to said hydride ion and said acid or super-acid.

7. A method for the explosive release energy comprising thermally decomposing a compound of a hydride, aid hydride ion has a binding energy of about 0.65 eV, to producing a hydrogen molecule having a first binding energy of about 8,928 eV.

8. A method of claim 7, wherein the thermal decomposition is achieved by detonating of a conventional explosive proximal to said hydride ion compound.

9. A method of claim 7, wherein the thermal decomposition is achieved by percussion heating of said hydride ion compound.

10. A method of claim 9, wherein percussion heating of the hydride ion compound comprises colliding a projectile tipped with said compound under conditions resulting in detonation upon impact.

11. A fuel comprising a compound including at least one increased binding energy hydrogen species selected from the group consisting of:
